(19) United States
(12) Patent Application Publication
(10) Pub. No.: US 2004/0236661 A1
(43) Pub. Date: Nov. 25, 2004

(54) Capital markets index and futures contract

(75) Inventor: Joseph F. Benning, Summit, NJ (US)

Correspondence Address: FOLEY & LARDNER, 321 NORTH CLARK STREET, SUITE 2800, CHICAGO, IL, 60610-4764, US

(73) Assignee: Board of Trade of the City of Chicago

(21) Appl. No.: 10/435,760

(22) Filed: May 12, 2003

(51) Int. Cl. G06F 17/60

(52) U.S. Cl. 705/37

(57) ABSTRACT

A capital markets index and related futures contracts are provided. The index of the present invention indexes marginal returns available on capital markets free of default risk. The index of the present invention uses chain-linked futures contracts both as measuring instruments and as building blocks. The futures contract of the present invention is based on the index of the present invention. Accordingly, both the index of the present invention and related futures contracts are transparent and accurate reflections of the baseline returns universe made up of dollar based fixed-income markets

### FIELD OF THE INVENTION

The present invention relates to index contracts.

### REFERENCE TO TABLE SUBMITTED ON COMPACT DISK

The information located in the file entitled “Table” containing 288 bytes of information created on 12 May 2003 and submitted to the United States Patent and Trademark Office is hereby incorporated-by-reference.

### BACKGROUND OF THE INVENTION

The investment management industry has become increasingly inventive in its use of benchmark indices as baseline measures, for differentiating among factors influencing returns, and for evaluating the performance of portfolios managers. However, portfolio managers typically use off-the-shelf indices that do often do not accurately reflect the true investment universe. Consequently, performance analyses can be biased or distorted (See, for example, David E. Kuenzi, Strategy Benchmarks, Journal of Portfolio Management Winter 2003, Vol. 29, No. 2, pp. 46-56).

Desirable properties possessed by good benchmarks are summarized in Jeffrey V. Baily, Are Manager Universes Acceptable Performance Benchmarks?, Journal of Portfolio Management Spring 1992, Vol. 18, No. 3, pp. 9-13. These properties include: a well-defined universe, availability of historical data, investable securities with well-defined risk parameters, daily price performance, low-turnover of securities included in the benchmark, and selection rules for index inclusion specified in advance.

A well-defined universe is important for two reasons that are integrally related. This first is generalizability; the second is internal validity. However, there is a natural trade-off between these goals. (See, for example, THOMAS D. COOK & DONALD T. CAMBELL, QUASI-EXPERIMENTATION: DESIGN & ANALYSIS ISSUES, (Houghton-Mifflin 1979) (discussing the trade-offs between reliability and generalizability); ROBERT F. DEVELLIS, SCALE DEVELOPMENT THEORY AND APPLICATIONS 39-41 (Sage Publications 1991). Broadly based indices lack focus; narrowly based indices may not be representative. For an index to have value, the universe of securities available for inclusion must be representative, and the rules for sample selection must be well defined, known in advance, and unbiased.

To the extent that the universe of securities available for index selection is large, but only loosely correlated, the reliability of the index suffers. High turnover of index components makes it unclear exactly what the index actually measures. High turnover also calls into question the validity of comparisons over time. A loosely defined universe of selectable securities leads to a lack of index focus. On the other hand, a very tightly defined and highly correlated group of securities may be so specific that it loses its generalizability value. Lack of clear inclusion rules can lead to selection bias.

In addition, a critical feature that differentiates bonds from stocks makes bond market indices problematic. Unlike stocks, bonds mature. Consequently, prices of individual fixed-income securities change over time in ways that individual stocks do not. For example, if the general level of equity markets remained unchanged over a 1-year period, we would expect the Dow Jones Industrial Average to be essentially unchanged, even though some index components would have risen and some fallen. The Dow Jones Industrial Average is an index promulgated by the Dow Jones & Company, World Financial Center, 200 Liberty Street, New York, N.Y. 10281, that serves as a measure of the entire U.S. market, covering such diverse industries as financial services, technology, retail, entertainment and consumer goods.

By way of contrast, consider a bond market with a positive yield curve in which 4-year maturities yield 50 basis points more than 3-year maturities. With no change in the general level of market interest rates, over 1-years time, a portfolio consisting of 4-year notes will enjoy a capital gain of 50 basis points in addition to coupon income earned. But the ending portfolio will be different from the beginning one. Portfolio risk parameters, market value and earnings potential all will have changed, even though market interest rates have remained stable. Hence there exists a need for a measure that replicates returns available in the bond market so that portfolio managers (and their customers) can benchmark similar performances over time.

An approach to address these issues has been to offer a dual solution: a pair of indices. One index presents a returns universe; the other index presents a statistics universe. The returns universe index seeks to avoid the problem of the moving target by designating a constant set of bonds for a given time period, with returns calculated accordingly. This approach avoids the moving target problem, but at the price of missing potentially important changes in the selection universe for the time in question.

By contrast, the statistics universe index captures the dynamism implicit in the marketplace. For instance, the statistics universe index includes new issues, changes in credit ratings, and can be used for rebalancing. But it necessarily does so by changing the definition of the universe of available securities. Returns comparisons are thus not necessarily directly comparable over time.

In addition, data quality is of paramount concern in index construction. Even a good index design executed with bad data will result in a flawed measure with limited utility. Many designers attempt to deal with the inherent difficulties of bond market data collection by constructing indices containing large numbers of bonds on the theory that, on average, the prices will be approximately correct. However, such indices are expensive to administer and their responsiveness to significant market moves is liable to be sluggish and unfocused. Moreover, index pricing is likely to reflect only the closing prices of the component bonds, and even then, the closing “prices” are simply traders' marks-to-market.

Still further, transparency is of paramount concern in index construction. Bond indices (unlike stock indices) are rarely calculated on the basis of actual market transactions. Typically bond indices are calculated on traders' subjective mark-to-market type estimates of where they think bonds ought to trade. For the most part the bonds are “matrix-priced”, against a grid of comparable issues.

Thus, reliable and efficient bond indices are far more difficult to construct and maintain than stock indices. The universe of available instruments is difficult to define. The mathematics of fixed-income pricing is such that apples-to-apples comparisons of bond indices are problematic, especially over time. Historical bond market data is more difficult to come by than stock market data. Moreover, bond index pricing tends toward trader's mark-to-market quotes rather than actual market transactions.

What would therefore be desirable would be an index that accurately, efficiently and transparently replicates marginal returns on Treasury securities generated by the general level of longer-term market interest rates, the shape of the yield curve and the level of short-term financing rates.

### SUMMARY OF THE INVENTION

An index in accordance with the principals of the present invention more accurately, efficiently and transparently replicates the returns on Treasury securities generated by the general level of longer-term market interest rates, the shape of the yield curve and the level of short-term financing rates. In accordance with the principals of the present invention, a capital markets index and related futures contracts based on the capital markets index are provided. The index of the present invention indexes marginal returns available on capital markets free of default risk. The index of the present invention uses chain-linked futures contracts both as measuring instruments and as building blocks. Accordingly, both the index of the present invention and related futures contracts are transparent and accurate reflections of the baseline returns universe made up of dollar based fixed-income markets

### BRIEF DESCRIPTION OF THE DRAWINGS

FIG. 1 is a graph illustrating the high, low and closing prices of an example index in accordance with the principals of the present invention based on historical daily market data from January 2001 through March 2003.

FIG. 2 is a scatter plot comparing monthly returns on the example index of FIG. 1 to monthly returns generated by an index of constant maturity synthetic Treasury securities with 5-year, 10-year and 20-year maturities.

FIG. 3 is a graph comparing returns between cash bonds and cash five-year notes, using constant maturity Treasury rates from February 2001 through February 2003 to create a comparison Index of synthetic cash securities.

FIG. 4 is a graph displaying and comparing average monthly closing prices of the example index of FIG. 1 with its cash counterpart of the same duration.

FIG. 5 is a graph displaying the price movements of synthetic 5-year notes and 20-year bonds.

FIG. 6 is a graph displaying a comparison of the price action of the example index of FIG. 1 versus the Dow Jones Industrials from January 2001 through March 2003.

FIG. 7 is a returns scatter plot derived from regressing daily bond market returns against daily equity returns.

### DETAILED DESCRIPTION OF THE INVENTION

An index and futures contract in accordance with the principals of the present invention is an easily usable and accurate replication of the universe of “riskless” capital market returns. By “riskless” what is meant is that the capital market returns are free of default risk. An index and futures contract in accordance with the principals of the present invention uses Treasury futures as its building blocks. The term Treasury futures refers to futures contracts such as those offered by the Board of Trade of the City of Chicago, 141 West Jackson Boulevard, Chicago, Ill. 60604-2994 (CBOT) in which the underlying deliverable security is one issued by the United States Treasury. Tethered to the broad, deep and transparent marketplace for Treasury futures contracts, the index and futures contract in accordance with the principals of the present invention accurately reflects marginal returns available to investors in Treasury securities with maturities of 5 years and longer. The terms Treasury Securities and Treasury Instruments are used interchangeably herein, and refer to debt instruments sold by the United States Treasury in the open market and bearing the full faith and credit of the United States government.

The index, in accordance with the principals of the present invention, addresses a problem inherent in fixed-income benchmarks by reconciling two competing needs. The first is for a recognizable, predictable, and transparently priced set of fixed-income securities to comprise the index. The second is for the index to capture changes in the universe of bonds without sacrificing internal consistency.

An index in accordance with the principals of the present invention addresses the reliability/generalizability trade-off by combining a constant measuring instrument with forward pricing. In a preferred embodiment, the constant measuring instruments are front-month contracts and the forward pricing are the quarterly contract rolls. An index in accordance with the principals of the present invention chain-links measurement cohorts into a continuous time series. The cohort is the duration weighted average daily price of bond contracts during a given time period; the chain-link is the market price of rolling from Timeₜ to Timeₜ₊₁. For example, in a preferred embodiment the cohort is the duration weighted average daily price of Treasury 5-year notes, Treasury 10-year notes, and bond contracts during a calendar quarter; the chain-link is the market price of rolling from Quarterₜ to Quarterₜ₊₁. Because the roll-price is equal to carry value, an index in accordance with the principals of the present invention approximates marginal returns available from “risk-free” capital market instruments. (Treasury instruments are “risk-free” with respect to credit; they can also be thought of as the “risk-free” rate for a particular place along the yield curve).

To replicate these returns on Treasury securities generated by the general level of longer-term market interest rates, the shape of the yield curve and the level of short-term financing rates the index of the present invention is comprised of duration weighted prices of front-month 5-year, 10-year and bond contracts. Duration weights are adjusted. In a preferred embodiment, duration weights are adjusted quarterly. The index is chain-linked to maintain consistency over time. The chain-link technique strings observations together into a consistent and reliable time-series by incorporating past information into the current index calculation. Not only does the chain-link technique maintain internal index consistency, it allows returns to compound over time at current market rates. The result is an index that correlates well with cash market returns. In a preferred embodiment, the index is chain linked quarterly.

An index in accordance with the principals of the present invention is comprised of the following elements: prices of 5-year, 10-year and bond contracts weighted by duration, calendar spreads of 5-year, 10-year and bond contracts and accumulated calendar spreads from the index inception date. In a preferred embodiment, duration weights are adjusted quarterly. Calendar spreads are added to, and current front-month contracts are substituted for, expiring contracts. In a preferred embodiment, this substitution occurs after the close of business on the second Friday of March, June, September and December. See Lev DynKin, Jay Hyman, & Peter Lindner, Hedging and Replication of Fixed-Income Portfolios, THE JOURNAL OF FIXED INCOME 1-21 (March 2002) for a discussion of the efficacy of using duration-weighted CBOT Treasury futures to replicate a series of fixed-income portfolios.

The index value (IV) at time (t) is the duration-weighted average price (DWABP) of nearby 5-year, 10-year and bond futures contracts plus accumulated net carry (AC), rebalanced quarterly, or:

IVₜ=(DWABPₜ)+ACₜ

The duration weights are such that each index component makes an approximately equal contribution to index volatility for parallel rate shifts. Deferred contract months embed carry into the price structure. Price differences between current and deferred contracts are added in to the index periodically (in a preferred embodiment, quarterly) and accumulate over time.

Constructed this way an index in accordance with the principals of the present invention incorporates three important factors into its pricing structure: parallel rate shifts, yield curve changes and financing margins. The index of the present invention covers the span of the targeted maturity spectrum by including 5-year, 10-year and bond contracts. Duration price weighting allows yield curve shifts to show through. Including (and accumulating) forward contract rolls adds cumulative net carry, which is largely determined by short-term financing rates.

An index in accordance with the principals of the present invention is consistent both as a measure and as a construct. The construct is that of marginal capital market returns available from investing in a representative collection of longer-duration Treasury instruments. However, not all long-dated capital market instruments enjoy the same return nor do they have the same risk profile, expressed in terms of volatility. Therefore, to be a consistent measure of capital market returns, the index incorporates, on a weighted basis, the risks and returns that reside at key pivot points along the capital market yield curve.

For example, Treasury 5-year notes, Treasury 10-year notes and bonds represent key inflection points that define the shape of the yield curve. But over time, characteristics of cash Treasury securities at inflection points can and will change. For instance, as rate levels change new issues will have coupons that reflect new market levels. To the extent that market rates change substantially, calculated duration may change substantially as well. Further, market interest rate shifts may not be parallel, and so the relative duration may shift.

An index in accordance with the principals of the present invention accommodates developments such as these (because they reflect the dynamism of the market place), while maintaining the integrity of the underlying construct—marginal returns available from risk-free capital market instruments. Construct integrity—that is, index consistency—is accomplished by chain-linking. The index is updated so that it consists of the nearby Treasury 5-year note, Treasury 10-year note and bond contracts. Index consistency over time is maintained by linking index cohorts by the market price of rolling forward.

Rolling contracts forward involves selling the nearby position and acquiring a position in the next contract expiration. For example, an investor who is “long” March bond futures contracts and who wants to roll his position forward, would sell out his March bonds and buy June bonds as a replacement. The price of this type of transaction is typically determined by the difference in carry value, in this example, between March and June. Carry value is determined by the difference between the cost of funds and interest earned.

Table 1 illustrates how carry works in bond futures. The table assumes that the cheapest-to-deliver cash bond has a 6% semi-annual coupon; that it is trading at 100, and that the financing rate is 2%. For the sake of example, the additional simplifying assumption that all contract expirations are exactly equally spaced among quarters is made. Hypothetical contract prices are in the table's interior.

TABLE 1

| | | Contract Expiration Dates | | | |
|---|---|---|---|---|---|
| Hypothetical Deliverable Cash | | March | June | Sept. | Dec. |
| Treasury Bond: 6% @ 100 | | 02 | 02 | 02 | 02 |
| Valuation | December 2001 | 99 | 98 | 97 | 96 |
| Dates | March 2002 | 100 | 99 | 98 | 97 |
| | June 2002 | | 100 | 99 | 98 |
| | September 2002 | | | 100 | 99 |
| | December 2002 | | | | 100 |

The prices displayed in the table are a snapshot. Absent a change in the cash bond price over one full year, the front bond contract will gradually experience a price rise equal to carry or 6%−2%=4%=4 points. The 4 points can come about two ways. In December 2001 an investor could simply buy the December 2002 contract at 96 and wait for it to accrete to par. Or an investor could buy the March 2002 contract at 99, sell it at 100 and roll into the June contract at 99 and repeat the process 3 more times over the course of the year, thereby earning 4 points. An investor who bought and rolled the front bond contract and invested in fed funds would essentially earn the same pre-tax return as a cash bond investor. Four points would come from accretion over the year and 2 additional points would come from the 2% fed funds rate.

Table 1 also shows how the index of the present invention maintains consistency over time. Even though the futures contracts that comprise the index are updated quarterly, the changes do not fundamentally affect index valuation. Changes in index valuation arise from two sources: changes in market rates and interest earnings in excess of carry costs. Changes in market rates can emerge from changes in the shape in the yield curve, changes in the general level of rates, or both. Absent a change in the general level market rates, changes in index valuation are the result of carry accretion, negative or positive.

An additional feature of an index in accordance with the principals of the present invention is its transparency, both with respect to pricing and the criteria for index inclusion. Evaluation of the index in accordance with the principals of the present invention is based on actual transactions that take place in large, liquid, transparent and easily accessible markets. Not only are the underlying contracts themselves traded actively, the cash securities on which they are based trade actively, and the delivery process keeps cash and futures markets “in line” with each other. For example, on the average day CBOT trades 5-year note futures with a notional value of about $20 Billion; 10-year notes with a notional value of about $40 Billion, and bonds in the vicinity of $20 Billion. In the underlying cash markets that ultimately price the futures contracts through convergence, average daily trading in 3 to 5-year maturities is about $100 Billion; 6-to-10-year maturities about $70 Billion, and long-dated bonds about $18 Billion.

Tight linkage between cash and futures markets in U.S. government securities bolsters efficient futures market pricing with respect to cash. Market transparency encourages price signals to be widely disseminated throughout the marketplace. Consequently, an index in accordance with the principals of the present invention that is derived from these prices, is both a transparent and efficient benchmark of market prices and returns.

In addition, not only is historical data available for an index in accordance with the principals of the present invention, daily price and volume data for index components are available as well. The CBOT maintains historical high-low-close and volume data for all its contracts. As a result, historical index results can be calculated and analyzed. These data can be used to calculate historical returns in the bond markets and can be used for benchmarking purposes, both retrospectively and prospectively.

The index data utilized in an index of the present invention represents actual transactions that take place throughout the day. Consequently there are high, low, and closing prices, as well as volume statistics for the underlying contracts. Prices are contestable, based on transactions, rather than opinions. Because volume statistics are available, the index and its components can be subjected to various types of analysis (such as flow-of-funds) that other indices cannot accommodate. Further, by design, the index of the present invention is sensitive to fluctuations in market interest rates and therefore represents a superior measure of market behavior.

Still further, the index in accordance with the principals of the present invention is both efficient and simple. The index of the present invention captures and aggregates the impact of hundreds of thousands of transactions a day for billions of dollars of securities using a discreet number of data points. In a preferred embodiment, only 3 data collection points, namely, the prices of nearby 5-year, 10-year and bond futures contracts are utilized. Index prices are duration-weighted averages of these futures prices, plus the weighted price of the forward roll, discussed earlier. But while there are a discreet number of data collection points, these collection points accurately represent the underlying values of hundreds of billions of dollars worth of U.S. Government securities that are traded daily. The prices are accurate because the delivery process forces convergence between cash and futures prices.

### EXAMPLE

An example index in accordance with the principals of the present invention consists of the following elements: daily high, low and closing prices of 5-year, 10-year and bond contracts weighted by duration, quarterly calendar spreads of 5-year, 10-year and bond contracts and accumulated calendar spreads from the index inception date. Duration weights are adjusted quarterly. Calendar spreads are added to, and current front-month contracts are substituted for, expiring contracts after the close of business on the second Friday of March, June, September and December. The Appendixes include the historical equity data used to compare equity returns to the returns of the the example index, historical constant maturity and fed funds rate data published by the Federal Reserve Bank of St. Louis and historical CBOT futures price data used to calculate duration weights and market prices for note and bond rolls.

The example index is designed to measure available returns in Treasury securities with maturities 5-years and longer. While returns across Treasury securities tend to be highly correlated, both risk parameters and expected earnings vary with respect to duration. Further, yields on shorter-term securities are likely to be more sensitive to changes in monetary policy, while yields of longer-dated issues are likely to be more sensitive to inflation expectations. Finally, returns on long-dated Treasury securities are partly determined by liquidity preferences. Therefore the goal of the example index is to accurately, efficiently and transparently replicate the returns on Treasury securities generated by the general level of longer-term market interest rates, the shape of the yield curve and the level of short-term financing rates.

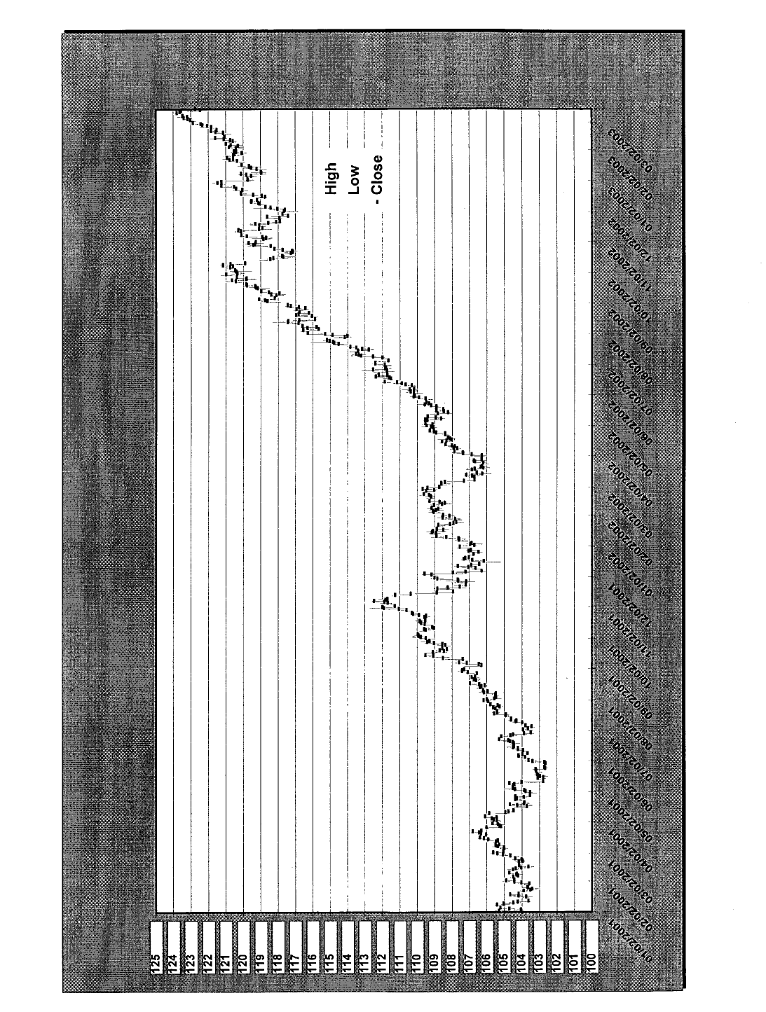

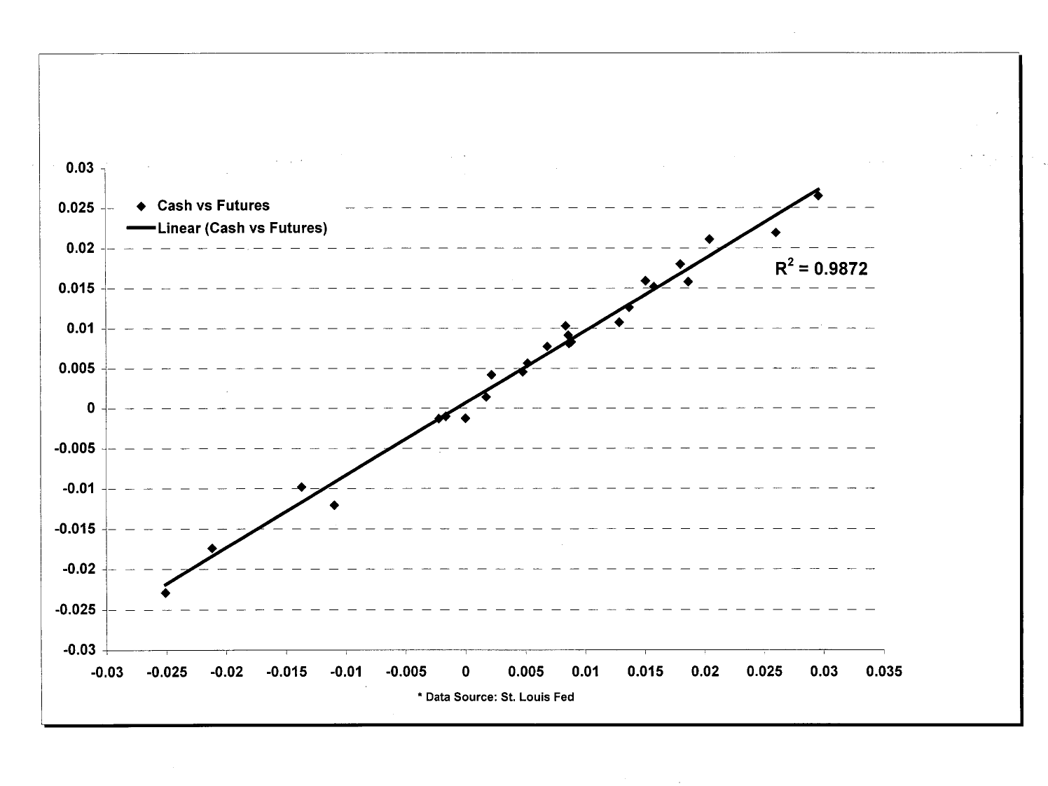

A good test of the efficacy of an index is how well it correlates with cash market behavior. To the extent that an index reliably captures returns generated by a representative collection of cash securities over time, it is a reliable index of that universe of returns. FIG. 1 graphically represents the high, low and closing prices of the example index in accordance with the principals of the present invention based on historical daily market data from January 2001 through March 2003. FIG. 2 presents a scatter plot comparing monthly returns on the example index to monthly returns generated by an index of constant maturity synthetic Treasury securities with 5-year, 10-year and 20-year maturities. The sample time frame extends from February 2001 through February 2003. The comparison cash index used synthetic 6% coupon semi-annual cash bonds; prices were generated using constant maturity rates reported by the St. Louis Fed on its website (http://www.stls.frb.org/). The cash index added accrued interest from the 6% coupon and subtracted carry cost using the monthly average fed funds rate. Cash index bond prices were duration weighted.

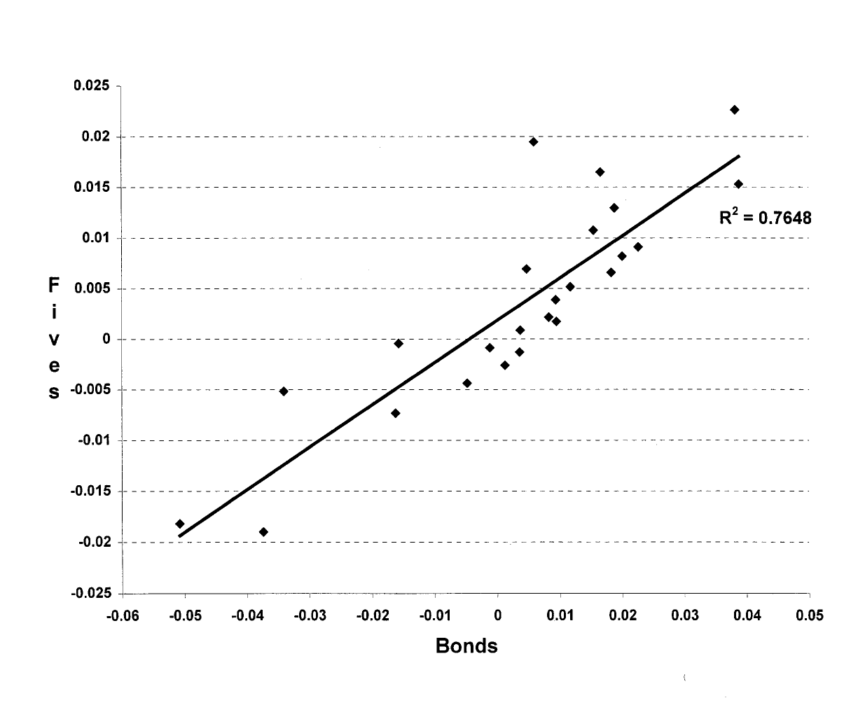

A comparison of returns between the example index and the mirror image cash market index produced highly correlated returns, with an R² of 0.987. In this regard, the high correlation (bordering on an identity) is not simply the result of generally high correlations in bond market returns. Correlations between the returns on 5-year notes and bonds are much lower for the same time period, with an R² of about 0.764. This is shown in FIG. 3, which graphs return comparisons between cash bonds and cash fives, using constant maturity Treasury rates from February 2001 through February 2003 as a basis for comparison.

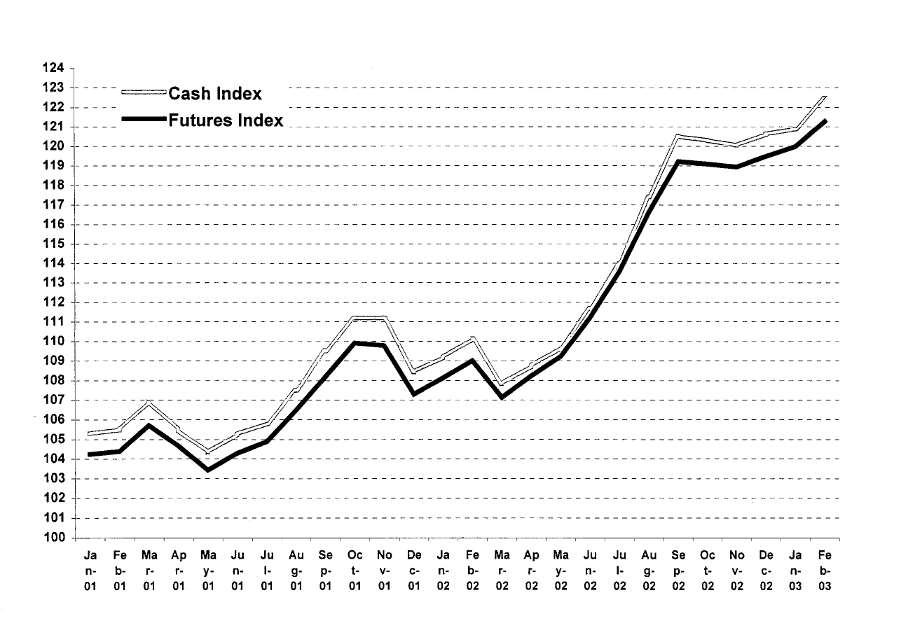

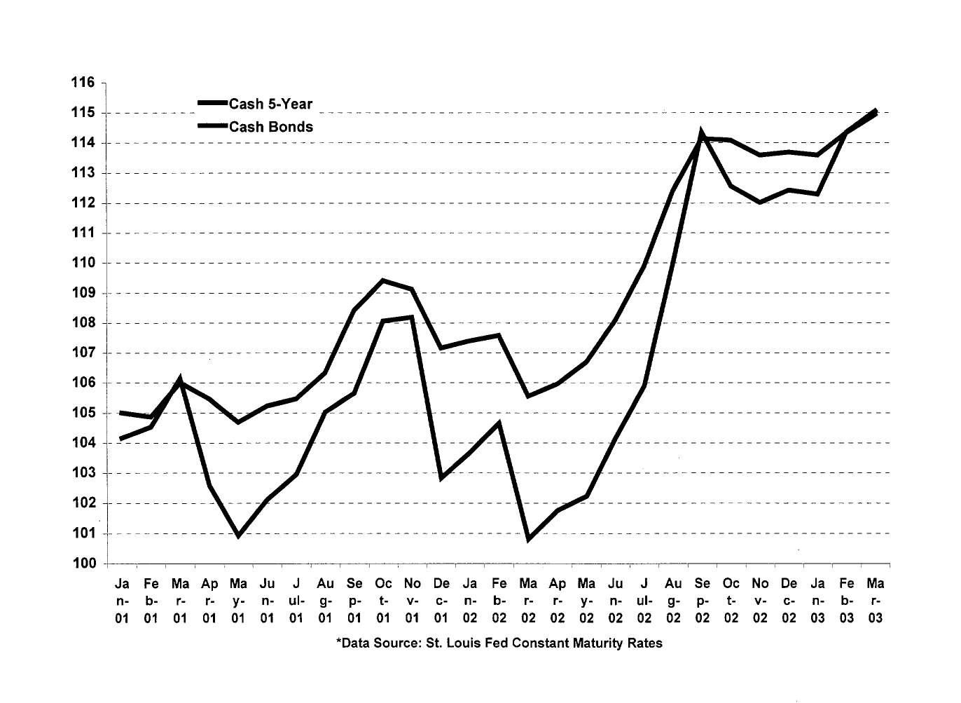

In combination, FIGS. 4 and 5 illustrate the price effects of matched and unmatched durations. For example, FIG. 4 displays the price movements of the example index with its cash counterpart of the same duration; the two indices clearly move together. By comparison, FIG. 5 displays the price movements of synthetic 5-year notes and 20-year bonds. Their relative price behavior is clearly less closely correlated than the duration-matched cash and futures proxies displayed in FIG. 4.

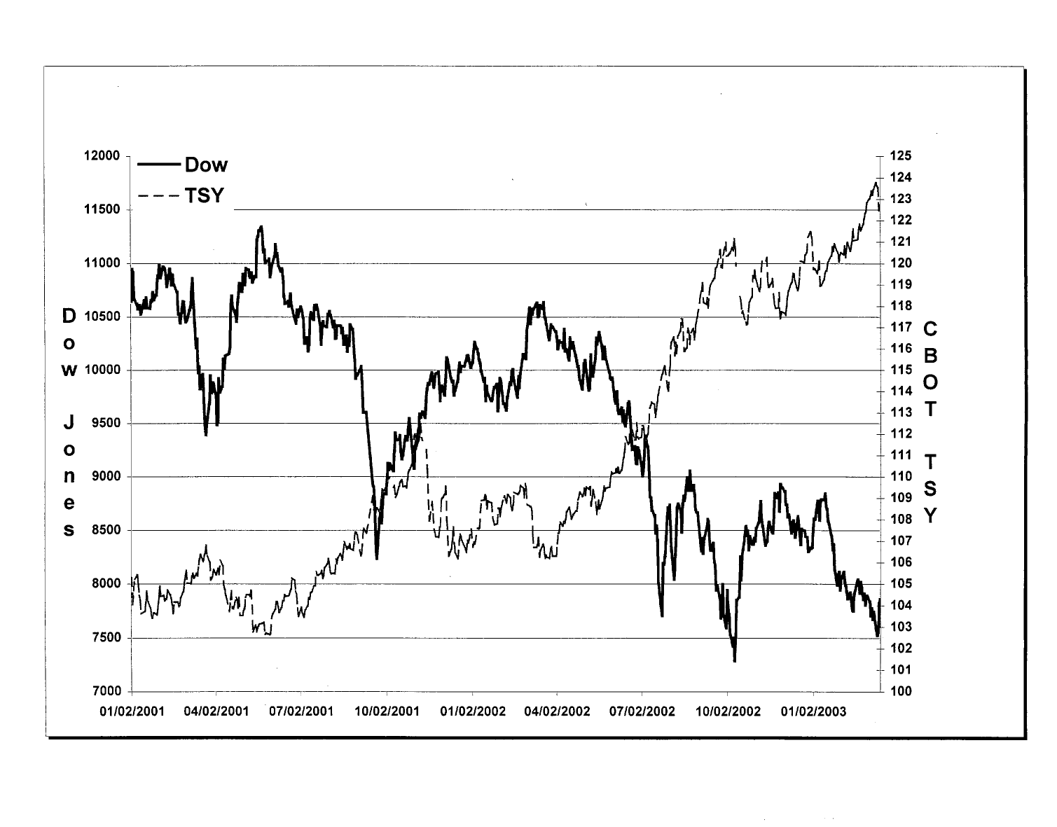

The index in accordance with the principals of the present invention also can be used as a reference for comparing returns across markets. For example, FIG. 6 displays a comparison of the price action of the example index versus the Dow Jones Industrials from January 2001 through March 2003. The Dow scale is on the left-hand side of the graph; the example index is on the right.

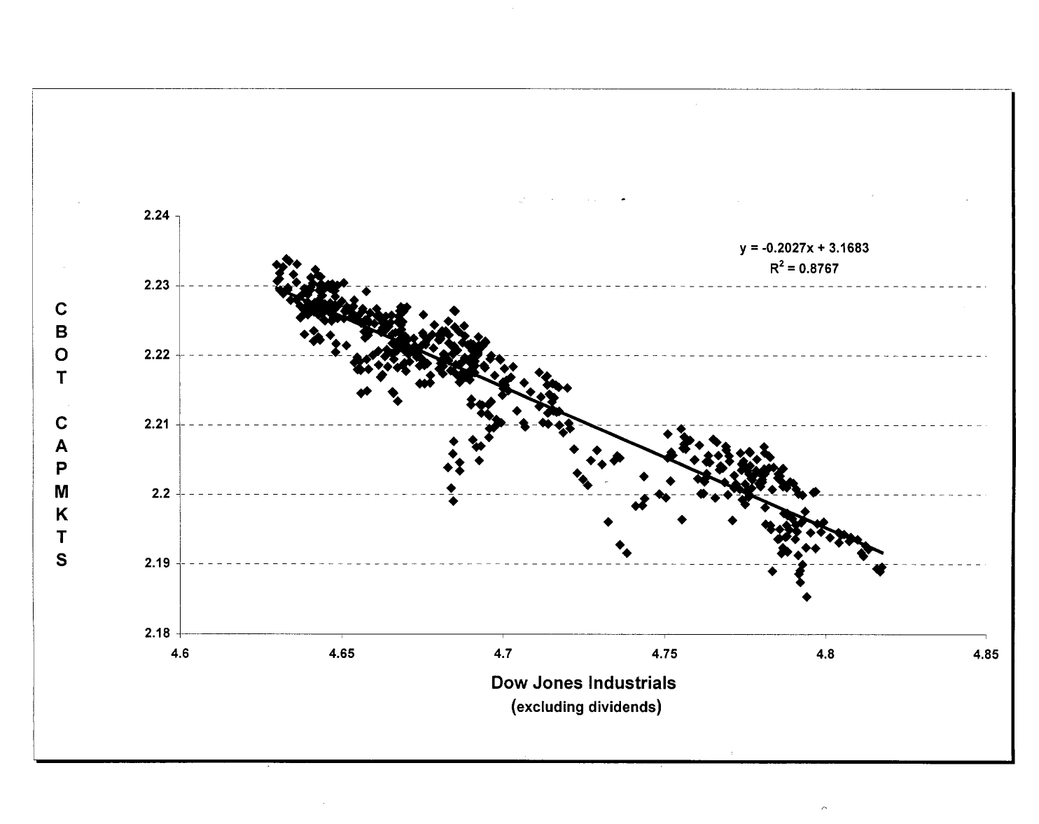

In the same vein, FIG. 7 displays a returns scatter plot derived from regressing daily bond market returns against daily equity returns. As the graph illustrates, returns are reasonably highly correlated, but the correlations are negative. To some extent, this may be statistical artifact; the sample time frame coincides with the early stages both of the bear market in stocks and easing by the Fed. Nevertheless these data suggest the possibility of using combinations of equity and debt index futures contracts to manage what might otherwise be systematic (that is, non-diversifiable) financial market risk. See PETER BERNSTEIN, AGAINST THE GODS: THE REMARKABLE STORY OF RISK (John Wiley and Sons 1996 pp 248-257 (discussing diversification across markets); FRANK J. FABOZZI, & GIFFORD FONG, ADVANCED FIXED INCOME PORTFOLIO MANAGEMENT pp. 33-34 (discussing systematic vs. non-systematic risk (McGraw-Hill 1994); PHILLIPPE JORIAN, VALUE AT RISK (McGraw-Hill, 2001) pp.82-85; and JOHN F. MARSHALL; & VIPUL K. BANSAL, FINANCIAL ENGINEERING A COMPLETE GUIDE TO FINANCIAL INNOVATION (N.Y. Inst. of Fin. 1992) pp. 119-121. See also Charles D. Ellis, Levels of the Game, 26 JOURNAL OF PORTFOLIO MANAGEMENT 2 at 12-15 (2000) (discussing the costs and benefits of bundling versus buying and selling individual securities.)

The index in accordance with the principals of the present invention can be converted into the form of a futures contract. An index in accordance with the principals of the present invention would serve as the underlying asset; it would have a notional par value with prices quoted as a percent of par, and it would settle for cash. There would be timely expirations.

For example, the unit of trading of a futures contract in accordance with the principals of the present invention could be $1,000 times the example index for a notional par value of $100,000. The minimum Tick Size could be one thirty-second (1/32^{nd}) of 1 point, with the value of one tick being $31.25. Minimum price fluctuations could be in multiples of points and 32nds of points. There would be no daily price limitations.

There would be 4 quarterly expirations (March, June, September and December). Final settlement would be at the close of business the second Friday of expiration months. The final settlement price could be $1,000 times the closing example index valuation. The final example index value calculation would be based on the settlement prices of 5-year, 10-year and bond contracts.

Two contracts could be listed for trading. The first could be the nearest available calendar delivery month; the second could be the next available delivery month. Eligible pairs for listing can be March-June, June-September, September-December, and December-March. The contracts would settle for cash. Position Limits could be implemented, such as 5,000 contracts in the spot month and in all months combined. Reportable Positions could be implemented, such as 100 contracts.

While the invention has been described with specific embodiments, other alternatives, modifications and variations will be apparent to those skilled in the art. All such alternatives, modifications and variations are intended to be included within the spirit and scope of the appended claims.

APPENDIX I
Front Contract Roll Date

| | | Bonds | | | | | Comdty | Tens | | | | Comdty | Fives | | |
|---|---|---|---|---|---|---|---|---|---|---|---|---|---|---|---|
| USH1 | | Px | Px | Px | | TYH1 | Px | Px | Px | | FVH1 | Px | Px | Px | |
| Comdty | Date | High | Last | Low | Spread | Date | High | Last | Low | Spread | Date | High | Last | Low | Spread |
| USH1 | Jan. 02, 2001 | 106.34 | 06.28 | 104.78 | | Jan. 02, 2001 | 106.28 | 106.19 | 105.06 | | Jan. 02, 2001 | 104.48 | 104.44 | 103.69 | |
| Comdty | | | | | | | | | | | | | | | |
| USH1 | Jan. 03, 2001 | 106.63 | 104.44 | 104.25 | | Jan. 03, 2001 | 106.56 | 104.77 | 104.63 | | Jan. 03, 2001 | 104.53 | 103.52 | 103.34 | |
| Comdty | | | | | | | | | | | | | | | |
| USH1 | an. 04, 2001 | 105.16 | 105.13 | 104.09 | | Jan. 04, 2001 | 105.56 | 105.55 | 104.75 | | Jan. 04, 2001 | 104.09 | 104.08 | 103.63 | |
| Comdty | | | | | | | | | | | | | | | |
| USH1 | Jan. 05, 2001 | 105.63 | 105.59 | 104.56 | | Jan. 05, 2001 | 106.16 | 106.11 | 105.22 | | Jan. 05, 2001 | 104.59 | 104.58 | 103.84 | |
| Comdty | | | | | | | | | | | | | | | |
| USH1 | Jan. 08, 2001 | 105.75 | 105.59 | 105.25 | | Jan. 08, 2001 | 106.5 | 106.38 | 105.8 | | Jan. 08, 2001 | 104.91 | 104.8 | 104.33 | |
| Comdty | | | | | | | | | | | | | | | |
| USH1 | Jan. 09, 2001 | 105.47 | 105.28 | 104.72 | | Jan. 09, 2001 | 106.09 | 105.97 | 105.59 | | Jan. 09, 2001 | 104.56 | 104.41 | 104.17 | |
| Comdty | | | | | | | | | | | | | | | |
| USH1 | Jan. 10, 2001 | 105.28 | 104.5 | 104.34 | | Jan. 10, 2001 | 105.92 | 105.33 | 105.23 | | Jan. 10, 2001 | 104.45 | 103.98 | 103.89 | |
| Comdty | | | | | | | | | | | | | | | |
| USH1 | Jan. 11, 2001 | 104.72 | 103.72 | 103.56 | | Jan. 11, 2001 | 105.63 | 105.11 | 104.86 | | Jan. 11, 2001 | 104.2 | 103.92 | 103.78 | |
| Comdty | | | | | | | | | | | | | | | |
| USH1 | Jan. 12, 2001 | 103.66 | 102.91 | 102.78 | | Jan. 12, 2001 | 105.13 | 104.36 | 104.25 | | Jan. 12, 2001 | 103.92 | 103.45 | 103.34 | |
| Comdty | | | | | | | | | | | | | | | |
| USH1 | Jan. 16, 2001 | 103.34 | 103.19 | 102.78 | | Jan. 16, 2001 | 104.73 | 104.52 | 104.34 | | Jan. 16, 2001 | 103.73 | 103.52 | 103.45 | |
| Comdty | | | | | | | | | | | | | | | |
| USH1 | Jan. 17, 2001 | 104.38 | 104.06 | 102.75 | | Jan. 17, 2001 | 105.31 | 105.02 | 104.16 | | Jan. 17, 2001 | 104.03 | 103.77 | 103.2 | |
| Comdty | | | | | | | | | | | | | | | |
| USH1 | Jan. 18, 2001 | 104.78 | 104.75 | 103.78 | | Jan. 18, 2001 | 105.56 | 105.53 | 104.86 | | Jan. 18, 2001 | 104.19 | 104.14 | 103.69 | |
| Comdty | | | | | | | | | | | | | | | |
| USH1 | Jan. 19, 2001 | 104.53 | 103.72 | 103.56 | | Jan. 19, 2001 | 105.56 | 105.02 | 104.88 | | Jan. 19, 2001 | 104.3 | 103.89 | 103.81 | |
| Comdty | | | | | | | | | | | | | | | |
| USH1 | Jan. 22, 2001 | 103.63 | 103.19 | 103.03 | | Jan. 22, 2001 | 104.98 | 104.67 | 104.59 | | Jan. 22, 2001 | 103.94 | 103.7 | 103.64 | |
| Comdty | | | | | | | | | | | | | | | |
| USH1 | Jan. 23, 2001 | 103.72 | 102.59 | 102.53 | | Jan. 23, 2001 | 105.05 | 104.28 | 104.23 | | Jan. 23, 2001 | 103.91 | 103.41 | 103.38 | |
| Comdty | | | | | | | | | | | | | | | |
| USH1 | Jan. 24, 2001 | 103.03 | 102.44 | 102.19 | | Jan. 24, 2001 | 104.52 | 104.14 | 104.03 | | Jan. 24, 2001 | 103.53 | 103.34 | 103.22 | |
| Comdty | | | | | | | | | | | | | | | |
| USH1 | Jan. 25, 2001 | 103.28 | 102.94 | 101.97 | | Jan. 25, 2001 | 104.56 | 104.38 | 103.63 | | Jan. 25, 2001 | 103.72 | 103.48 | 102.94 | |
| Comdty | | | | | | | | | | | | | | | |
| USH1 | Jan. 26, 2001 | 103.44 | 102.78 | 102.5 | | Jan. 26, 2001 | 104.77 | 104.39 | 104.2 | | Jan. 26, 2001 | 103.78 | 103.58 | 103.5 | |
| Comdty | | | | | | | | | | | | | | | |
| USH1 | Jan. 29, 2001 | 102.97 | 102.44 | 102.28 | | Jan. 29, 2001 | 104.56 | 104.27 | 104.22 | | Jan. 29, 2001 | 103.77 | 103.58 | 103.53 | |
| Comdty | | | | | | | | | | | | | | | |
| USH1 | Jan. 30, 2001 | 103.66 | 103.47 | 102.38 | | Jan. 30, 2001 | 105 | 104.78 | 104.25 | | Jan. 30, 2001 | 103.95 | 103.8 | 103.53 | |
| Comdty | | | | | | | | | | | | | | | |
| USH1 | Jan. 31, 2001 | 104.22 | 104.06 | 103.44 | | Jan. 31, 2001 | 105.31 | 105.22 | 104.81 | | Jan. 31, 2001 | 104.13 | 104.09 | 103.78 | |
| Comdty | | | | | | | | | | | | | | | |
| USH1 | Feb. 01, 2001 | 105.44 | 105.13 | 104.56 | | Feb. 01, 2001 | 105.97 | 105.73 | 105.53 | | Feb. 01, 2001 | 104.5 | 104.33 | 104.2 | |
| Comdty | | | | | | | | | | | | | | | |
| USH1 | Feb. 02, 2001 | 105.28 | 104.41 | 104.38 | | Feb. 02, 2001 | 105.8 | 105.27 | 105.14 | | Feb. 02, 2001 | 104.34 | 103.95 | 103.88 | |
| Comdty | | | | | | | | | | | | | | | |
| USH1 | Feb. 05, 2001 | 105 | 104.69 | 104.38 | | Feb. 05, 2001 | 105.5 | 105.27 | 105.13 | | Feb. 05, 2001 | 104.06 | 103.95 | 103.8 | |
| Comdty | | | | | | | | | | | | | | | |
| USH1 | Feb. 06, 2001 | 104.69 | 104.34 | 104.22 | | Feb. 06, 2001 | 105.27 | 104.95 | 104.89 | | Feb. 06, 2001 | 103.95 | 103.75 | 103.72 | |
| Comdty | | | | | | | | | | | | | | | |
| USH1 | Feb. 07, 2001 | 104.88 | 104.34 | 104.25 | | Feb. 07, 2001 | 105.31 | 105.13 | 105.05 | | Feb. 07, 2001 | 104.02 | 103.83 | 103.78 | |
| Comdty | | | | | | | | | | | | | | | |
| USH1 | Feb. 08, 2001 | 104.56 | 104.34 | 103.75 | | Feb. 08, 2001 | 105.22 | 105.09 | 104.73 | | Feb. 08, 2001 | 103.88 | 103.81 | 103.59 | |
| Comdty | | | | | | | | | | | | | | | |
| USH1 | Feb. 09, 2001 | 105.09 | 105 | 104.47 | | Feb. 09, 2001 | 105.56 | 105.55 | 105.19 | | Feb. 09, 2001 | 104.16 | 104.13 | 103.91 | |
| Comdty | | | | | | | | | | | | | | | |
| USH1 | Feb. 12, 2001 | 105 | 104.41 | 104.31 | | Feb. 12, 2001 | 105.66 | 105.33 | 105.28 | | Feb. 12, 2001 | 104.28 | 104.06 | 104.03 | |
| Comdty | | | | | | | | | | | | | | | |
| USH1 | Feb. 13, 2001 | 105.06 | 104.22 | 103.97 | | Feb. 13, 2001 | 105.69 | 105.17 | 105.08 | | Feb. 13, 2001 | 104.23 | 103.92 | 103.81 | |
| Comdty | | | | | | | | | | | | | | | |
| USH1 | Feb. 14, 2001 | 104.47 | 104.03 | 103.91 | | Feb. 14, 2001 | 105.28 | 104.83 | 104.78 | | Feb. 14, 2001 | 103.95 | 103.59 | 103.53 | |
| Comdty | | | | | | | | | | | | | | | |
| USH1 | Feb. 15, 2001 | 103.81 | 103.22 | 102.97 | | Feb. 15, 2001 | 104.67 | 104.41 | 104.19 | | Feb. 15, 2001 | 103.47 | 103.33 | 103.19 | |
| Comdty | | | | | | | | | | | | | | | |
| USH1 | Feb. 16, 2001 | 103.84 | 103.75 | 102.56 | | Feb. 16, 2001 | 105.03 | 105 | 104.09 | | Feb. 16, 2001 | 103.86 | 103.83 | 103.13 | |
| Comdty | | | | | | | | | | | | | | | |
| USH1 | Feb. 20, 2001 | 103.91 | 103.81 | 103.25 | | Feb. 20, 2001 | 105.05 | 105.02 | 104.66 | | Feb. 20, 2001 | 103.84 | 103.81 | 103.63 | |
| Comdty | | | | | | | | | | | | | | | |
| USH1 | Feb. 21, 2001 | 103.91 | 103.34 | 103.03 | | Feb. 21, 2001 | 105.19 | 104.77 | 104.67 | | Feb. 21, 2001 | 104.03 | 103.72 | 103.64 | |
| Comdty | | | | | | | | | | | | | | | |
| USH1 | Feb. 22, 2001 | 103.81 | 103.22 | 102.94 | | Feb. 22, 2001 | 105.02 | 104.81 | 104.63 | | Feb. 22, 2001 | 103.97 | 103.86 | 103.72 | |
| Comdty | | | | | | | | | | | | | | | |
| USH1 | Feb. 23, 2001 | 104.09 | 103.78 | 103.13 | | Feb. 23, 2001 | 105.3 | 105.16 | 104.86 | | Feb. 23, 2001 | 104.27 | 104.14 | 103.94 | |
| Comdty | | | | | | | | | | | | | | | |
| USH1 | Feb. 26, 2001 | 104.31 | 104.28 | 103.47 | | Feb. 26, 2001 | 105.47 | 105.44 | 104.91 | | Feb. 26, 2001 | 104.36 | 104.33 | 104 | |
| Comdty | | | | | | | | | | | | | | | |
| USH1 | Feb. 27, 2001 | 105.63 | 105.47 | 104.5 | | Feb. 27, 2001 | 106.06 | 105.88 | 105.58 | | Feb. 27, 2001 | 104.69 | 104.47 | 104.39 | |
| Comdty | | | | | | | | | | | | | | | |
| USH1 | Feb. 28, 2001 | 105.88 | 105.59 | 105.06 | | Feb. 28, 2001 | 106.34 | 106.33 | 105.78 | | Feb. 28, 2001 | 104.78 | 104.78 | 104.34 | |
| Comdty | | | | | | | | | | | | | | | |
| USH1 | Mar. 01, 2001 | 106.44 | 106.25 | 105.88 | | Mar. 01, 2001 | 106.72 | 106.53 | 106.22 | | Mar. 01, 2001 | 105 | 104.89 | 104.69 | |
| Comdty | | | | | | | | | | | | | | | |
| USH1 | Mar. 02, 2001 | 106.5 | 105.09 | 105.03 | | Mar. 02, 2001 | 106.66 | 105.91 | 105.88 | | Mar. 02, 2001 | 104.94 | 104.53 | 104.47 | |
| Comdty | | | | | | | | | | | | | | | |
| USH1 | Mar. 05, 2001 | 105.25 | 105.13 | 104.84 | | Mar. 05, 2001 | 105.98 | 105.89 | 105.75 | | Mar. 05, 2001 | 104.63 | 104.5 | 104.44 | |
| Comdty | | | | | | | | | | | | | | | |
| USH1 | Mar. 06, 2001 | 105.59 | 104.94 | 104.75 | | Mar. 06, 2001 | 106.14 | 105.89 | 105.67 | | Mar. 06, 2001 | 104.61 | 104.5 | 104.33 | |
| Comdty | | | | | | | | | | | | | | | |
| USH1 | Mar. 07, 2001 | 105.88 | 105.75 | 104.94 | | Mar. 07, 2001 | 106.31 | 106.25 | 105.92 | | Mar. 07, 2001 | 104.72 | 104.7 | 104.5 | |
| Comdty | | | | | | | | | | | | | | | |
| USH1 | Mar. 08, 2001 | 106.25 | 105.94 | 105.78 | | Mar. 08, 2001 | 106.58 | 106.41 | 106.28 | | Mar. 08, 2001 | 104.92 | 104.8 | 104.77 | |
| Comdty | | | | | | | | | | | | | | | |
| USH1 | Mar. 09, 2001 | 106.25 | 105.72 | 105.19 | 0.313 | Mar. 09, 2001 | 106.48 | 106.13 | 105.81 | | Mar. 09, 2001 | 104.84 | 104.63 | 104.44 | |
| Comdty | | | | | | | | | | | | | | | |
| USH1 | Mar. 12, 2001 | 106.22 | 105.88 | 105.63 | 0.313 | Mar. 12, 2001 | 106.52 | 106.22 | 106.13 | 0.438 | Mar. 12, 2001 | 104.84 | 104.7 | 104.63 | −0.2 |
| | | | | | | | Comdty | | | | | Comdty | | | |
| USM1 | | Px | Px | Px | | TYM1 | Px | Px | Px | | FVM1 | Px | Px | Px | |
| Comdty | Date | High | Last | Low | | Date | High | Last | Low | | Date | High | Last | Low | |
| USM1 | Mar. 09, 2001 | 105.91 | 105.41 | 104.84 | | Mar. 09, 2001 | 106.16 | 105.69 | 105.36 | | Mar. 09, 2001 | 105.08 | 104.83 | 104.63 | |
| Comdty | | | | | | | | | | | | | | | |
| USM1 | Mar. 12, 2001 | 105.94 | 105.56 | 105.28 | | Mar. 12, 2001 | 106.08 | 105.8 | 105.69 | | Mar. 12, 2001 | 105.06 | 104.91 | 104.83 | |
| Comdty | | | | | | | | | | | | | | | |
| USM1 | Mar. 13, 2001 | 105.66 | 105.34 | 105.19 | | Mar. 13, 2001 | 105.88 | 105.64 | 105.63 | | Mar. 13, 2001 | 105.03 | 104.86 | 104.84 | |
| Comdty | | | | | | | | | | | | | | | |
| USM1 | Mar. 14, 2001 | 106.47 | 106.03 | 105.69 | | Mar. 14, 2001 | 106.41 | 106.2 | 105.86 | | Mar. 14, 2001 | 105.44 | 105.33 | 105.08 | |
| Comdty | | | | | | | | | | | | | | | |
| USM1 | Mar. 15, 2001 | 106.53 | 106.13 | 105.75 | | Mar. 15, 2001 | 106.69 | 106.47 | 106.09 | | Mar. 15, 2001 | 105.77 | 105.63 | 105.28 | |
| Comdty | | | | | | | | | | | | | | | |
| USM1 | Mar. 16, 2001 | 106.91 | 106.53 | 106.16 | | Mar. 16, 2001 | 107 | 106.75 | 106.42 | | Mar. 16, 2001 | 105.94 | 105.75 | 105.53 | |
| Comdty | | | | | | | | | | | | | | | |
| USM1 | Mar. 19, 2001 | 106.44 | 106.03 | 105.94 | | Mar. 19, 2001 | 106.61 | 106.34 | 106.33 | | Mar. 19, 2001 | 105.64 | 105.5 | 105.48 | |
| Comdty | | | | | | | | | | | | | | | |
| USM1 | Mar. 20, 2001 | 106.41 | 106.34 | 105.84 | | Mar. 20, 2001 | 106.66 | 106.64 | 106.25 | | Mar. 20, 2001 | 105.8 | 105.77 | 105.41 | |
| Comdty | | | | | | | | | | | | | | | |
| USM1 | Mar. 21, 2001 | 106.81 | 106.34 | 106.19 | | Mar. 21, 2001 | 107.05 | 106.8 | 106.63 | | Mar. 21, 2001 | 106.09 | 105.89 | 105.77 | |
| Comdty | | | | | | | | | | | | | | | |
| USM1 | Mar. 22, 2001 | 107.25 | 106.88 | 106.34 | | Mar. 22, 2001 | 107.36 | 107.2 | 106.81 | | Mar. 22, 2001 | 106.3 | 106.17 | 105.88 | |
| Comdty | | | | | | | | | | | | | | | |
| USM1 | Mar. 23, 2001 | 106.47 | 106.13 | 106.03 | | Mar. 23, 2001 | 107 | 106.72 | 106.69 | | Mar. 23, 2001 | 105.97 | 105.77 | 105.72 | |
| Comdty | | | | | | | | | | | | | | | |
| USM1 | Mar. 26, 2001 | 105.91 | 105.41 | 105.25 | | Mar. 26, 2001 | 106.52 | 106.45 | 106.31 | | Mar. 26, 2001 | 105.63 | 105.61 | 105.47 | |
| Comdty | | | | | | | | | | | | | | | |
| USM1 | Mar. 27, 2001 | 105.75 | 104.13 | 104.09 | | Mar. 27, 2001 | 106.69 | 105.58 | 105.53 | | Mar. 27, 2001 | 105.78 | 104.97 | 104.84 | |
| Comdty | | | | | | | | | | | | | | | |
| USM1 | Mar. 28, 2001 | 104.47 | 104 | 103.81 | | Mar. 28, 2001 | 105.84 | 105.7 | 105.53 | | Mar. 28, 2001 | 105.16 | 105.09 | 104.97 | |
| Comdty | | | | | | | | | | | | | | | |
| USM1 | Mar. 29, 2001 | 104.38 | 103.91 | 103.72 | | Mar. 29, 2001 | 105.95 | 105.84 | 105.66 | | Mar. 29, 2001 | 105.28 | 105.23 | 105.06 | |
| Comdty | | | | | | | | | | | | | | | |
| USM1 | Mar. 30, 2001 | 104.63 | 104.19 | 103.5 | | Mar. 30, 2001 | 106.44 | 106.2 | 105.47 | | Mar. 30, 2001 | 105.64 | 105.52 | 104.91 | |
| Comdty | | | | | | | | | | | | | | | |
| USM1 | Apr. 02, 2001 | 104.47 | 103.88 | 103.66 | | Apr. 02, 2001 | 106.48 | 105.89 | 105.66 | | Apr. 02, 2001 | 105.73 | 105.34 | 105.16 | |
| Comdty | | | | | | | | | | | | | | | |
| USM1 | Apr. 03, 2001 | 104.22 | 104.03 | 103.5 | | Apr. 03, 2001 | 106.16 | 106.06 | 105.69 | | Apr. 03, 2001 | 105.58 | 105.52 | 105.22 | |
| Comdty | | | | | | | | | | | | | | | |
| USM1 | Apr. 04, 2001 | 104.25 | 103.94 | 103.53 | | Apr. 04, 2001 | 106.28 | 106.25 | 105.89 | | Apr. 04, 2001 | 105.72 | 105.69 | 105.47 | |
| Comdty | | | | | | | | | | | | | | | |
| USM1 | Apr. 05, 2001 | 104.19 | 103.63 | 103.59 | | Apr. 05, 2001 | 106.17 | 105.92 | 105.91 | | Apr. 05, 2001 | 105.63 | 105.44 | 105.42 | |
| Comdty | | | | | | | | | | | | | | | |
| USM1 | Apr. 06, 2001 | 104.88 | 104.66 | 103.63 | | Apr. 06, 2001 | 106.86 | 106.66 | 106 | | Apr. 06, 2001 | 106.06 | 105.91 | 105.47 | |
| Comdty | | | | | | | | | | | | | | | |
| USM1 | Apr. 09, 2001 | 104.63 | 104.16 | 104.09 | | Apr. 09, 2001 | 106.64 | 106.44 | 106.38 | | Apr. 09, 2001 | 105.94 | 105.77 | 105.73 | |
| Comdty | | | | | | | | | | | | | | | |
| USM1 | Apr. 10, 2001 | 103.63 | 102.41 | 102.16 | | Apr. 10, 2001 | 106.19 | 105.41 | 105.25 | | Apr. 10, 2001 | 105.63 | 105.22 | 105.03 | |
| Comdty | | | | | | | | | | | | | | | |
| USM1 | Apr. 11, 2001 | 102.75 | 102.5 | 101.97 | | Apr. 11, 2001 | 105.23 | 105.13 | 104.77 | | Apr. 11, 2001 | 105.06 | 104.98 | 104.7 | |
| Comdty | | | | | | | | | | | | | | | |
| USM1 | Apr. 12, 2001 | 102.91 | 102.31 | 102.13 | | Apr. 12, 2001 | 105.44 | 104.78 | 104.73 | | Apr. 12, 2001 | 105.19 | 104.7 | 104.69 | |
| Comdty | | | | | | | | | | | | | | | |
| USM1 | Apr. 16, 2001 | 102.5 | 101.19 | 101.16 | | Apr. 16, 2001 | 104.83 | 103.95 | 103.94 | | Apr. 16, 2001 | 104.73 | 104.13 | 104.11 | |
| Comdty | | | | | | | | | | | | | | | |
| USM1 | Apr. 17, 2001 | 101.94 | 101.88 | 101.38 | | Apr. 17, 2001 | 104.66 | 104.61 | 104.11 | | Apr. 17, 2001 | 104.59 | 104.56 | 104.22 | |
| Comdty | | | | | | | | | | | | | | | |
| USM1 | Apr. 18, 2001 | 102.06 | 102 | 100.78 | | Apr. 18, 2001 | 105.13 | 105.08 | 103.64 | | Apr. 18, 2001 | 105.11 | 105.05 | 103.86 | |
| Comdty | | | | | | | | | | | | | | | |
| USM1 | Apr. 19, 2001 | 101.84 | 100.53 | 100.5 | | Apr. 19, 2001 | 105.06 | 104.22 | 104.19 | | Apr. 19, 2001 | 105.11 | 104.53 | 104.5 | |
| Comdty | | | | | | | | | | | | | | | |
| USM1 | Apr. 20, 2001 | 101.06 | 100.5 | 100.03 | | Apr. 20, 2001 | 104.44 | 104.19 | 103.89 | | Apr. 20, 2001 | 104.64 | 104.52 | 104.31 | |
| Comdty | | | | | | | | | | | | | | | |
| USM1 | Apr. 23, 2001 | 101.44 | 101.25 | 100.63 | | Apr. 23, 2001 | 104.81 | 104.73 | 104.27 | | Apr. 23, 2001 | 104.95 | 104.91 | 104.61 | |
| Comdty | | | | | | | | | | | | | | | |
| USM1 | Apr. 24, 2001 | 101.31 | 101 | 100.66 | | Apr. 24, 2001 | 104.88 | 104.67 | 104.33 | | Apr. 24, 2001 | 105.06 | 104.89 | 104.69 | |
| Comdty | | | | | | | | | | | | | | | |
| USM1 | Apr. 25, 2001 | 101.5 | 100.63 | 100.56 | | Apr. 25, 2001 | 104.91 | 104.23 | 104.22 | | Apr. 25, 2001 | 105.05 | 104.52 | 104.5 | |
| Comdty | | | | | | | | | | | | | | | |
| USM1 | Apr. 26, 2001 | 101.72 | 101.53 | 100.47 | | Apr. 26, 2001 | 104.78 | 104.73 | 104.05 | | Apr. 26, 2001 | 104.83 | 104.81 | 104.36 | |
| Comdty | | | | | | | | | | | | | | | |
| USM1 | Apr. 27, 2001 | 101.44 | 100.25 | 100.19 | | Apr. 27, 2001 | 104.66 | 103.8 | 103.77 | | Apr. 27, 2001 | 104.78 | 104.22 | 104.2 | |
| Comdty | | | | | | | | | | | | | | | |
| USM1 | Apr. 30, 2001 | 100.59 | 100.47 | 99.969 | | Apr. 30, 2001 | 103.81 | 103.78 | 103.31 | | Apr. 30, 2001 | 104.14 | 104.13 | 103.84 | |
| Comdty | | | | | | | | | | | | | | | |
| USM1 | May 01, 2001 | 101.34 | 101.03 | 100.28 | | May 01, 2001 | 104.25 | 104.08 | 103.63 | | May 01, 2001 | 104.38 | 104.25 | 104.03 | |
| Comdty | | | | | | | | | | | | | | | |
| USM1 | May 02, 2001 | 101.72 | 101.53 | 100.78 | | May 02, 2001 | 104.31 | 104.09 | 103.83 | | May 02, 2001 | 104.38 | 104.22 | 104.11 | |
| Comdty | | | | | | | | | | | | | | | |
| USM1 | May 03, 2001 | 102.5 | 102.41 | 101.72 | | May 03, 2001 | 104.81 | 104.77 | 104.19 | | May 03, 2001 | 104.58 | 104.52 | 104.27 | |
| Comdty | | | | | | | | | | | | | | | |
| USM1 | May 04, 2001 | 103.28 | 102.34 | 101.88 | | May 04, 2001 | 105.63 | 104.89 | 104.73 | | May 04, 2001 | 105.09 | 104.7 | 104.55 | |
| Comdty | | | | | | | | | | | | | | | |
| USM1 | May 07, 2001 | 102.25 | 102.09 | 101.84 | | May 07, 2001 | 104.94 | 104.91 | 104.75 | | May 07, 2001 | 104.78 | 104.77 | 104.66 | |
| Comdty | | | | | | | | | | | | | | | |
| USM1 | May 08, 2001 | 102.31 | 101.66 | 101.53 | | May 08, 2001 | 105.23 | 104.78 | 104.77 | | May 08, 2001 | 105.02 | 104.84 | 104.75 | |
| Comdty | | | | | | | | | | | | | | | |
| USM1 | May 09, 2001 | 102.31 | 102.16 | 101.34 | | May 09, 2001 | 105.22 | 105.19 | 104.8 | | May 09, 2001 | 105.02 | 104.98 | 104.86 | |
| Comdty | | | | | | | | | | | | | | | |
| USM1 | May 10, 2001 | 101.91 | 101.03 | 100.88 | | May 10, 2001 | 105.06 | 104.39 | 104.33 | | May 10, 2001 | 104.94 | 104.52 | 104.45 | |
| Comdty | | | | | | | | | | | | | | | |
| USM1 | May 11, 2001 | 100.97 | 99.188 | 99.125 | | May 11, 2001 | 104.36 | 102.97 | 102.92 | | May 11, 2001 | 104.48 | 103.61 | 103.56 | |
| Comdty | | | | | | | | | | | | | | | |
| USM1 | May 14, 2001 | 99.75 | 99.625 | 99.344 | | May 14, 2001 | 103.45 | 103.38 | 103.11 | | May 14, 2001 | 103.88 | 103.81 | 103.66 | |
| Comdty | | | | | | | | | | | | | | | |
| USM1 | May 15, 2001 | 99.781 | 99.031 | 98.969 | | May 15, 2001 | 103.5 | 102.97 | 102.91 | | May 15, 2001 | 103.94 | 103.67 | 103.45 | |
| Comdty | | | | | | | | | | | | | | | |
| USM1 | May 16, 2001 | 100 | 99.438 | 99.094 | | May 16, 2001 | 103.42 | 103.19 | 102.95 | | May 16, 2001 | 103.91 | 103.75 | 103.55 | |
| Comdty | | | | | | | | | | | | | | | |
| USM1 | May 17, 2001 | 100.16 | 100.09 | 99.156 | | May 17, 2001 | 103.36 | 103.3 | 102.69 | | May 17, 2001 | 103.77 | 103.66 | 103.28 | |
| Comdty | | | | | | | | | | | | | | | |
| USM1 | May 18, 2001 | 100.81 | 100.41 | 100.09 | | May 18, 2001 | 103.69 | 103.41 | 103.23 | | May 18, 2001 | 103.78 | 103.59 | 103.41 | |
| Comdty | | | | | | | | | | | | | | | |
| USM1 | May 21, 2001 | 100.72 | 100.47 | 99.75 | | May 21, 2001 | 103.56 | 103.5 | 103.13 | | May 21, 2001 | 103.64 | 103.63 | 103.42 | |
| Comdty | | | | | | | | | | | | | | | |
| USM1 | May 22, 2001 | 100.59 | 100.31 | 100.25 | | May 22, 2001 | 103.69 | 103.5 | 103.47 | | May 22, 2001 | 103.8 | 103.7 | 103.69 | |
| Comdty | | | | | | | | | | | | | | | |
| USM1 | May 23, 2001 | 100.69 | 100.13 | 99.844 | | May 23, 2001 | 103.72 | 103.55 | 103.36 | | May 23, 2001 | 103.86 | 103.8 | 103.69 | |
| Comdty | | | | | | | | | | | | | | | |
| USM1 | May 24, 2001 | 100.59 | 99.25 | 99.156 | | May 24, 2001 | 103.83 | 102.92 | 102.89 | | May 24, 2001 | 103.98 | 103.41 | 103.34 | |
| Comdty | | | | | | | | | | | | | | | |
| USM1 | May 25, 2001 | 99.656 | 99.219 | 99.094 | | May 25, 2001 | 103.11 | 102.95 | 102.8 | | May 25, 2001 | 103.56 | 103.48 | 103.27 | |
| Comdty | | | | | | | | | | | | | | | |
| USM1 | May 29, 2001 | 99.719 | 99.188 | 99.031 | | May 29, 2001 | 103.17 | 102.86 | 102.83 | | May 29, 2001 | 103.64 | 103.44 | 103.41 | |
| Comdty | | | | | | | | | | | | | | | |
| USM1 | May 30, 2001 | 99.406 | 99.25 | 99.031 | | May 30, 2001 | 103.05 | 102.89 | 102.86 | | May 30, 2001 | 103.58 | 103.48 | 103.42 | |
| Comdty | | | | | | | | | | | | | | | |
| USM1 | May 31, 2001 | 100.31 | 100.19 | 99.5 | | May 31, 2001 | 103.72 | 103.69 | 103.08 | | May 31, 2001 | 104.06 | 104.03 | 103.63 | |
| Comdty | | | | | | | | | | | | | | | |
| USM1 | Jun. 01, 2001 | 101.28 | 101 | 99.906 | | Jun. 01, 2001 | 104.3 | 103.92 | 103.47 | | Jun. 01, 2001 | 104.31 | 104.02 | 103.78 | |
| Comdty | | | | | | | | | | | | | | | |
| USM1 | Jun. 04, 2001 | 101.44 | 101.25 | 100.91 | | Jun. 04, 2001 | 104.25 | 104.23 | 103.97 | | Jun. 04, 2001 | 104.17 | 104.14 | 104.02 | |
| Comdty | | | | | | | | | | | | | | | |
| USM1 | Jun. 05, 2001 | 101.75 | 101.66 | 101.03 | | Jun. 05, 2001 | 104.72 | 104.7 | 104.17 | | Jun. 05, 2001 | 104.45 | 104.44 | 104.14 | |
| Comdty | | | | | | | | | | | | | | | |
| USM1 | Jun. 06, 2001 | 101.75 | 101.69 | 101.25 | | Jun. 06, 2001 | 104.69 | 104.69 | 104.41 | | Jun. 06, 2001 | 104.44 | 104.44 | 104.25 | |
| Comdty | | | | | | | | | | | | | | | |
| USM1 | Jun. 07, 2001 | 101.97 | 101.09 | 100.88 | 0.656 | Jun. 07, 2001 | 104.88 | 104.41 | 104.28 | 0.891 | Jun. 07, 2001 | 104.66 | 104.38 | 104.3 | 0.672 |
| Comdty | | | | | | | | | | | | | | | |
| USM1 | Jun. 08, 2001 | 101.31 | 100.91 | 100.84 | 0.656 | Jun. 08, 2001 | 104.34 | 104.08 | 104.06 | 0.891 | Jun. 08, 2001 | 104.28 | 104.09 | 104.09 | 0.672 |
| | | | | | | | Comdty | | | | | Comdty | | | |
| USU1 | | Px | Px | Px | | TYU1 | Px | Px | Px | | FVU1 | Px | Px | Px | |
| Comdty | Date | High | Last | Low | | Date | High | Last | Low | | Date | High | Last | Low | |
| USU1 | Jun. 08, 2001 | 100.69 | 100.25 | 100.19 | | Jun. 08, 2001 | 103.48 | 103.19 | 103.17 | | Jun. 08, 2001 | 103.63 | 103.42 | 103.41 | |
| Comdty | | | | | | | | | | | | | | | |
| USU1 | Jun. 11, 2001 | 101.13 | 100.81 | 100.31 | | Jun. 11, 2001 | 103.73 | 103.59 | 103.22 | | Jun. 11, 2001 | 103.75 | 103.69 | 103.45 | |
| Comdty | | | | | | | | | | | | | | | |
| USU1 | Jun. 12, 2001 | 101.5 | 101.28 | 100.78 | | Jun. 12, 2001 | 104 | 103.91 | 103.66 | | Jun. 12, 2001 | 103.95 | 103.91 | 103.75 | |
| Comdty | | | | | | | | | | | | | | | |
| USU1 | Jun. 13, 2001 | 101.56 | 101.25 | 100.75 | | Jun. 13, 2001 | 104.16 | 103.84 | 103.5 | | Jun. 13, 2001 | 104.13 | 103.95 | 103.66 | |
| Comdty | | | | | | | | | | | | | | | |
| USU1 | Jun. 14, 2001 | 101.81 | 101.56 | 101.22 | | Jun. 14, 2001 | 104.31 | 104.16 | 103.84 | | Jun. 14, 2001 | 104.28 | 104.19 | 103.97 | |
| Comdty | | | | | | | | | | | | | | | |
| USU1 | Jun. 15, 2001 | 102.03 | 101.16 | 101.03 | | Jun. 15, 2001 | 104.56 | 104.06 | 104.03 | | Jun. 15, 2001 | 104.5 | 104.28 | 104.22 | |
| Comdty | | | | | | | | | | | | | | | |
| USU1 | Jun. 18, 2001 | 101.38 | 101.06 | 100.84 | | Jun. 18, 2001 | 104.36 | 104.14 | 104.05 | | Jun. 18, 2001 | 104.45 | 104.3 | 104.22 | |
| Comdty | | | | | | | | | | | | | | | |
| USU1 | Jun. 19, 2001 | 101.31 | 101.22 | 100.53 | | Jun. 19, 2001 | 104.27 | 104.22 | 103.8 | | Jun. 19, 2001 | 104.31 | 104.3 | 104.02 | |
| Comdty | | | | | | | | | | | | | | | |
| USU1 | Jun. 20, 2001 | 101.81 | 101.5 | 101.16 | | Jun. 20, 2001 | 104.55 | 104.44 | 104.22 | | Jun. 20, 2001 | 104.48 | 104.38 | 104.25 | |
| Comdty | | | | | | | | | | | | | | | |
| USU1 | Jun. 21, 2001 | 102.31 | 101.81 | 101.47 | | Jun. 21, 2001 | 104.84 | 104.48 | 104.34 | | Jun. 21, 2001 | 104.58 | 104.42 | 104.33 | |
| Comdty | | | | | | | | | | | | | | | |
| USU1 | Jun. 22, 2001 | 102.72 | 102.69 | 101.97 | | Jun. 22, 2001 | 105.17 | 105 | 104.63 | | Jun. 22, 2001 | 104.84 | 104.81 | 104.47 | |
| Comdty | | | | | | | | | | | | | | | |
| USU1 | Jun. 25, 2001 | 102.75 | 102.5 | 102.31 | | Jun. 25, 2001 | 105.02 | 104.91 | 104.8 | | Jun. 25, 2001 | 104.8 | 104.7 | 104.61 | |
| Comdty | | | | | | | | | | | | | | | |
| USU1 | Jun. 26, 2001 | 102.59 | 101.75 | 101.44 | | Jun. 26, 2001 | 105 | 104.36 | 104.19 | | Jun. 26, 2001 | 104.78 | 104.3 | 104.16 | |
| Comdty | | | | | | | | | | | | | | | |
| USU1 | Jun. 27, 2001 | 102.28 | 101.94 | 101.47 | | Jun. 27, 2001 | 104.52 | 104.22 | 104.03 | | Jun. 27, 2001 | 104.33 | 104 | 103.84 | |
| Comdty | | | | | | | | | | | | | | | |
| USU1 | Jun. 28, 2001 | 102.47 | 101.16 | 100.94 | | Jun. 28, 2001 | 104.38 | 103.52 | 103.38 | | Jun. 28, 2001 | 104.06 | 103.5 | 103.33 | |
| Comdty | | | | | | | | | | | | | | | |
| USU1 | Jun. 29, 2001 | 100.94 | 100.31 | 100.19 | | Jun. 29, 2001 | 103.38 | 103.02 | 102.8 | | Jun. 29, 2001 | 103.55 | 103.34 | 103.17 | |
| Comdty | | | | | | | | | | | | | | | |
| USU1 | Jul. 02, 2001 | 100.94 | 100.91 | 100.13 | | Jul. 02, 2001 | 103.53 | 103.52 | 102.94 | | Jul. 02, 2001 | 103.7 | 103.69 | 103.25 | |
| Comdty | | | | | | | | | | | | | | | |
| USU1 | Jul. 03, 2001 | 100.84 | 100.44 | 100.38 | | Jul. 03, 2001 | 103.53 | 103.17 | 103.16 | | Jul. 03, 2001 | 103.75 | 103.52 | 103.5 | |
| Comdty | | | | | | | | | | | | | | | |
| USU1 | Jul. 05, 2001 | 100.81 | 100.03 | 99.781 | | Jul. 05, 2001 | 103.42 | 102.98 | 102.69 | | Jul. 05, 2001 | 103.7 | 103.38 | 103.31 | |
| Comdty | | | | | | | | | | | | | | | |
| USU1 | Jul. 06, 2001 | 100.56 | 100.38 | 99.813 | | Jul. 06, 2001 | 103.47 | 103.39 | 102.94 | | Jul. 06, 2001 | 103.75 | 103.69 | 103.41 | |
| Comdty | | | | | | | | | | | | | | | |
| USU1 | Jul. 09, 2001 | 100.94 | 100.88 | 100.34 | | Jul. 09, 2001 | 103.61 | 103.58 | 103.3 | | Jul. 09, 2001 | 103.78 | 103.77 | 103.58 | |
| Comdty | | | | | | | | | | | | | | | |
| USU1 | Jul. 10, 2001 | 101.5 | 101.31 | 100.56 | | Jul. 10, 2001 | 104.19 | 104.02 | 103.5 | | Jul. 10, 2001 | 104.22 | 104.08 | 103.77 | |
| Comdty | | | | | | | | | | | | | | | |
| USU1 | Jul. 11, 2001 | 101.72 | 101.06 | 100.97 | | Jul. 11, 2001 | 104.41 | 104.03 | 103.95 | | Jul. 11, 2001 | 104.36 | 104.06 | 104 | |
| Comdty | | | | | | | | | | | | | | | |
| USU1 | Jul. 12, 2001 | 101.94 | 101.66 | 101.19 | | Jul. 12, 2001 | 104.5 | 104.39 | 104.08 | | Jul. 12, 2001 | 104.34 | 104.23 | 104.03 | |
| Comdty | | | | | | | | | | | | | | | |
| USU1 | Jul. 13, 2001 | 101.91 | 101.81 | 101.31 | | Jul. 13, 2001 | 104.5 | 104.41 | 104 | | Jul. 13, 2001 | 104.23 | 104.16 | 103.88 | |
| Comdty | | | | | | | | | | | | | | | |
| USU1 | Jul. 16, 2001 | 102.44 | 102.31 | 101.81 | | Jul. 16, 2001 | 104.88 | 104.81 | 104.5 | | Jul. 16, 2001 | 104.39 | 104.34 | 104.23 | |
| Comdty | | | | | | | | | | | | | | | |
| USU1 | Jul. 17, 2001 | 102.5 | 102.44 | 101.97 | | Jul. 17, 2001 | 104.95 | 104.8 | 104.64 | | Jul. 17, 2001 | 104.42 | 104.3 | 104.25 | |
| Comdty | | | | | | | | | | | | | | | |
| USU1 | Jul. 18, 2001 | 103.44 | 103.41 | 102.13 | | Jul. 18, 2001 | 105.59 | 105.58 | 104.63 | | Jul. 18, 2001 | 104.8 | 104.78 | 104.16 | |
| Comdty | | | | | | | | | | | | | | | |
| USU1 | Jul. 19, 2001 | 103.34 | 103.25 | 102.97 | | Jul. 19, 2001 | 105.44 | 105.36 | 105.25 | | Jul. 19, 2001 | 104.75 | 104.66 | 104.58 | |
| Comdty | | | | | | | | | | | | | | | |
| USU1 | Jul. 20, 2001 | 103.63 | 103.13 | 102.88 | | Jul. 20, 2001 | 105.67 | 105.31 | 105.2 | | Jul. 20, 2001 | 104.89 | 104.69 | 104.61 | |
| Comdty | | | | | | | | | | | | | | | |
| USU1 | Jul. 23, 2001 | 103.41 | 103.38 | 102.84 | | Jul. 23, 2001 | 105.45 | 105.44 | 105.13 | | Jul. 23, 2001 | 104.78 | 104.73 | 104.55 | |
| Comdty | | | | | | | | | | | | | | | |
| USU1 | Jul. 24, 2001 | 103.72 | 103.63 | 103.25 | | Jul. 24, 2001 | 105.64 | 105.58 | 105.38 | | Jul. 24, 2001 | 104.89 | 104.81 | 104.73 | |
| Comdty | | | | | | | | | | | | | | | |
| USU1 | Jul. 25, 2001 | 103.44 | 102.91 | 102.88 | | Jul. 25, 2001 | 105.45 | 105.09 | 105.08 | | Jul. 25, 2001 | 104.78 | 104.63 | 104.61 | |
| Comdty | | | | | | | | | | | | | | | |
| USU1 | Jul. 26, 2001 | 103.16 | 102.88 | 102.78 | | Jul. 26, 2001 | 105.31 | 105.25 | 104.81 | | Jul. 26, 2001 | 104.84 | 104.78 | 104.52 | |
| Comdty | | | | | | | | | | | | | | | |
| USU1 | Jul. 27, 2001 | 103.94 | 103.47 | 103.06 | | Jul. 27, 2001 | 105.77 | 105.64 | 105.38 | | Jul. 27, 2001 | 105.14 | 105.13 | 104.88 | |
| Comdty | | | | | | | | | | | | | | | |
| USU1 | Jul. 30, 2001 | 103.88 | 103.72 | 103.22 | | Jul. 30, 2001 | 105.83 | 105.77 | 105.5 | | Jul. 30, 2001 | 105.25 | 105.22 | 105.08 | |
| Comdty | | | | | | | | | | | | | | | |
| USU1 | Jul. 31, 2001 | 104.16 | 104.03 | 103.5 | | Jul. 31, 2001 | 106.19 | 106.11 | 105.67 | | Jul. 31, 2001 | 105.47 | 105.42 | 105.17 | |
| Comdty | | | | | | | | | | | | | | | |
| USU1 | Aug. 01, 2001 | 104.09 | 103.78 | 103.44 | | Aug. 01, 2001 | 106.13 | 105.86 | 105.61 | | Aug. 01, 2001 | 105.5 | 105.28 | 105.11 | |
| Comdty | | | | | | | | | | | | | | | |
| USU1 | Aug. 02, 2001 | 103.56 | 103.16 | 103.09 | | Aug. 02, 2001 | 105.66 | 105.41 | 105.39 | | Aug. 02, 2001 | 105.11 | 104.95 | 104.91 | |
| Comdty | | | | | | | | | | | | | | | |
| USU1 | Aug. 03, 2001 | 103.25 | 103.06 | 102.56 | | Aug. 03, 2001 | 105.38 | 105.3 | 105 | | Aug. 03, 2001 | 104.91 | 104.86 | 104.59 | |
| Comdty | | | | | | | | | | | | | | | |
| USU1 | Aug. 06, 2001 | 103.13 | 102.97 | 102.63 | | Aug. 06, 2001 | 105.41 | 105.36 | 105.17 | | Aug. 06, 2001 | 104.95 | 104.92 | 104.8 | |
| Comdty | | | | | | | | | | | | | | | |
| USU1 | Aug. 07, 2001 | 103.38 | 102.91 | 102.78 | | Aug. 07, 2001 | 105.53 | 105.31 | 105.28 | | Aug. 07, 2001 | 105.05 | 104.92 | 104.91 | |
| Comdty | | | | | | | | | | | | | | | |
| USU1 | Aug. 08, 2001 | 104.03 | 103.94 | 102.88 | | Aug. 08, 2001 | 106.19 | 106.09 | 105.33 | | Aug. 08, 2001 | 105.48 | 105.42 | 104.98 | |
| Comdty | | | | | | | | | | | | | | | |
| USU1 | Aug. 09, 2001 | 104.41 | 103.66 | 103.56 | | Aug. 09, 2001 | 106.36 | 105.77 | 105.72 | | Aug. 09, 2001 | 105.64 | 105.3 | 105.22 | |
| Comdty | | | | | | | | | | | | | | | |
| USU1 | Aug. 10, 2001 | 104.31 | 104 | 103.66 | | Aug. 10, 2001 | 106.2 | 106.03 | 105.78 | | Aug. 10, 2001 | 105.59 | 105.53 | 105.31 | |
| Comdty | | | | | | | | | | | | | | | |
| USU1 | Aug. 13, 2001 | 104.53 | 104.13 | 103.94 | | Aug. 13, 2001 | 106.44 | 106.25 | 106.03 | | Aug. 13, 2001 | 105.81 | 105.72 | 105.55 | |
| Comdty | | | | | | | | | | | | | | | |
| USU1 | Aug. 14, 2001 | 104.13 | 104.06 | 103.59 | | Aug. 14, 2001 | 106.22 | 106.16 | 105.84 | | Aug. 14, 2001 | 105.67 | 105.63 | 105.44 | |
| Comdty | | | | | | | | | | | | | | | |
| USU1 | Aug. 15, 2001 | 104.34 | 103.94 | 103.53 | | Aug. 15, 2001 | 106.31 | 105.95 | 105.8 | | Aug. 15, 2001 | 105.64 | 105.42 | 105.34 | |
| Comdty | | | | | | | | | | | | | | | |
| USU1 | Aug. 16, 2001 | 104.59 | 104.41 | 103.91 | | Aug. 16, 2001 | 106.47 | 106.34 | 105.83 | | Aug. 16, 2001 | 105.78 | 105.64 | 105.25 | |
| Comdty | | | | | | | | | | | | | | | |
| USU1 | Aug. 17, 2001 | 105.28 | 105.25 | 104.59 | | Aug. 17, 2001 | 106.94 | 106.92 | 106.5 | | Aug. 17, 2001 | 106.03 | 106.02 | 105.75 | |
| Comdty | | | | | | | | | | | | | | | |
| USU1 | Aug. 20, 2001 | 105.09 | 104.78 | 104.63 | | Aug. 20, 2001 | 106.86 | 106.55 | 106.52 | | Aug. 20, 2001 | 105.94 | 105.73 | 105.7 | |
| Comdty | | | | | | | | | | | | | | | |
| USU1 | Aug. 21, 2001 | 105.03 | 104.94 | 104.53 | | Aug. 21, 2001 | 106.72 | 106.63 | 106.41 | | Aug. 21, 2001 | 105.84 | 105.84 | 105.64 | |
| Comdty | | | | | | | | | | | | | | | |
| USU1 | Aug. 22, 2001 | 105.16 | 105.03 | 104.41 | | Aug. 22, 2001 | 106.7 | 106.58 | 106.27 | | Aug. 22, 2001 | 105.89 | 105.73 | 105.55 | |
| Comdty | | | | | | | | | | | | | | | |
| USU1 | Aug. 23, 2001 | 105.56 | 105.44 | 105.09 | | Aug. 23, 2001 | 106.81 | 106.72 | 106.58 | | Aug. 23, 2001 | 105.91 | 105.86 | 105.73 | |
| Comdty | | | | | | | | | | | | | | | |
| USU1 | Aug. 24, 2001 | 105.41 | 105 | 104.59 | | Aug. 24, 2001 | 106.66 | 106.56 | 106.31 | | Aug. 24, 2001 | 105.81 | 105.73 | 105.59 | |
| Comdty | | | | | | | | | | | | | | | |
| USU1 | Aug. 27, 2001 | 105.13 | 104.78 | 104.75 | | Aug. 27, 2001 | 106.66 | 106.52 | 106.47 | | Aug. 27, 2001 | 105.8 | 105.66 | 105.66 | |
| Comdty | | | | | | | | | | | | | | | |
| USU1 | Aug. 28, 2001 | 105.78 | 105.56 | 104.97 | | Aug. 28, 2001 | 107.2 | 107.13 | 106.64 | | Aug. 28, 2001 | 106.08 | 106.03 | 105.73 | |
| Comdty | | | | | | | | | | | | | | | |
| USU1 | Aug. 29, 2001 | 106.22 | 106.19 | 105.44 | | Aug. 29, 2001 | 107.5 | 107.48 | 107.02 | | Aug. 29, 2001 | 106.25 | 106.23 | 105.95 | |
| Comdty | | | | | | | | | | | | | | | |
| USU1 | Aug. 30, 2001 | 106.5 | 106.03 | 105.78 | | Aug. 30, 2001 | 107.75 | 107.42 | 107.31 | | Aug. 30, 2001 | 106.45 | 106.3 | 106.16 | |
| Comdty | | | | | | | | | | | | | | | |
| USU1 | Aug. 31, 2001 | 106.13 | 106.03 | 105.63 | | Aug. 31, 2001 | 107.39 | 107.22 | 107 | | Aug. 31, 2001 | 106.28 | 106.22 | 106.03 | |
| Comdty | | | | | | | | | | | | | | | |
| USU1 | Sep. 04, 2001 | 106 | 104.44 | 104.31 | | Sep. 04, 2001 | 107.23 | 106.22 | 106.17 | | Sep. 04, 2001 | 106.2 | 105.45 | 105.39 | |
| Comdty | | | | | | | | | | | | | | | |
| USU1 | Sep. 05, 2001 | 104.81 | 104.59 | 104.5 | | Sep. 05, 2001 | 106.5 | 106.38 | 106.28 | | Sep. 05, 2001 | 105.7 | 105.59 | 105.58 | |
| Comdty | | | | | | | | | | | | | | | |
| USU1 | Sep. 06, 2001 | 105.63 | 105.5 | 104.69 | | Sep. 06, 2001 | 107.17 | 107.16 | 106.55 | | Sep. 06, 2001 | 106.14 | 106.14 | 105.73 | |
| Comdty | | | | | | | | | | | | | | | |
| USU1 | Sep. 07, 2001 | 106.44 | 106.06 | 105.56 | | Sep. 07, 2001 | 107.94 | 107.61 | 107.16 | | Sep. 07, 2001 | 106.66 | 106.53 | 106.16 | |
| Comdty | | | | | | | | | | | | | | | |
| USU1 | Sep. 10, 2001 | 106.41 | 105.44 | 105.38 | | Sep. 10, 2001 | 107.84 | 107.39 | 107.31 | | Sep. 10, 2001 | 106.75 | 106.5 | 106.45 | |
| Comdty | | | | | | | | | | | | | | | |
| USU1 | Sep. 11, 2001 | 106.69 | 106.63 | 105.31 | | Sep. 11, 2001 | 108.38 | 108.38 | 107.28 | | Sep. 11, 2001 | 107.72 | 107.72 | 106.41 | |
| Comdty | | | | | | | | | | | | | | | |
| USU1 | Sep. 13, 2001 | 106.63 | 106.56 | 105.53 | 0.844 | Sep. 13, 2001 | 109.34 | 109.31 | 108.03 | 0.906 | Sep. 13, 2001 | 108.34 | 108.25 | 107.59 | 0.375 |
| Comdty | | | | | | | | | | | | | | | |
| USU1 | Sep. 14, 2001 | 107.06 | 106.97 | 106.25 | 0.844 | Sep. 14, 2001 | 109.92 | 109.86 | 109.38 | 0.906 | Sep. 14, 2001 | 108.75 | 108.67 | 108.38 | 0.375 |
| | | | | | | | Comdty | | | | | Comdty | | | |
| USZ1 | | Px | Px | Px | | TYZ1 | Px | Px | Px | | FVZ1 | Px | Px | Px | |
| Comdty | Date | High | Last | Low | | Date | High | Last | Low | | Date | High | Last | Low | |
| USZ1 | Sep. 14, 2001 | 106.22 | 106.13 | 105.34 | | Sep. 14, 2001 | 109.06 | 108.95 | 108.47 | | Sep. 14, 2001 | 108.36 | 108.3 | 107.84 | |
| Comdty | | | | | | | | | | | | | | | |
| USZ1 | Sep. 17, 2001 | 106.03 | 105.41 | 105.28 | | Sep. 17, 2001 | 108.88 | 108.47 | 108.28 | | Sep. 17, 2001 | 108.34 | 108.02 | 107.84 | |
| Comdty | | | | | | | | | | | | | | | |
| USZ1 | Sep. 18, 2001 | 105.16 | 103.69 | 103.38 | | Sep. 18, 2001 | 108.59 | 107.81 | 107.63 | | Sep. 18, 2001 | 108.22 | 107.78 | 107.67 | |
| Comdty | | | | | | | | | | | | | | | |
| USZ1 | Sep. 19, 2001 | 103.84 | 103.63 | 102.97 | | Sep. 19, 2001 | 108.19 | 107.97 | 107.56 | | Sep. 19, 2001 | 108.34 | 108.19 | 107.8 | |
| Comdty | | | | | | | | | | | | | | | |
| USZ1 | Sep. 20, 2001 | 103.91 | 102.72 | 102.53 | | Sep. 20, 2001 | 108.17 | 107.55 | 107.47 | | Sep. 20, 2001 | 108.42 | 107.98 | 107.91 | |
| Comdty | | | | | | | | | | | | | | | |
| USZ1 | Sep. 21, 2001 | 103.34 | 103.22 | 102.72 | | Sep. 21, 2001 | 108.17 | 107.92 | 107.69 | | Sep. 21, 2001 | 108.47 | 108.06 | 107.84 | |
| Comdty | | | | | | | | | | | | | | | |
| USZ1 | Sep. 24, 2001 | 103.56 | 103.38 | 102.81 | | Sep. 24, 2001 | 107.97 | 107.73 | 107.41 | | Sep. 24, 2001 | 107.95 | 107.8 | 107.63 | |
| Comdty | | | | | | | | | | | | | | | |
| USZ1 | Sep. 25, 2001 | 103.97 | 103.44 | 103.31 | | Sep. 25, 2001 | 108.19 | 107.94 | 107.88 | | Sep. 25, 2001 | 108.19 | 107.98 | 107.94 | |
| Comdty | | | | | | | | | | | | | | | |
| USZ1 | Sep. 26, 2001 | 104.63 | 104.53 | 103.5 | | Sep. 26, 2001 | 108.52 | 108.47 | 107.88 | | Sep. 26, 2001 | 108.25 | 108.22 | 107.88 | |
| Comdty | | | | | | | | | | | | | | | |
| USZ1 | Sep. 27, 2001 | 105.38 | 105.31 | 104.53 | | Sep. 27, 2001 | 109.08 | 108.92 | 108.61 | | Sep. 27, 2001 | 108.58 | 108.41 | 108.34 | |
| Comdty | | | | | | | | | | | | | | | |
| USZ1 | Sep. 28, 2001 | 106.09 | 105.5 | 105.22 | | Sep. 28, 2001 | 109.33 | 108.78 | 108.72 | | Sep. 28, 2001 | 108.59 | 108.19 | 108.14 | |
| Comdty | | | | | | | | | | | | | | | |
| USZ1 | Oct. 01, 2001 | 106.06 | 106.03 | 105.03 | | Oct. 01, 2001 | 109.16 | 109.05 | 108.56 | | Jan. 01, 2001 | 108.36 | 108.23 | 108 | |
| Comdty | | | | | | | | | | | | | | | |
| USZ1 | Oct. 02, 2001 | 106.91 | 106.56 | 105.91 | | Oct. 02, 2001 | 109.44 | 109.33 | 109.06 | | Oct. 02, 2001 | 108.5 | 108.42 | 108.22 | |
| Comdty | | | | | | | | | | | | | | | |
| USZ1 | Oct. 03, 2001 | 107.34 | 106.72 | 106.69 | | Oct. 03, 2001 | 109.86 | 109.48 | 109.47 | | Oct. 03, 2001 | 108.78 | 108.5 | 108.5 | |
| Comdty | | | | | | | | | | | | | | | |
| USZ1 | Oct. 04, 2001 | 107.28 | 106.88 | 106.53 | | Oct. 04, 2001 | 109.84 | 109.45 | 109.03 | | Oct. 04, 2001 | 108.84 | 108.52 | 108.31 | |
| Comdty | | | | | | | | | | | | | | | |
| USZ1 | Oct. 05, 2001 | 107.19 | 106.78 | 106.66 | | Oct. 05, 2001 | 109.72 | 109.52 | 109.38 | | Oct. 05, 2001 | 108.7 | 108.59 | 108.39 | |
| Comdty | | | | | | | | | | | | | | | |
| USZ1 | Oct. 09, 2001 | 106.66 | 105.94 | 105.91 | | Oct. 09, 2001 | 109.33 | 109 | 108.98 | | Oct. 09, 2001 | 108.55 | 108.31 | 108.3 | |
| Comdty | | | | | | | | | | | | | | | |
| USZ1 | Oct. 10, 2001 | 106.38 | 106.31 | 105.56 | | Oct. 10, 2001 | 109.09 | 109.08 | 108.7 | | Oct. 10, 2001 | 108.31 | 108.28 | 108.06 | |
| Comdty | | | | | | | | | | | | | | | |
| USZ1 | Oct. 11, 2001 | 106.34 | 105.47 | 105.22 | | Oct. 11, 2001 | 109.08 | 108.5 | 108.33 | | Oct. 11, 2001 | 108.3 | 107.84 | 107.75 | |
| Comdty | | | | | | | | | | | | | | | |
| USZ1 | Oct. 12, 2001 | 105.94 | 105.38 | 105.19 | | Oct. 12, 2001 | 108.89 | 108.56 | 108.3 | | Oct. 12, 2001 | 108.2 | 108.03 | 107.75 | |
| Comdty | | | | | | | | | | | | | | | |
| USZ1 | Oct. 15, 2001 | 106.09 | 106.03 | 105.31 | | Oct. 15, 2001 | 109.09 | 109.06 | 108.59 | | Oct. 15, 2001 | 108.38 | 108.34 | 108.11 | |
| Comdty | | | | | | | | | | | | | | | |
| USZ1 | Oct. 16, 2001 | 106.5 | 106.34 | 105.94 | | Oct. 16, 2001 | 109.38 | 109.28 | 109.03 | | Oct. 16, 2001 | 108.56 | 108.47 | 108.38 | |
| Comdty | | | | | | | | | | | | | | | |
| USZ1 | Oct. 17, 2001 | 107 | 106.72 | 106.06 | | Oct. 17, 2001 | 109.5 | 109.31 | 108.88 | | Oct. 17, 2001 | 108.56 | 108.41 | 108.17 | |
| Comdty | | | | | | | | | | | | | | | |
| USZ1 | Oct. 18, 2001 | 107.13 | 106.81 | 106.72 | | Oct. 18, 2001 | 109.47 | 109.36 | 109.23 | | Oct. 18, 2001 | 108.52 | 108.45 | 108.31 | |
| Comdty | | | | | | | | | | | | | | | |
| USZ1 | Oct. 19, 2001 | 107.22 | 106.28 | 106.19 | | Oct. 19, 2001 | 109.66 | 108.94 | 108.89 | | Oct. 19, 2001 | 108.64 | 108.27 | 108.25 | |
| Comdty | | | | | | | | | | | | | | | |
| USZ1 | Oct. 22, 2001 | 106.69 | 106.41 | 106.34 | | Oct. 22, 2001 | 109.16 | 109 | 108.97 | | Oct. 22, 2001 | 108.34 | 108.27 | 108.25 | |
| Comdty | | | | | | | | | | | | | | | |
| USZ1 | Oct. 23, 2001 | 106.22 | 106.22 | 105.75 | | Oct. 23, 2001 | 108.98 | 108.86 | 108.66 | | Oct. 23, 2001 | 108.31 | 108.23 | 108.08 | |
| Comdty | | | | | | | | | | | | | | | |
| USZ1 | Oct. 24, 2001 | 107.28 | 107.09 | 106.28 | | Oct. 24, 2001 | 109.27 | 109.25 | 108.88 | | Oct. 24, 2001 | 108.53 | 108.48 | 108.16 | |
| Comdty | | | | | | | | | | | | | | | |
| USZ1 | Oct. 25, 2001 | 107.81 | 107.56 | 107.06 | | Oct. 25, 2001 | 109.8 | 109.64 | 109.3 | | Oct. 25, 2001 | 108.83 | 108.75 | 108.56 | |
| Comdty | | | | | | | | | | | | | | | |
| USZ1 | Oct. 26, 2001 | 107.78 | 107.69 | 107 | | Oct. 26, 2001 | 109.81 | 109.73 | 109.36 | | Oct. 26, 2001 | 108.83 | 108.8 | 108.59 | |
| Comdty | | | | | | | | | | | | | | | |
| USZ1 | Oct. 29, 2001 | 108.19 | 108.03 | 107.75 | | Oct. 29, 2001 | 110.17 | 110.06 | 109.89 | | Oct. 29, 2001 | 109.14 | 109.06 | 108.92 | |
| Comdty | | | | | | | | | | | | | | | |
| USZ1 | Oct. 30, 2001 | 108.53 | 108.5 | 107.97 | | Oct. 30, 2001 | 110.66 | 110.63 | 110.14 | | Oct. 30, 2001 | 109.45 | 109.44 | 109.14 | |
| Comdty | | | | | | | | | | | | | | | |
| USZ1 | Oct. 31, 2001 | 111.31 | 110.44 | 108.22 | | Oct. 31, 2001 | 111.66 | 111.52 | 110.31 | | Oct. 31, 2001 | 109.92 | 109.86 | 109.06 | |
| Comdty | | | | | | | | | | | | | | | |
| USZ1 | Nov. 01, 2001 | 112.56 | 110.84 | 110.75 | | Nov. 01, 2001 | 112.39 | 111.58 | 111.48 | | Nov. 01, 2001 | 110.19 | 109.84 | 109.72 | |
| Comdty | | | | | | | | | | | | | | | |
| USZ1 | Nov. 02, 2001 | 110.91 | 109.31 | 109.06 | | Nov. 02, 2001 | 111.69 | 110.83 | 110.72 | | Nov. 02, 2001 | 109.97 | 109.48 | 109.44 | |
| Comdty | | | | | | | | | | | | | | | |
| USZ1 | Nov. 05, 2001 | 110.22 | 110.19 | 109.34 | | Nov. 05, 2001 | 111.25 | 111.23 | 110.78 | | Nov. 05, 2001 | 109.72 | 109.7 | 109.42 | |
| Comdty | | | | | | | | | | | | | | | |
| USZ1 | Nov. 06, 2001 | 110.88 | 110.34 | 110.13 | | Nov. 06, 2001 | 111.69 | 111.44 | 111.09 | | Nov. 06, 2001 | 110.03 | 109.91 | 109.38 | |
| Comdty | | | | | | | | | | | | | | | |
| USZ1 | Nov. 07, 2001 | 111.69 | 111.5 | 110.72 | | Nov. 07, 2001 | 112.16 | 112.02 | 111.7 | | Nov. 07, 2001 | 110.41 | 110.31 | 110.16 | |
| Comdty | | | | | | | | | | | | | | | |
| USZ1 | Nov. 08, 2001 | 111.91 | 110.5 | 110.38 | | Nov. 08, 2001 | 112.16 | 111.25 | 111.2 | | Nov. 08, 2001 | 110.31 | 109.84 | 109.81 | |
| Comdty | | | | | | | | | | | | | | | |
| USZ1 | Nov. 09, 2001 | 111.22 | 110.44 | 110.34 | | Nov. 09, 2001 | 111.67 | 111.16 | 111.11 | | Nov. 09, 2001 | 110.09 | 109.7 | 109.64 | |
| Comdty | | | | | | | | | | | | | | | |
| USZ1 | Nov. 13, 2001 | 110.09 | 109.81 | 109.63 | | Nov. 13, 2001 | 110.88 | 110.59 | 110.56 | | Nov. 13, 2001 | 109.47 | 109.39 | 109.33 | |
| Comdty | | | | | | | | | | | | | | | |
| USZ1 | Nov. 14, 2001 | 109.59 | 108.53 | 108.44 | | Nov. 14, 2001 | 110.3 | 109.58 | 109.5 | | Nov. 14, 2001 | 109.14 | 108.69 | 108.64 | |
| Comdty | | | | | | | | | | | | | | | |
| USZ1 | Nov. 15, 2001 | 108.25 | 106.28 | 106.25 | | Nov. 15, 2001 | 109.31 | 107.94 | 107.92 | | Nov. 15, 2001 | 108.48 | 107.56 | 107.53 | |
| Comdty | | | | | | | | | | | | | | | |
| USZ1 | Nov. 16, 2001 | 106.66 | 104.94 | 104.78 | | Nov. 16, 2001 | 108.22 | 106.91 | 106.81 | | Nov. 16, 2001 | 107.77 | 106.84 | 106.8 | |
| Comdty | | | | | | | | | | | | | | | |
| USZ1 | Nov. 19, 2001 | 106.31 | 106.25 | 104.69 | | Nov. 19, 2001 | 107.94 | 107.89 | 107.02 | | Nov. 19, 2001 | 107.58 | 107.55 | 106.98 | |
| Comdty | | | | | | | | | | | | | | | |
| USZ1 | Nov. 20, 2001 | 106.38 | 104.94 | 104.84 | | Nov. 20, 2001 | 108.13 | 107.16 | 107.06 | | Nov. 20, 2001 | 107.78 | 107.3 | 107.14 | |
| Comdty | | | | | | | | | | | | | | | |
| USZ1 | Nov. 21, 2001 | 105.25 | 103.94 | 103.38 | | Nov. 21, 2001 | 107.33 | 106.42 | 105.97 | | Nov. 21, 2001 | 107.39 | 106.72 | 106.42 | |
| Comdty | | | | | | | | | | | | | | | |
| USZ1 | Nov. 23, 2001 | 104.63 | 103.47 | 103.34 | | Nov. 23, 2001 | 106.81 | 106.08 | 105.98 | | Nov. 23, 2001 | 106.89 | 106.44 | 106.34 | |
| Comdty | | | | | | | | | | | | | | | |
| USZ1 | Nov. 26, 2001 | 104.38 | 103.34 | 103.28 | | Nov. 26, 2001 | 106.84 | 106.08 | 106.03 | | Nov. 26, 2001 | 106.94 | 106.42 | 106.31 | |
| Comdty | | | | | | | | | | | | | | | |
| USZ1 | Nov. 27, 2001 | 103.84 | 103.66 | 102.72 | | Nov. 27, 2001 | 106.84 | 106.69 | 105.53 | | Nov. 27, 2001 | 107 | 106.86 | 105.95 | |
| Comdty | | | | | | | | | | | | | | | |
| USZ1 | Nov. 28, 2001 | 104.38 | 103.66 | 103.41 | | Nov. 28, 2001 | 107.45 | 106.69 | 106.56 | | Nov. 28, 2001 | 107.56 | 106.92 | 106.78 | |
| Comdty | | | | | | | | | | | | | | | |
| USZ1 | Nov. 29, 2001 | 105.03 | 104.97 | 103.88 | | Nov. 29, 2001 | 108.13 | 108.09 | 107 | | Nov. 29, 2001 | 107.92 | 107.89 | 107.19 | |
| Comdty | | | | | | | | | | | | | | | |
| USZ1 | Nov. 30, 2001 | 105.47 | 104.78 | 104.16 | | Nov. 30, 2001 | 108.58 | 108.25 | 107.8 | | Nov. 30, 2001 | 108.19 | 108.19 | 107.66 | |
| Comdty | | | | | | | | | | | | | | | |
| USZ1 | Dec. 03, 2001 | 105.31 | 105.16 | 104.69 | | Dec. 03, 2001 | 108.53 | 108.45 | 108 | | Dec. 03, 2001 | 108.3 | 108.27 | 108 | |
| Comdty | | | | | | | | | | | | | | | |
| USZ1 | Dec. 04, 2001 | 106.28 | 106.09 | 105 | | Dec. 04, 2001 | 109.05 | 108.88 | 108.25 | | Dec. 04, 2001 | 108.56 | 108.44 | 108.11 | |
| Comdty | | | | | | | | | | | | | | | |
| USZ1 | Dec. 05, 2001 | 105.59 | 103.72 | 102.72 | | Dec. 05, 2001 | 108.45 | 107.08 | 106.19 | | Dec. 05, 2001 | 108.16 | 107.22 | 106.94 | |
| Comdty | | | | | | | | | | | | | | | |
| USZ1 | Dec. 06, 2001 | 103.72 | 102.63 | 102.56 | | Dec. 06, 2001 | 106.78 | 106.31 | 105.92 | | Dec. 06, 2001 | 107.03 | 106.63 | 106.44 | |
| Comdty | | | | | | | | | | | | | | | |
| USZ1 | Dec. 07, 2001 | 103.22 | 100.56 | 100.5 | | Dec. 07, 2001 | 106.88 | 105.28 | 104.97 | | Dec. 07, 2001 | 107.06 | 106.19 | 105.95 | |
| Comdty | | | | | | | | | | | | | | | |
| USZ1 | Dec. 10, 2001 | 101.56 | 101.13 | 100.66 | | Dec. 10, 2001 | 105.83 | 105.56 | 105.11 | | Dec. 10, 2001 | 106.59 | 106.48 | 106.27 | |
| Comdty | | | | | | | | | | | | | | | |
| USZ1 | Dec. 11, 2001 | 102.25 | 101.56 | 101.38 | | Dec. 11, 2001 | 106.47 | 106 | 105.72 | | Dec. 11, 2001 | 107.08 | 106.86 | 106.66 | |
| Comdty | | | | | | | | | | | | | | | |
| USZ1 | Dec. 12, 2001 | 102.59 | 102.53 | 101.69 | | Dec. 12, 2001 | 106.88 | 106.8 | 106.3 | | Dec. 12, 2001 | 107.31 | 107.23 | 107.09 | |
| Comdty | | | | | | | | | | | | | | | |
| USZ1 | Dec. 13, 2001 | 103.22 | 101.63 | 101.22 | 1.188 | Dec. 13, 2001 | 107.05 | 105.89 | 105.59 | 1.375 | Dec. 13, 2001 | 107.28 | 106.58 | 106.55 | 1.313 |
| Comdty | | | | | | | | | | | | | | | |
| USZ1 | Dec. 14, 2001 | 102.16 | 100.91 | 100.84 | 1.188 | Dec. 14, 2001 | 106.16 | 105.36 | 105.36 | 1.375 | Dec. 14, 2001 | 106.56 | 106.28 | 106.28 | 1.313 |
| | | | | | | | Comdty | | | | | Comdty | | | |
| USH2 | | Px | Px | Px | | TYH2 | Px | Px | Px | | FVH2 | Px | Px | Px | |
| Comdty | Date | High | Last | Low | | Date | High | Last | Low | | Date | High | Last | Low | |
| USH2 | Dec. 14, 2001 | 101.09 | 99.719 | 99.656 | | Dec. 14, 2001 | 104.84 | 103.98 | 103.95 | | Dec. 14, 2001 | 105.47 | 104.97 | 104.88 | |
| Comdty | | | | | | | | | | | | | | | |
| USH2 | Dec. 17, 2001 | 99.5 | 99.25 | 98.031 | | Dec. 17, 2001 | 103.64 | 103.63 | 102.52 | | Dec. 17, 2001 | 104.88 | 104.86 | 104.05 | |
| Comdty | | | | | | | | | | | | | | | |
| USH2 | Dec. 18, 2001 | 100.56 | 100.5 | 99.594 | | Dec. 18, 2001 | 104.42 | 104.39 | 103.73 | | Dec. 18, 2001 | 105.28 | 105.22 | 104.88 | |
| Comdty | | | | | | | | | | | | | | | |
| USH2 | Dec. 19, 2001 | 101.56 | 101.5 | 100.59 | | Dec. 19, 2001 | 105.13 | 105.02 | 104.38 | | Dec. 19, 2001 | 105.67 | 105.47 | 105.17 | |
| Comdty | | | | | | | | | | | | | | | |
| USH2 | Dec. 20, 2001 | 101.78 | 101.41 | 100.84 | | Dec. 20, 2001 | 105.09 | 104.94 | 104.44 | | Dec. 20, 2001 | 105.45 | 105.38 | 105 | |
| Comdty | | | | | | | | | | | | | | | |
| USH2 | Dec. 21, 2001 | 101.81 | 101.09 | 101 | | Dec. 21, 2001 | 105.22 | 104.63 | 104.58 | | Dec. 21, 2001 | 105.67 | 105.27 | 105.23 | |
| Comdty | | | | | | | | | | | | | | | |
| USH2 | Dec. 24, 2001 | 101.25 | 100.69 | 100.47 | | Dec. 24, 2001 | 104.67 | 104.28 | 104.19 | | Dec. 24, 2001 | 105.31 | 105.08 | 105.03 | |
| Comdty | | | | | | | | | | | | | | | |
| USH2 | Dec. 26, 2001 | 100.81 | 100.34 | 100.19 | | Dec. 26, 2001 | 104.25 | 103.95 | 103.86 | | Dec. 26, 2001 | 105.06 | 104.86 | 104.8 | |
| Comdty | | | | | | | | | | | | | | | |
| USH2 | Dec. 27, 2001 | 101.03 | 101 | 100 | | Dec. 27, 2001 | 104.63 | 104.61 | 103.72 | | Dec. 27, 2001 | 105.34 | 105.33 | 104.69 | |
| Comdty | | | | | | | | | | | | | | | |
| USH2 | Dec. 28, 2001 | 101.16 | 100.53 | 100 | | Dec. 28, 2001 | 104.77 | 104.53 | 103.94 | | Dec. 28, 2001 | 105.44 | 105.31 | 104.97 | |
| Comdty | | | | | | | | | | | | | | | |
| USH2 | Dec. 31, 2001 | 101.59 | 101.53 | 100.59 | | Dec. 31, 2001 | 105.34 | 105.14 | 104.56 | | Dec. 31, 2001 | 106 | 105.83 | 105.3 | |
| Comdty | | | | | | | | | | | | | | | |
| USH2 | Jan. 02, 2002 | 101.91 | 100.13 | 99.906 | | Jan. 02, 2002 | 105.22 | 104.31 | 104.13 | | Jan. 02, 2002 | 105.8 | 105.2 | 105.11 | |
| Comdty | | | | | | | | | | | | | | | |
| USH2 | Jan. 03, 2002 | 100.72 | 100.53 | 100.16 | | Jan. 03, 2002 | 104.75 | 104.58 | 104.31 | | Jan. 03, 2002 | 105.5 | 105.34 | 105.23 | |
| Comdty | | | | | | | | | | | | | | | |
| USH2 | Jan. 04, 2002 | 101.06 | 100.22 | 99.344 | | Jan. 04, 2002 | 104.84 | 104.55 | 103.86 | | Jan. 04, 2002 | 105.45 | 105.33 | 104.86 | |
| Comdty | | | | | | | | | | | | | | | |
| USH2 | Jan. 07, 2002 | 101.5 | 101.44 | 100.34 | | Jan. 07, 2002 | 105.33 | 105.31 | 104.64 | | Jan. 07, 2002 | 105.89 | 105.86 | 105.41 | |
| Comdty | | | | | | | | | | | | | | | |
| USH2 | Jan. 08, 2002 | 101.75 | 101.38 | 101.09 | | Jan. 08, 2002 | 105.55 | 105.28 | 105.03 | | Jan. 08, 2002 | 106.05 | 105.84 | 105.67 | |
| Comdty | | | | | | | | | | | | | | | |
| USH2 | Jan. 09, 2002 | 101.59 | 101.5 | 100.81 | | Jan. 09, 2002 | 105.36 | 105.31 | 104.86 | | Jan. 09, 2002 | 105.89 | 105.88 | 105.58 | |
| Comdty | | | | | | | | | | | | | | | |
| USH2 | Jan. 10, 2002 | 103.09 | 102.81 | 101.44 | | Jan. 10, 2002 | 106.28 | 106.03 | 105.28 | | Jan. 10, 2002 | 106.52 | 106.36 | 105.91 | |
| Comdty | | | | | | | | | | | | | | | |
| USH2 | Jan. 11, 2002 | 103.84 | 103.47 | 102.75 | | Jan. 11, 2002 | 107 | 106.64 | 105.97 | | Jan. 11, 2002 | 107.14 | 106.86 | 106.3 | |
| Comdty | | | | | | | | | | | | | | | |
| USH2 | Jan. 14, 2002 | 104 | 103.28 | 103.25 | | Jan. 14, 2002 | 107.13 | 106.72 | 106.67 | | Jan. 14, 2002 | 107.13 | 106.92 | 106.88 | |
| Comdty | | | | | | | | | | | | | | | |
| USH2 | Jan. 15, 2002 | 104.28 | 103.91 | 103.09 | | Jan. 15, 2002 | 107.17 | 107.02 | 106.48 | | Jan. 15, 2002 | 107.06 | 106.97 | 106.66 | |
| Comdty | | | | | | | | | | | | | | | |
| USH2 | Jan. 16, 2002 | 104.34 | 103.75 | 103.34 | | Jan. 16, 2002 | 107.38 | 106.95 | 106.73 | | Jan. 16, 2002 | 107.23 | 106.95 | 106.75 | |
| Comdty | | | | | | | | | | | | | | | |
| USH2 | Jan. 17, 2002 | 103.59 | 102.97 | 102.72 | | Jan. 17, 2002 | 106.88 | 106.3 | 106.19 | | Jan. 17, 2002 | 106.86 | 106.48 | 106.36 | |
| Comdty | | | | | | | | | | | | | | | |
| USH2 | Jan. 18, 2002 | 103.66 | 103.63 | 102.53 | | Jan. 18, 2002 | 106.67 | 106.64 | 105.92 | | Jan. 18, 2002 | 106.78 | 106.77 | 106.25 | |
| Comdty | | | | | | | | | | | | | | | |
| USH2 | Jan. 22, 2002 | 103.63 | 103.47 | 103.03 | | Jan. 22, 2002 | 106.69 | 106.58 | 106.14 | | Jan. 22, 2002 | 106.75 | 106.67 | 106.36 | |
| Comdty | | | | | | | | | | | | | | | |
| USH2 | Jan. 23, 2002 | 103.38 | 102.19 | 102 | | Jan. 23, 2002 | 106.58 | 105.92 | 105.72 | | Jan. 23, 2002 | 106.67 | 106.23 | 106.06 | |
| Comdty | | | | | | | | | | | | | | | |
| USH2 | Jan. 24, 2002 | 102.72 | 102.22 | 101.97 | | Jan. 24, 2002 | 106.2 | 105.7 | 105.55 | | Jan. 24, 2002 | 106.53 | 105.98 | 105.94 | |
| Comdty | | | | | | | | | | | | | | | |
| USH2 | Jan. 25, 2002 | 102.41 | 102.13 | 101.41 | | Jan. 25, 2002 | 105.7 | 105.45 | 104.97 | | Jan. 25, 2002 | 105.98 | 105.83 | 105.52 | |
| Comdty | | | | | | | | | | | | | | | |
| USH2 | Jan. 28, 2002 | 102.59 | 102.28 | 101.66 | | Jan. 28, 2002 | 105.59 | 105.48 | 105.06 | | Jan. 28, 2002 | 105.94 | 105.88 | 105.56 | |
| Comdty | | | | | | | | | | | | | | | |
| USH2 | Jan. 29, 2002 | 103.41 | 103.25 | 101.75 | | Jan. 29, 2002 | 106.34 | 106.27 | 105.14 | | Jan. 29, 2002 | 106.5 | 106.47 | 105.66 | |
| Comdty | | | | | | | | | | | | | | | |
| USH2 | Jan. 30, 2002 | 103.69 | 103.19 | 102.88 | | Jan. 30, 2002 | 106.59 | 106.3 | 105.97 | | Jan. 30, 2002 | 106.69 | 106.47 | 106.27 | |
| Comdty | | | | | | | | | | | | | | | |
| USH2 | Jan. 31, 2002 | 103.56 | 102.84 | 102.69 | | Jan. 31, 2002 | 106.48 | 105.88 | 105.84 | | Jan. 31, 2002 | 106.5 | 106.08 | 106.06 | |
| Comdty | | | | | | | | | | | | | | | |
| USH2 | Feb. 01, 2002 | 103.59 | 103.34 | 102.44 | | Feb. 01, 2002 | 106.42 | 106.25 | 105.56 | | Feb. 01, 2002 | 106.45 | 106.39 | 105.88 | |
| Comdty | | | | | | | | | | | | | | | |
| USH2 | Feb. 04, 2002 | 104.25 | 104.16 | 103.56 | | Feb. 04, 2002 | 106.95 | 106.89 | 106.39 | | Feb. 04, 2002 | 106.84 | 106.78 | 106.48 | |
| Comdty | | | | | | | | | | | | | | | |
| USH2 | Feb. 05, 2002 | 104.53 | 104.09 | 103.41 | | Feb. 05, 2002 | 107.19 | 106.95 | 106.53 | | Feb. 05, 2002 | 107.02 | 106.84 | 106.58 | |
| Comdty | | | | | | | | | | | | | | | |
| USH2 | Feb. 06, 2002 | 104.31 | 103.69 | 103.56 | | Feb. 06, 2002 | 107.16 | 106.75 | 106.66 | | Feb. 06, 2002 | 107.05 | 106.77 | 106.69 | |
| Comdty | | | | | | | | | | | | | | | |
| USH2 | Feb. 07, 2002 | 103.53 | 103.31 | 102.94 | | Feb. 07, 2002 | 106.61 | 106.56 | 106.27 | | Feb. 07, 2002 | 106.77 | 106.73 | 106.48 | |
| Comdty | | | | | | | | | | | | | | | |
| USH2 | Feb. 08, 2002 | 104.41 | 103.88 | 103 | | Feb. 08, 2002 | 107.22 | 106.95 | 106.31 | | Feb. 08, 2002 | 107.22 | 107.06 | 106.61 | |
| Comdty | | | | | | | | | | | | | | | |
| USH2 | Feb. 11, 2002 | 103.78 | 103.59 | 103.34 | | Feb. 11, 2002 | 106.97 | 106.83 | 106.61 | | Feb. 11, 2002 | 107.05 | 106.97 | 106.83 | |
| Comdty | | | | | | | | | | | | | | | |
| USH2 | Feb. 12, 2002 | 103.84 | 102.84 | 102.75 | | Feb. 12, 2002 | 107.03 | 106.31 | 106.3 | | Feb. 12, 2002 | 107.14 | 106.66 | 106.64 | |
| Comdty | | | | | | | | | | | | | | | |
| USH2 | Feb. 13, 2002 | 102.91 | 102.72 | 102 | | Feb. 13, 2002 | 106.27 | 106.13 | 105.61 | | Feb. 13, 2002 | 106.61 | 106.52 | 106.17 | |
| Comdty | | | | | | | | | | | | | | | |
| USH2 | Feb. 14, 2002 | 103.63 | 103.38 | 102.59 | | Feb. 14, 2002 | 106.48 | 106.41 | 105.97 | | Feb. 14, 2002 | 106.69 | 106.67 | 106.38 | |
| Comdty | | | | | | | | | | | | | | | |
| USH2 | Feb. 15, 2002 | 104.44 | 104.22 | 103.47 | | Feb. 15, 2002 | 107.19 | 107.08 | 106.5 | | Feb. 15, 2002 | 107.19 | 107.09 | 106.75 | |
| Comdty | | | | | | | | | | | | | | | |
| USH2 | Feb. 19, 2002 | 104.44 | 103.91 | 103.63 | | Feb. 19, 2002 | 107.3 | 106.95 | 106.77 | | Feb. 19, 2002 | 107.23 | 107.08 | 106.94 | |
| Comdty | | | | | | | | | | | | | | | |
| USH2 | Feb. 20, 2002 | 104.5 | 103.94 | 103.72 | | Feb. 20, 2002 | 107.33 | 107 | 106.73 | | Feb. 20, 2002 | 107.36 | 107.13 | 106.91 | |
| Comdty | | | | | | | | | | | | | | | |
| USH2 | Feb. 21, 2002 | 104.38 | 104.22 | 103.59 | | Feb. 21, 2002 | 107.14 | 107.06 | 106.78 | | Feb. 21, 2002 | 107.2 | 107.16 | 106.95 | |
| Comdty | | | | | | | | | | | | | | | |
| USH2 | Feb. 22, 2002 | 105.13 | 104.66 | 104.56 | | Feb. 22, 2002 | 107.67 | 107.39 | 107.33 | | Feb. 22, 2002 | 107.55 | 107.38 | 107.34 | |
| Comdty | | | | | | | | | | | | | | | |
| USH2 | Feb. 25, 2002 | 104.78 | 104.47 | 104.25 | | Feb. 25, 2002 | 107.52 | 107.23 | 107.16 | | Feb. 25, 2002 | 107.44 | 107.28 | 107.19 | |
| Comdty | | | | | | | | | | | | | | | |
| USH2 | Feb. 26, 2002 | 104.63 | 103.66 | 103.53 | | Feb. 26, 2002 | 107.41 | 106.75 | 106.67 | | Feb. 26, 2002 | 107.42 | 106.98 | 106.92 | |
| Comdty | | | | | | | | | | | | | | | |
| USH2 | Feb. 27, 2002 | 104.59 | 104.5 | 103.47 | | Feb. 27, 2002 | 107.55 | 107.53 | 106.56 | | Feb. 27, 2002 | 107.53 | 107.5 | 106.84 | |
| Comdty | | | | | | | | | | | | | | | |
| USH2 | Feb. 28, 2002 | 104.59 | 104.09 | 103.72 | | Feb. 28, 2002 | 107.53 | 107.25 | 106.94 | | Feb. 28, 2002 | 107.5 | 107.28 | 107.06 | |
| Comdty | | | | | | | | | | | | | | | |
| USH2 | Mar. 01, 2002 | 104.09 | 103 | 102.81 | | Mar. 01, 2002 | 107.11 | 106.52 | 106.42 | | Mar. 01, 2002 | 107.19 | 106.8 | 106.75 | |
| Comdty | | | | | | | | | | | | | | | |
| USH2 | Mar. 04, 2002 | 102.91 | 102.91 | 102.38 | | Mar. 04, 2002 | 106.36 | 106.33 | 106.02 | | Mar. 04, 2002 | 106.7 | 106.7 | 106.47 | |
| Comdty | | | | | | | | | | | | | | | |
| USH2 | Mar. 05, 2002 | 103.19 | 103.09 | 102.25 | | Mar. 05, 2002 | 106.34 | 106.3 | 105.75 | | Mar. 05, 2002 | 106.69 | 106.66 | 106.31 | |
| Comdty | | | | | | | | | | | | | | | |
| USH2 | Mar. 06, 2002 | 103.09 | 102.53 | 102.47 | | Mar. 06, 2002 | 106.41 | 106.11 | 106 | | Mar. 06, 2002 | 106.81 | 106.58 | 106.53 | |
| Comdty | | | | | | | | | | | | | | | |
| USH2 | Mar. 07, 2002 | 102.34 | 100.88 | 100.81 | 1.156 | Mar. 07, 2002 | 106 | 104.89 | 104.88 | 1.391 | Mar. 07, 2002 | 106.48 | 105.73 | 105.73 | 1.234 |
| Comdty | | | | | | | | | | | | | | | |
| USH2 | Mar. 08, 2002 | 100.75 | 100.06 | 99.875 | 1.156 | Mar. 08, 2002 | 104.66 | 104.22 | 104.16 | 1.391 | Mar. 08, 2002 | 105.56 | 105.25 | 105.22 | 1.234 |
| | | | | | | | Comdty | | | | | Comdty | | | |
| USM2 | | Px | Px | Px | | TYM2 | Px | Px | Px | | FVM2 | Px | Px | Px | |
| Comdty | Date | High | Last | Low | | Date | High | Last | Low | | Date | High | Last | Low | |
| USM2 | Mar. 08, 2002 | 99.625 | 98.906 | 98.719 | | Mar. 08, 2002 | 103.31 | 102.83 | 102.75 | | Mar. 08, 2002 | 104.42 | 104.02 | 103.97 | |
| Comdty | | | | | | | | | | | | | | | |
| USM2 | Mar. 11, 2002 | 99.375 | 98.875 | 98.75 | | Mar. 11, 2002 | 103.19 | 102.83 | 102.75 | | Mar. 11, 2002 | 104.28 | 104.06 | 104 | |
| Comdty | | | | | | | | | | | | | | | |
| USM2 | Mar. 12, 2002 | 99.563 | 98.906 | 98.688 | | Mar. 12, 2002 | 103.39 | 102.95 | 102.84 | | Mar. 12, 2002 | 104.48 | 104.23 | 104.16 | |
| Comdty | | | | | | | | | | | | | | | |
| USM2 | Mar. 13, 2002 | 99.344 | 99.156 | 98.469 | | Mar. 13, 2002 | 103.47 | 103.36 | 102.56 | | Mar. 13, 2002 | 104.66 | 104.55 | 103.88 | |
| Comdty | | | | | | | | | | | | | | | |
| USM2 | Mar. 14, 2002 | 98.813 | 97.813 | 97.781 | | Mar. 14, 2002 | 103.16 | 102.3 | 102.28 | | Mar. 14, 2002 | 104.44 | 103.88 | 103.84 | |
| Comdty | | | | | | | | | | | | | | | |
| USM2 | Mar. 15, 2002 | 98.875 | 98.563 | 97.188 | | Mar. 15, 2002 | 102.91 | 102.66 | 101.73 | | Mar. 15, 2002 | 104.22 | 104 | 103.42 | |
| Comdty | | | | | | | | | | | | | | | |
| USM2 | Mar. 18, 2002 | 99.25 | 99.094 | 98.438 | | Mar. 18, 2002 | 103.06 | 103 | 102.61 | | Mar. 18, 2002 | 104.19 | 104.14 | 103.94 | |
| Comdty | | | | | | | | | | | | | | | |
| USM2 | Mar. 19, 2002 | 99.5 | 98.75 | 98.531 | | Mar. 19, 2002 | 103.38 | 102.83 | 102.7 | | Mar. 19, 2002 | 104.44 | 104.06 | 103.92 | |
| Comdty | | | | | | | | | | | | | | | |
| USM2 | Mar. 20, 2002 | 99.406 | 97.938 | 97.781 | | Mar. 20, 2002 | 103.33 | 102.3 | 102.13 | | Mar. 20, 2002 | 104.42 | 103.7 | 103.56 | |
| Comdty | | | | | | | | | | | | | | | |
| USM2 | Mar. 21, 2002 | 98.406 | 98.344 | 97.5 | | Mar. 21, 2002 | 102.61 | 102.5 | 101.91 | | Mar. 21, 2002 | 103.83 | 103.73 | 103.36 | |
| Comdty | | | | | | | | | | | | | | | |
| USM2 | Mar. 22, 2002 | 98.406 | 98.125 | 97.813 | | Mar. 22, 2002 | 102.53 | 102.45 | 102.05 | | Mar. 22, 2002 | 103.75 | 103.69 | 103.42 | |
| Comdty | | | | | | | | | | | | | | | |
| USM2 | Mar. 25, 2002 | 98.281 | 98.219 | 97.563 | | Mar. 25, 2002 | 102.38 | 102.36 | 102.03 | | Mar. 25, 2002 | 103.66 | 103.56 | 103.39 | |
| Comdty | | | | | | | | | | | | | | | |
| USM2 | Mar. 26, 2002 | 99.25 | 98.969 | 97.938 | | Mar. 26, 2002 | 103.02 | 102.84 | 102.19 | | Mar. 26, 2002 | 104.06 | 103.92 | 103.47 | |
| Comdty | | | | | | | | | | | | | | | |
| USM2 | Mar. 27, 2002 | 99.313 | 99 | 98.813 | | Mar. 27, 2002 | 103.03 | 102.92 | 102.77 | | Mar. 27, 2002 | 104.05 | 103.98 | 103.89 | |
| Comdty | | | | | | | | | | | | | | | |
| USM2 | Mar. 28, 2002 | 99.125 | 98.156 | 97.688 | | Mar. 28, 2002 | 103.05 | 102.45 | 102.16 | | Mar. 28, 2002 | 104.11 | 103.73 | 103.55 | |
| Comdty | | | | | | | | | | | | | | | |
| USM2 | Apr. 01, 2002 | 98.75 | 98.25 | 97.969 | | Apr. 01, 2002 | 102.88 | 102.47 | 102.3 | | Apr. 01, 2002 | 104.08 | 103.67 | 103.58 | |
| Comdty | | | | | | | | | | | | | | | |
| USM2 | Apr. 02, 2002 | 99.313 | 99.188 | 97.844 | | Apr. 02, 2002 | 103.19 | 103.08 | 102.19 | | Apr. 02, 2002 | 104.17 | 104.09 | 103.5 | |
| Comdty | | | | | | | | | | | | | | | |
| USM2 | Apr. 03, 2002 | 99.813 | 99.781 | 98.844 | | Apr. 03, 2002 | 103.67 | 103.64 | 102.91 | | Apr. 03, 2002 | 104.53 | 104.5 | 104.02 | |
| Comdty | | | | | | | | | | | | | | | |
| USM2 | Apr. 04, 2002 | 100.34 | 99.938 | 99.75 | | Apr. 04, 2002 | 104.09 | 103.66 | 103.58 | | Apr. 04, 2002 | 104.8 | 104.48 | 104.42 | |
| Comdty | | | | | | | | | | | | | | | |
| USM2 | Apr. 05, 2002 | 100.78 | 100.59 | 99.719 | | Apr. 05, 2002 | 104.38 | 104.23 | 103.53 | | Apr. 05, 2002 | 105 | 104.86 | 104.41 | |
| Comdty | | | | | | | | | | | | | | | |
| USM2 | Apr. 08, 2002 | 100.88 | 100.22 | 100.03 | | Apr. 08, 2002 | 104.48 | 104 | 103.86 | | Apr. 08, 2002 | 105.13 | 104.81 | 104.72 | |
| Comdty | | | | | | | | | | | | | | | |
| USM2 | Apr. 09, 2002 | 100.53 | 100.5 | 99.969 | | Apr. 09, 2002 | 104.25 | 104.23 | 103.75 | | Apr. 09, 2002 | 105 | 104.98 | 104.61 | |
| Comdty | | | | | | | | | | | | | | | |
| USM2 | Apr. 10, 2002 | 100.75 | 100.25 | 100 | | Apr. 10, 2002 | 104.34 | 104.11 | 103.94 | | Apr. 10, 2002 | 105.11 | 105 | 104.83 | |
| Comdty | | | | | | | | | | | | | | | |
| USM2 | Apr. 11, 2002 | 100.97 | 100.63 | 100.09 | | Apr. 11, 2002 | 104.56 | 104.27 | 104.06 | | Apr. 11, 2002 | 105.28 | 105.11 | 105 | |
| Comdty | | | | | | | | | | | | | | | |
| USM2 | Apr. 12, 2002 | 101.16 | 100.97 | 100.22 | | Apr. 12, 2002 | 104.75 | 104.67 | 104.11 | | Apr. 12, 2002 | 105.5 | 105.45 | 105.05 | |
| Comdty | | | | | | | | | | | | | | | |
| USM2 | Apr. 15, 2002 | 101.44 | 101.31 | 100.78 | | Apr. 15, 2002 | 105.05 | 104.88 | 104.63 | | Apr. 15, 2002 | 105.72 | 105.59 | 105.42 | |
| Comdty | | | | | | | | | | | | | | | |
| USM2 | Apr. 16, 2002 | 101.09 | 100.91 | 100.25 | | Apr. 16, 2002 | 104.66 | 104.59 | 104.16 | | Apr. 16, 2002 | 105.47 | 105.42 | 105.11 | |
| Comdty | | | | | | | | | | | | | | | |
| USM2 | Apr. 17, 2002 | 100.78 | 100.06 | 99.844 | | Apr. 17, 2002 | 104.56 | 104.31 | 104.16 | | Apr. 17, 2002 | 105.52 | 105.33 | 105.14 | |
| Comdty | | | | | | | | | | | | | | | |
| USM2 | Apr. 18, 2002 | 101.16 | 100.28 | 99.625 | | Apr. 18, 2002 | 105.22 | 104.41 | 104.11 | | Apr. 18, 2002 | 105.94 | 105.39 | 105.25 | |
| Comdty | | | | | | | | | | | | | | | |
| USM2 | Apr. 19, 2002 | 100.72 | 100.56 | 99.969 | | Apr. 19, 2002 | 104.66 | 104.53 | 104.08 | | Apr. 19, 2002 | 105.45 | 105.42 | 105.11 | |
| Comdty | | | | | | | | | | | | | | | |
| USM2 | Apr. 22, 2002 | 100.78 | 100.75 | 100.47 | | Apr. 22, 2002 | 104.75 | 104.73 | 104.45 | | Apr. 22, 2002 | 105.53 | 105.52 | 105.3 | |
| Comdty | | | | | | | | | | | | | | | |
| USM2 | Apr. 23, 2002 | 101.19 | 100.94 | 100.72 | | Apr. 23, 2002 | 104.89 | 104.75 | 104.58 | | Apr. 23, 2002 | 105.58 | 105.47 | 105.34 | |
| Comdty | | | | | | | | | | | | | | | |
| USM2 | Apr. 24, 2002 | 101.78 | 101.75 | 100.91 | | Apr. 24, 2002 | 105.31 | 105.28 | 104.7 | | Apr. 24, 2002 | 105.88 | 105.86 | 105.41 | |
| Comdty | | | | | | | | | | | | | | | |
| USM2 | Apr. 25, 2002 | 102.31 | 101.81 | 101.59 | | Apr. 25, 2002 | 105.75 | 105.42 | 105.31 | | Apr. 25, 2002 | 106.25 | 106 | 105.91 | |
| Comdty | | | | | | | | | | | | | | | |
| USM2 | Apr. 26, 2002 | 102.28 | 102.22 | 101.5 | | Apr. 26, 2002 | 105.75 | 105.7 | 105.22 | | Apr. 26, 2002 | 106.17 | 106.14 | 105.81 | |
| Comdty | | | | | | | | | | | | | | | |
| USM2 | Apr. 29, 2002 | 102.25 | 101.97 | 101.78 | | Apr. 29, 2002 | 105.69 | 105.45 | 105.34 | | Apr. 29, 2002 | 106.13 | 106 | 105.92 | |
| Comdty | | | | | | | | | | | | | | | |
| USM2 | Apr. 30, 2002 | 102.44 | 102.31 | 101.72 | | Apr. 30, 2002 | 105.61 | 105.56 | 105.28 | | Apr. 30, 2002 | 106.06 | 106.05 | 105.81 | |
| Comdty | | | | | | | | | | | | | | | |
| USM2 | May 01, 2002 | 103.13 | 102.69 | 102.31 | | May 01, 2002 | 106.16 | 105.81 | 105.52 | | May 01, 2002 | 106.47 | 106.27 | 106.02 | |
| Comdty | | | | | | | | | | | | | | | |
| USM2 | May 02, 2002 | 102.59 | 102.16 | 102.06 | | May 02, 2002 | 105.69 | 105.41 | 105.22 | | May 02, 2002 | 106.19 | 106.05 | 105.89 | |
| Comdty | | | | | | | | | | | | | | | |
| USM2 | May 03, 2002 | 103 | 102.72 | 102.06 | | May 03, 2002 | 106.03 | 105.84 | 105.38 | | May 03, 2002 | 106.5 | 106.36 | 106.06 | |
| Comdty | | | | | | | | | | | | | | | |
| USM2 | May 06, 2002 | 102.81 | 102.63 | 102.47 | | May 06, 2002 | 105.88 | 105.72 | 105.64 | | May 06, 2002 | 106.34 | 106.27 | 106.22 | |
| Comdty | | | | | | | | | | | | | | | |
| USM2 | May 07, 2002 | 102.88 | 102.59 | 102.34 | | May 07, 2002 | 105.95 | 105.83 | 105.59 | | May 07, 2002 | 106.5 | 106.45 | 106.22 | |
| Comdty | | | | | | | | | | | | | | | |
| USM2 | May 08, 2002 | 102.28 | 101.13 | 101 | | May 08, 2002 | 105.56 | 104.84 | 104.81 | | May 08, 2002 | 106.25 | 105.8 | 105.77 | |
| Comdty | | | | | | | | | | | | | | | |
| USM2 | May 09, 2002 | 101.63 | 101.53 | 100.78 | | May 09, 2002 | 105.17 | 105.16 | 104.59 | | May 09, 2002 | 106.06 | 106.05 | 105.64 | |
| Comdty | | | | | | | | | | | | | | | |
| USM2 | May 10, 2002 | 102.09 | 102.06 | 101.13 | | May 10, 2002 | 105.72 | 105.69 | 104.84 | | May 10, 2002 | 106.47 | 106.45 | 105.86 | |
| Comdty | | | | | | | | | | | | | | | |
| USM2 | May 13, 2002 | 101.94 | 101.03 | 100.88 | | May 13, 2002 | 105.56 | 105.06 | 105.03 | | May 13, 2002 | 106.38 | 106.06 | 106.05 | |
| Comdty | | | | | | | | | | | | | | | |
| USM2 | May 14, 2002 | 101 | 100.13 | 99.844 | | May 14, 2002 | 104.95 | 104.45 | 104.25 | | May 14, 2002 | 105.95 | 105.63 | 105.44 | |
| Comdty | | | | | | | | | | | | | | | |
| USM2 | May 15, 2002 | 100.63 | 100.38 | 99.969 | | May 15, 2002 | 104.77 | 104.72 | 104.34 | | May 15, 2002 | 105.88 | 105.84 | 105.55 | |
| Comdty | | | | | | | | | | | | | | | |
| USM2 | May 16, 2002 | 101 | 100.88 | 100.31 | | May 16, 2002 | 105.34 | 105.25 | 104.72 | | May 16, 2002 | 106.23 | 106.17 | 105.86 | |
| Comdty | | | | | | | | | | | | | | | |
| USM2 | May 17, 2002 | 100.69 | 100.19 | 99.938 | | May 17, 2002 | 105.2 | 104.83 | 104.63 | | May 17, 2002 | 106.16 | 105.91 | 105.77 | |
| Comdty | | | | | | | | | | | | | | | |
| USM2 | May 20, 2002 | 100.88 | 100.81 | 100.38 | | May 20, 2002 | 105.31 | 105.28 | 105.02 | | May 20, 2002 | 106.2 | 106.19 | 106.05 | |
| Comdty | | | | | | | | | | | | | | | |
| USM2 | May 21, 2002 | 101.34 | 101.25 | 100.5 | | May 21, 2002 | 105.66 | 105.63 | 105.14 | | May 21, 2002 | 106.45 | 106.42 | 106.16 | |
| Comdty | | | | | | | | | | | | | | | |
| USM2 | May 22, 2002 | 101.91 | 101.81 | 101.44 | | May 22, 2002 | 106.06 | 106 | 105.73 | | May 22, 2002 | 106.78 | 106.7 | 106.56 | |
| Comdty | | | | | | | | | | | | | | | |
| USM2 | May 23, 2002 | 102.56 | 101.31 | 101.19 | | May 23, 2002 | 106.48 | 105.73 | 105.56 | | May 23, 2002 | 107.02 | 106.56 | 106.31 | |
| Comdty | | | | | | | | | | | | | | | |
| USM2 | May 24, 2002 | 101.84 | 101.53 | 101.22 | | May 24, 2002 | 106.08 | 105.94 | 105.75 | | May 24, 2002 | 106.75 | 106.64 | 106.5 | |
| Comdty | | | | | | | | | | | | | | | |
| USM2 | May 28, 2002 | 101.81 | 101:5 | 101 | | May 28, 2002 | 106.06 | 106.02 | 105.52 | | May 28, 2002 | 106.73 | 106.7 | 106.38 | |
| Comdty | | | | | | | | | | | | | | | |
| USM2 | May 29, 2002 | 102.13 | 102.03 | 101.41 | | May 29, 2002 | 106.53 | 106.45 | 106.06 | | May 29, 2002 | 107.03 | 106.98 | 106.72 | |
| Comdty | | | | | | | | | | | | | | | |
| USM2 | May 30, 2002 | 102.56 | 102.44 | 101.88 | | May 30, 2002 | 106.92 | 106.83 | 106.45 | | May 30, 2002 | 107.3 | 107.23 | 107 | |
| Comdty | | | | | | | | | | | | | | | |
| USM2 | May 31, 2002 | 102.88 | 102.28 | 101.78 | | May 31, 2002 | 107.03 | 106.73 | 106.42 | | May 31, 2002 | 107.36 | 107.2 | 106.98 | |
| Comdty | | | | | | | | | | | | | | | |
| USM2 | Jun. 03, 2002 | 102.47 | 102.34 | 101.59 | | Jun. 03, 2002 | 106.88 | 106.8 | 106.23 | | Jun. 03, 2002 | 107.3 | 107.25 | 106.84 | |
| Comdty | | | | | | | | | | | | | | | |
| USM2 | Jun. 04, 2002 | 103.09 | 102.5 | 102.38 | | Jun. 04, 2002 | 107.31 | 106.98 | 106.81 | | Jun. 04, 2002 | 107.61 | 107.44 | 107.3 | |
| Comdty | | | | | | | | | | | | | | | |
| USM2 | Jun. 05, 2002 | 102.44 | 102 | 101.84 | | Jun. 05, 2002 | 107 | 106.83 | 106.63 | | Jun. 05, 2002 | 107.44 | 107.36 | 107.17 | |
| Comdty | | | | | | | | | | | | | | | |
| USM2 | Jun. 06, 2002 | 102.75 | 102.53 | 101.66 | | Jun. 06, 2002 | 107.2 | 107.08 | 106.56 | | Jun. 06, 2002 | 107.59 | 107.5 | 107.19 | |
| Comdty | | | | | | | | | | | | | | | |
| USM2 | Jun. 07, 2002 | 103.06 | 101.94 | 101.75 | | Jun. 07, 2002 | 107.59 | 106.81 | 106.63 | | Jun. 07, 2002 | 107.86 | 107.36 | 107.25 | |
| Comdty | | | | | | | | | | | | | | | |
| USM2 | Jun. 10, 2002 | 102.53 | 102.38 | 101.81 | | Jun. 10, 2002 | 107.09 | 106.97 | 106.72 | | Jun. 10, 2002 | 107.41 | 107.39 | 107.25 | |
| Comdty | | | | | | | | | | | | | | | |
| USM2 | Jun. 11, 2002 | 103.06 | 103 | 101.97 | | Jun. 11, 2002 | 107.33 | 107.31 | 106.77 | | Jun. 11, 2002 | 107.66 | 107.64 | 107.3 | |
| Comdty | | | | | | | | | | | | | | | |
| USM2 | Jun. 12, 2002 | 103.53 | 103.38 | 102.94 | | Jun. 12, 2002 | 107.64 | 107.58 | 107.31 | | Jun. 12, 2002 | 107.83 | 107.78 | 107.67 | |
| Comdty | | | | | | | | | | | | | | | |
| USM2 | Jun. 13, 2002 | 104.13 | 103.75 | 103.19 | 1.188 | Jun. 13, 2002 | 108.13 | 107.88 | 107.44 | 1.359 | Jun. 13, 2002 | 108.17 | 108 | 107.94 | 1.281 |
| Comdty | | | | | | | | | | | | | | | |
| USM2 | Jun. 14, 2002 | 105.31 | 105.06 | 104.34 | 1.188 | Jun. 14, 2002 | 108.8 | 108.61 | 108.22 | 1.359 | Jun. 14, 2002 | 108.61 | 108.47 | 108.31 | 1.281 |
| | | | | | | | Comdty | | | | | Comdty | | | |
| USU2 | | Px | Px | Px | | TYU2 | Px | Px | Px | | FVU2 | Px | Px | Px | |
| Comdty | Date | High | Last | Low | | Date | High | Last | Low | | Date | High | Last | Low | |
| USU2 | Jun. 14, 2002 | 104.16 | 103.88 | 103.13 | | Jun. 14, 2002 | 107.42 | 107.25 | 106.83 | | Jun. 14, 2002 | 107.34 | 107.19 | 106.97 | |
| Comdty | | | | | | | | | | | | | | | |
| USU2 | Jun. 17, 2002 | 103.72 | 103.13 | 103.03 | | Jun. 17, 2002 | 107.16 | 106.84 | 106.75 | | Jun. 17, 2002 | 107.11 | 106.98 | 106.88 | |
| Comdty | | | | | | | | | | | | | | | |
| USU2 | Jun. 18, 2002 | 103.84 | 103.22 | 103 | | Jun. 18, 2002 | 107.33 | 106.92 | 106.78 | | Jun. 18, 2002 | 107.31 | 107.06 | 106.97 | |
| Comdty | | | | | | | | | | | | | | | |
| USU2 | Jun. 19, 2002 | 104.38 | 104.34 | 103.56 | | Jun. 19, 2002 | 107.83 | 107.8 | 107.22 | | Jun. 19, 2002 | 107.67 | 107.66 | 107.3 | |
| Comdty | | | | | | | | | | | | | | | |
| USU2 | Jun. 20, 2002 | 104.44 | 103.31 | 103.28 | | Jun. 20, 2002 | 107.86 | 107.03 | 107.02 | | Jun. 20, 2002 | 107.7 | 107.22 | 107.2 | |
| Comdty | | | | | | | | | | | | | | | |
| USU2 | Jun. 21, 2002 | 104.22 | 104.13 | 103.38 | | Jun. 21, 2002 | 107.66 | 107.61 | 107.14 | | Jun. 21, 2002 | 107.55 | 107.53 | 107.25 | |
| Comdty | | | | | | | | | | | | | | | |
| USU2 | Jun. 24, 2002 | 104.66 | 103.25 | 103.09 | | Jun. 24, 2002 | 107.92 | 107.11 | 107 | | Jun. 24, 2002 | 107.73 | 107.22 | 107.16 | |
| Comdty | | | | | | | | | | | | | | | |
| USU2 | Jun. 25, 2002 | 103.44 | 103.19 | 102.59 | | Jun. 25, 2002 | 107.25 | 107.16 | 106.66 | | Jun. 25, 2002 | 107.3 | 107.22 | 106.91 | |
| Comdty | | | | | | | | | | | | | | | |
| USU2 | Jun. 26, 2002 | 105.16 | 104.22 | 103.81 | | Jun. 26, 2002 | 108.8 | 108.05 | 107.67 | | Jun. 26, 2002 | 108.39 | 107.88 | 107.61 | |
| Comdty | | | | | | | | | | | | | | | |
| USU2 | Jun. 27, 2002 | 103.94 | 102.91 | 102.59 | | Jun. 27, 2002 | 107.97 | 107.33 | 107.17 | | Jun. 27, 2002 | 107.86 | 107.44 | 107.33 | |
| Comdty | | | | | | | | | | | | | | | |
| USU2 | Jun. 28, 2002 | 103.09 | 102.78 | 102.44 | | Jun. 28, 2002 | 107.41 | 107.23 | 106.97 | | Jun. 28, 2002 | 107.44 | 107.42 | 107.11 | |
| Comdty | | | | | | | | | | | | | | | |
| USU2 | Jul. 01, 2002 | 103.06 | 102.94 | 102.25 | | Jul. 01, 2002 | 107.41 | 107.3 | 106.94 | | Jul. 01, 2002 | 107.56 | 107.48 | 107.22 | |
| Comdty | | | | | | | | | | | | | | | |
| USU2 | Jul. 02, 2002 | 103.84 | 103.72 | 103.06 | | Jul. 02, 2002 | 107.97 | 107.92 | 107.47 | | Jul. 02, 2002 | 107.94 | 107.89 | 107.63 | |
| Comdty | | | | | | | | | | | | | | | |
| USU2 | Jul. 03, 2002 | 103.97 | 103.72 | 103.47 | | Jul. 03, 2002 | 108.05 | 107.84 | 107.72 | | Jul. 03, 2002 | 108.05 | 107.92 | 107.8 | |
| Comdty | | | | | | | | | | | | | | | |
| USU2 | Jul. 05, 2002 | 103.56 | 102.66 | 102.63 | | Jul. 05, 2002 | 107.64 | 107.03 | 107.02 | | Jul. 05, 2002 | 107.81 | 107.33 | 107.3 | |
| Comdty | | | | | | | | | | | | | | | |
| USU2 | Jul. 08, 2002 | 103.09 | 103 | 102.63 | | Jul. 08, 2002 | 107.42 | 107.41 | 107.08 | | Jul. 08, 2002 | 107.67 | 107.66 | 107.38 | |
| Comdty | | | | | | | | | | | | | | | |
| USU2 | Jul. 09, 2002 | 103.94 | 103.81 | 102.72 | | Jul. 09, 2002 | 107.95 | 107.94 | 107.25 | | Jul. 09, 2002 | 108.11 | 108.09 | 107.63 | |
| Comdty | | | | | | | | | | | | | | | |
| USU2 | Jul. 10, 2002 | 105 | 104.78 | 103.56 | | Jul. 10, 2002 | 108.81 | 108.66 | 107.77 | | Jul. 10, 2002 | 108.78 | 108.66 | 108 | |
| Comdty | | | | | | | | | | | | | | | |
| USU2 | Jul. 11, 2002 | 105.94 | 105.09 | 104.78 | | Jul. 11, 2002 | 109.31 | 108.84 | 108.66 | | Jul. 11, 2002 | 109.03 | 108.7 | 108.59 | |
| Comdty | | | | | | | | | | | | | | | |
| USU2 | Jul. 12, 2002 | 105.66 | 105.25 | 104.53 | | Jul. 12, 2002 | 109.3 | 109.03 | 108.47 | | Jul. 12, 2002 | 108.98 | 108.83 | 108.38 | |
| Comdty | | | | | | | | | | | | | | | |
| USU2 | Jul. 15, 2002 | 105.75 | 104.84 | 104.81 | | Jul. 15, 2002 | 109.47 | 108.94 | 108.91 | | Jul. 15, 2002 | 109.11 | 108.81 | 108.78 | |
| Comdty | | | | | | | | | | | | | | | |
| USU2 | Jul. 16, 2002 | 104.97 | 103.78 | 103.59 | | Jul. 16, 2002 | 109.06 | 108.36 | 108.27 | | Jul. 16, 2002 | 108.89 | 108.36 | 108.31 | |
| Comdty | | | | | | | | | | | | | | | |
| USU2 | Jul. 17, 2002 | 104.31 | 104.22 | 103.22 | | Jul. 17, 2002 | 108.83 | 108.78 | 108.09 | | Jul. 17, 2002 | 108.7 | 108.67 | 108.16 | |
| Comdty | | | | | | | | | | | | | | | |
| USU2 | Jul. 18, 2002 | 104.59 | 104.56 | 103.69 | | Jul. 18, 2002 | 109.2 | 109.17 | 108.48 | | Jul. 18, 2002 | 109 | 108.97 | 108.47 | |
| Comdty | | | | | | | | | | | | | | | |
| USU2 | Jul. 19, 2002 | 105.34 | 105.16 | 104.63 | | Jul. 19, 2002 | 109.64 | 109.47 | 109.28 | | Jul. 19, 2002 | 109.34 | 109.27 | 109.06 | |
| Comdty | | | | | | | | | | | | | | | |
| USU2 | Jul. 22, 2002 | 106.38 | 106.13 | 105.28 | | Jul. 22, 2002 | 110.42 | 110.17 | 109.61 | | Jul. 22, 2002 | 110 | 109.83 | 109.42 | |
| Comdty | | | | | | | | | | | | | | | |
| USU2 | Jul. 23, 2002 | 106.34 | 106.22 | 105.66 | | Jul. 23, 2002 | 110.53 | 110.48 | 109.86 | | Jul. 23, 2002 | 110.13 | 110.09 | 109.63 | |
| Comdty | | | | | | | | | | | | | | | |
| USU2 | Jul. 24, 2002 | 107.81 | 105.94 | 105.81 | | Jul. 24, 2002 | 111.95 | 110.67 | 110.63 | | Jul. 24, 2002 | 111.3 | 110.23 | 110.19 | |
| Comdty | | | | | | | | | | | | | | | |
| USU2 | Jul. 25, 2002 | 106.47 | 106.19 | 105.31 | | Jul. 25, 2002 | 111.13 | 110.84 | 110.34 | | Jul. 25, 2002 | 110.66 | 110.44 | 110.08 | |
| Comdty | | | | | | | | | | | | | | | |
| USU2 | Jul. 26, 2002 | 106.28 | 105.91 | 105.59 | | Jul. 26, 2002 | 111.34 | 111.05 | 110.69 | | Jul. 26, 2002 | 110.86 | 110.72 | 110.39 | |
| Comdty | | | | | | | | | | | | | | | |
| USU2 | Jul. 29, 2002 | 105.59 | 104.59 | 104.44 | | Jul. 29, 2002 | 110.55 | 109.94 | 109.69 | | Jul. 29, 2002 | 110.33 | 109.83 | 109.69 | |
| Comdty | | | | | | | | | | | | | | | |
| USU2 | Jul. 30, 2002 | 105.19 | 104.69 | 104.31 | | Jul. 30, 2002 | 110.22 | 109.73 | 109.52 | | Jul. 30, 2002 | 110.06 | 109.63 | 109.44 | |
| Comdty | | | | | | | | | | | | | | | |
| USU2 | Jul. 31, 2002 | 106.22 | 105.94 | 104.56 | | Jul. 31, 2002 | 110.75 | 110.61 | 109.58 | | Jul. 31, 2002 | 110.41 | 110.33 | 109.53 | |
| Comdty | | | | | | | | | | | | | | | |
| USU2 | Aug. 01, 2002 | 106.44 | 106.25 | 105.66 | | Aug. 01, 2002 | 111.13 | 111.05 | 110.53 | | Aug. 01, 2002 | 110.84 | 110.78 | 110.41 | |
| Comdty | | | | | | | | | | | | | | | |
| USU2 | Aug. 02, 2002 | 107.75 | 107.72 | 106.31 | | Aug. 02, 2002 | 112.25 | 112.14 | 111.14 | | Aug. 02, 2002 | 111.61 | 111.53 | 110.88 | |
| Comdty | | | | | | | | | | | | | | | |
| USU2 | Aug. 05, 2002 | 108.25 | 107.94 | 107.5 | | Aug. 05, 2002 | 112.58 | 112.39 | 112 | | Aug. 05, 2002 | 111.88 | 111.81 | 111.53 | |
| Comdty | | | | | | | | | | | | | | | |
| USU2 | Aug. 06, 2002 | 107.53 | 106.84 | 106.72 | | Aug. 06, 2002 | 111.98 | 111.38 | 111.34 | | Aug. 06, 2002 | 111.55 | 111.09 | 111.08 | |
| Comdty | | | | | | | | | | | | | | | |
| USU2 | Aug. 07, 2002 | 107.84 | 107.53 | 106.91 | | Aug. 07, 2002 | 112.25 | 112.08 | 111.48 | | Aug. 07, 2002 | 111.78 | 111.67 | 111.23 | |
| Comdty | | | | | | | | | | | | | | | |
| USU2 | Aug. 08, 2002 | 107.47 | 107.03 | 106.72 | | Aug. 08, 2002 | 111.89 | 111.45 | 111.39 | | Aug. 08, 2002 | 111.55 | 111.2 | 111.16 | |
| Comdty | | | | | | | | | | | | | | | |
| USU2 | Aug. 09, 2002 | 108.78 | 108.63 | 107.41 | | Aug. 09, 2002 | 112.55 | 112.47 | 111.55 | | Aug. 09, 2002 | 111.69 | 111.59 | 111.19 | |
| Comdty | | | | | | | | | | | | | | | |
| USU2 | Aug. 12, 2002 | 109.72 | 109.31 | 108.88 | | Aug. 12, 2002 | 113.02 | 112.69 | 112.58 | | Aug. 12, 2002 | 111.88 | 111.67 | 111.56 | |
| Comdty | | | | | | | | | | | | | | | |
| USU2 | Aug. 13, 2002 | 110.31 | 110.25 | 109.28 | | Aug. 13, 2002 | 113.42 | 113.31 | 112.63 | | Aug. 13, 2002 | 112.28 | 112.16 | 111.63 | |
| Comdty | | | | | | | | | | | | | | | |
| USU2 | Aug. 14, 2002 | 112.38 | 111.19 | 110.69 | | Aug. 14, 2002 | 114.17 | 113.23 | 112.92 | | Aug. 14, 2002 | 112.59 | 111.8 | 111.67 | |
| Comdty | | | | | | | | | | | | | | | |
| USU2 | Aug. 15, 2002 | 110.56 | 110.06 | 109.53 | | Aug. 15, 2002 | 112.94 | 112.53 | 112.11 | | Aug. 15, 2002 | 111.67 | 111.41 | 110.98 | |
| Comdty | | | | | | | | | | | | | | | |
| USU2 | Aug. 16, 2002 | 110.44 | 108.56 | 108.41 | | Aug. 16, 2002 | 112.91 | 111.52 | 111.48 | | Aug. 16, 2002 | 111.73 | 110.78 | 110.75 | |
| Comdty | | | | | | | | | | | | | | | |
| USU2 | Aug. 19, 2002 | 109.03 | 108.91 | 108.25 | | Aug. 19, 2002 | 111.88 | 111.7 | 111.3 | | Aug. 19, 2002 | 111 | 110.89 | 110.67 | |
| Comdty | | | | | | | | | | | | | | | |
| USU2 | Aug. 20, 2002 | 110.09 | 110.06 | 109.06 | | Aug. 20, 2002 | 112.78 | 112.73 | 111.97 | | Aug. 20, 2002 | 111.67 | 111.64 | 111.17 | |
| Comdty | | | | | | | | | | | | | | | |
| USU2 | Aug. 21, 2002 | 109.91 | 109.78 | 109.09 | | Aug. 21, 2002 | 112.63 | 112.61 | 112.02 | | Aug. 21, 2002 | 111.59 | 111.55 | 111.11 | |
| Comdty | | | | | | | | | | | | | | | |
| USU2 | Aug. 22, 2002 | 109.34 | 108.84 | 108.72 | | Aug. 22, 2002 | 112.28 | 111.98 | 111.92 | | Aug. 22, 2002 | 111.41 | 111.09 | 111.08 | |
| Comdty | | | | | | | | | | | | | | | |
| USU2 | Aug. 23, 2002 | 110.09 | 109.94 | 108.97 | | Aug. 23, 2002 | 112.58 | 112.5 | 112.02 | | Aug. 23, 2002 | 111.5 | 111.45 | 111.13 | |
| Comdty | | | | | | | | | | | | | | | |
| USU2 | Aug. 26, 2002 | 110.28 | 110.13 | 109.38 | | Aug. 26, 2002 | 112.88 | 112.72 | 112.22 | | Aug. 26, 2002 | 111.75 | 111.59 | 111.28 | |
| Comdty | | | | | | | | | | | | | | | |
| USU2 | Aug. 27, 2002 | 110.22 | 109.09 | 109 | | Aug. 27, 2002 | 112.72 | 112.19 | 112 | | Aug. 27, 2002 | 111.58 | 111.27 | 111.06 | |
| Comdty | | | | | | | | | | | | | | | |
| USU2 | Aug. 28, 2002 | 110.06 | 109.88 | 109.59 | | Aug. 28, 2002 | 112.8 | 112.58 | 112.45 | | Aug. 28, 2002 | 111.63 | 111.48 | 111.39 | |
| Comdty | | | | | | | | | | | | | | | |
| USU2 | Aug. 29, 2002 | 111.03 | 110.56 | 110.22 | | Aug. 29, 2002 | 113.34 | 113.03 | 112.86 | | Aug. 29, 2002 | 112.02 | 111.88 | 111.73 | |
| Comdty | | | | | | | | | | | | | | | |
| USU2 | Aug. 30, 2002 | 111.03 | 110.88 | 110.5 | | Aug. 30, 2002 | 113.34 | 113.17 | 112.88 | | Aug. 30, 2002 | 112.16 | 112.03 | 111.86 | |
| Comdty | | | | | | | | | | | | | | | |
| USU2 | Sep. 03, 2002 | 112.91 | 112.72 | 111.44 | | Sep. 03, 2002 | 114.56 | 114.41 | 113.63 | | Sep. 03, 2002 | 112.97 | 112.92 | 112.36 | |
| Comdty | | | | | | | | | | | | | | | |
| USU2 | Sep. 04, 2002 | 113.09 | 112.94 | 112.47 | | Sep. 04, 2002 | 114.8 | 114.63 | 114.27 | | Sep. 04, 2002 | 113.22 | 112.97 | 112.84 | |
| Comdty | | | | | | | | | | | | | | | |
| USU2 | Sep. 05, 2002 | 113.53 | 113.41 | 112.53 | | Sep. 05, 2002 | 115.09 | 114.95 | 114.5 | | Sep. 05, 2002 | 113.33 | 113.28 | 112.92 | |
| Comdty | | | | | | | | | | | | | | | |
| USU2 | Sep. 06, 2002 | 113.09 | 111.81 | 111.72 | | Sep. 06, 2002 | 114.92 | 114.08 | 114.05 | | Sep. 06, 2002 | 113.03 | 112.63 | 112.59 | |
| Comdty | | | | | | | | | | | | | | | |
| USU2 | Sep. 09, 2002 | 112.44 | 111.81 | 111.78 | | Sep. 09, 2002 | 114.45 | 113.97 | 113.97 | | Sep. 09, 2002 | 112.78 | 112.48 | 112.48 | |
| Comdty | | | | | | | | | | | | | | | |
| USU2 | Sep. 10, 2002 | 112.63 | 112.41 | 111.19 | | Sep. 10, 2002 | 114.44 | 114.31 | 113.56 | | Sep. 10, 2002 | 112.75 | 112.66 | 112.14 | |
| Comdty | | | | | | | | | | | | | | | |
| USU2 | Sep. 11, 2002 | 111.75 | 111.69 | 111.06 | | Sep. 11, 2002 | 113.88 | 113.81 | 113.44 | | Sep. 11, 2002 | 112.3 | 112.3 | 112.02 | |
| Comdty | | | | | | | | | | | | | | | |
| USU2 | Sep. 12, 2002 | 112.78 | 112.72 | 111.88 | 1.188 | Sep. 12, 2002 | 114.5 | 114.47 | 113.97 | 1.25 | Sep. 12, 2002 | 112.73 | 112.72 | 112.45 | 0.656 |
| Comdty | | | | | | | | | | | | | | | |
| USU2 | Sep. 13, 2002 | 113.81 | 113.63 | 112.84 | 1.188 | Sep. 13, 2002 | 115 | 114.91 | 114.56 | 1.25 | Sep. 13, 2002 | 112.98 | 112.97 | 112.83 | 0.656 |
| | | | | | | | Comdty | | | | | Comdty | | | |
| USZ2 | | Px | Px | Px | | TYZ2 | Px | Px | Px | | FVZ2 | Px | Px | Px | |
| Comdty | Date | High | Last | Low | | Date | High | Last | Low | | Date | High | Last | Low | |
| USZ2 | Sep. 13, 2002 | 112.66 | 112.44 | 111.66 | | Sep. 13, 2002 | 113.78 | 113.66 | 113.28 | | Sep. 13, 2002 | 112.36 | 112.31 | 112.05 | |
| Comdty | | | | | | | | | | | | | | | |
| USZ2 | Sep. 16, 2002 | 113 | 112.78 | 111.97 | | Sep. 16, 2002 | 114.05 | 113.89 | 113.45 | | Sep. 16, 2002 | 112.59 | 112.47 | 112.16 | |
| Comdty | | | | | | | | | | | | | | | |
| USZ2 | Sep. 17, 2002 | 112.97 | 112.91 | 111.69 | | Sep. 17, 2002 | 114.13 | 114.02 | 113.22 | | Sep. 17, 2002 | 112.63 | 112.56 | 111.92 | |
| Comdty | | | | | | | | | | | | | | | |
| USZ2 | Sep. 18, 2002 | 113.41 | 112.78 | 112.59 | | Sep. 18, 2002 | 114.41 | 114.08 | 114 | | Sep. 18, 2002 | 112.88 | 112.63 | 112.59 | |
| Comdty | | | | | | | | | | | | | | | |
| USZ2 | Sep. 19, 2002 | 113.63 | 113.38 | 112.84 | | Sep. 19, 2002 | 114.77 | 114.58 | 114.25 | | Sep. 19, 2002 | 113.17 | 113.03 | 112.78 | |
| Comdty | | | | | | | | | | | | | | | |
| USZ2 | Sep. 20, 2002 | 113.31 | 113.06 | 112.63 | | Sep. 20, 2002 | 114.73 | 114.69 | 114.23 | | Sep. 20, 2002 | 113.17 | 113.16 | 112.83 | |
| Comdty | | | | | | | | | | | | | | | |
| USZ2 | Sep. 23, 2002 | 114.16 | 114.09 | 113.38 | | Sep. 23, 2002 | 115.45 | 115.34 | 114.95 | | Sep. 23, 2002 | 113.64 | 113.58 | 113.36 | |
| Comdty | | | | | | | | | | | | | | | |
| USZ2 | Sep. 24, 2002 | 114.97 | 114.5 | 114.09 | | Sep. 24, 2002 | 115.94 | 115.5 | 115.38 | | Sep. 24, 2002 | 114.09 | 113.77 | 113.66 | |
| Comdty | | | | | | | | | | | | | | | |
| USZ2 | Sep. 25, 2002 | 114.19 | 113.06 | 112.84 | | Sep. 25, 2002 | 115.39 | 114.69 | 114.55 | | Sep. 25, 2002 | 113.69 | 113.19 | 113.11 | |
| Comdty | | | | | | | | | | | | | | | |
| USZ2 | Sep. 26, 2002 | 113.28 | 113 | 112.13 | | Sep. 26, 2002 | 114.92 | 114.7 | 114.11 | | Sep. 26, 2002 | 113.39 | 113.13 | 112.73 | |
| Comdty | | | | | | | | | | | | | | | |
| USZ2 | Sep. 27, 2002 | 113.88 | 113.72 | 113 | | Sep. 27, 2002 | 115.36 | 115.28 | 114.75 | | Sep. 27, 2002 | 113.69 | 113.64 | 113.2 | |
| Comdty | | | | | | | | | | | | | | | |
| USZ2 | Sep. 30, 2002 | 114.97 | 114.25 | 114.13 | | Sep. 30, 2002 | 116.19 | 115.91 | 115.56 | | Sep. 30, 2002 | 114.44 | 114.28 | 113.86 | |
| Comdty | | | | | | | | | | | | | | | |
| USZ2 | Oct. 01, 2002 | 113.56 | 113.31 | 112.69 | | Oct. 01, 2002 | 115.64 | 115.22 | 115.08 | | Oct. 01, 2002 | 114.17 | 113.75 | 113.69 | |
| Comdty | | | | | | | | | | | | | | | |
| USZ2 | Oct. 02, 2002 | 113.75 | 113.53 | 112.91 | | Oct. 02, 2002 | 115.33 | 115.27 | 114.73 | | Oct. 02, 2002 | 113.75 | 113.7 | 113.34 | |
| Comdty | | | | | | | | | | | | | | | |
| USZ2 | Oct. 03, 2002 | 113.91 | 113.44 | 113.09 | | Oct. 03, 2002 | 115.56 | 115.34 | 114.94 | | Oct. 03, 2002 | 113.94 | 113.78 | 113.5 | |
| Comdty | | | | | | | | | | | | | | | |
| USZ2 | Oct. 04, 2002 | 114.25 | 113.63 | 112.25 | | Oct. 04, 2002 | 115.75 | 115.39 | 114.44 | | Oct. 04, 2002 | 113.98 | 113.8 | 113 | |
| Comdty | | | | | | | | | | | | | | | |
| USZ2 | Oct. 07, 2002 | 114.44 | 113.94 | 113.69 | | Oct. 07, 2002 | 115.92 | 115.73 | 115.5 | | Oct. 07, 2002 | 114.17 | 114.03 | 113.89 | |
| Comdty | | | | | | | | | | | | | | | |
| USZ2 | Oct. 08, 2002 | 115.13 | 113.84 | 113.63 | | Oct. 08, 2002 | 116.25 | 115.59 | 115.47 | | Oct. 08, 2002 | 114.34 | 113.86 | 113.83 | |
| Comdty | | | | | | | | | | | | | | | |
| USZ2 | Oct. 09, 2002 | 114.81 | 114.63 | 114.19 | | Oct. 09, 2002 | 116.2 | 116.16 | 115.78 | | Oct. 09, 2002 | 114.38 | 114.34 | 114.02 | |
| Comdty | | | | | | | | | | | | | | | |
| USZ2 | Oct. 10, 2002 | 114.56 | 113.75 | 113.44 | | Oct. 10, 2002 | 116.31 | 115.7 | 115.52 | | Oct. 10, 2002 | 114.56 | 114.11 | 113.97 | |
| Comdty | | | | | | | | | | | | | | | |
| USZ2 | Oct. 11, 2002 | 113.63 | 112.31 | 112.09 | | Oct. 11, 2002 | 115.66 | 114.81 | 114.73 | | Oct. 11, 2002 | 114.02 | 113.48 | 113.41 | |
| Comdty | | | | | | | | | | | | | | | |
| USZ2 | Oct. 15, 2002 | 111.25 | 110.16 | 110.09 | | Oct. 15, 2002 | 113.92 | 113.3 | 113.23 | | Oct. 15, 2002 | 112.81 | 112.34 | 112.3 | |
| Comdty | | | | | | | | | | | | | | | |
| USZ2 | Oct. 16, 2002 | 110.38 | 109.78 | 109.41 | | Oct. 16, 2002 | 113.5 | 113.13 | 112.88 | | Oct. 16, 2002 | 112.5 | 112.23 | 112.05 | |
| Comdty | | | | | | | | | | | | | | | |
| USZ2 | Oct. 17, 2002 | 109.22 | 108.78 | 108.47 | | Oct. 17, 2002 | 112.73 | 112.56 | 112.22 | | Oct. 17, 2002 | 111.97 | 111.81 | 111.55 | |
| Comdty | | | | | | | | | | | | | | | |
| USZ2 | Oct. 18, 2002 | 109 | 108.69 | 107.5 | | Oct. 18, 2002 | 112.86 | 112.69 | 111.84 | | Oct. 18, 2002 | 112.05 | 111.89 | 111.3 | |
| Comdty | | | | | | | | | | | | | | | |
| USZ2 | Oct. 21, 2002 | 109.22 | 108.06 | 107.78 | | Oct. 21, 2002 | 112.94 | 112.14 | 111.97 | | Oct. 21, 2002 | 112 | 111.47 | 111.34 | |
| Comdty | | | | | | | | | | | | | | | |
| USZ2 | Oct. 22, 2002 | 108.31 | 107.72 | 107.56 | | Oct. 22, 2002 | 112.36 | 112.05 | 111.84 | | Oct. 22, 2002 | 111.63 | 111.41 | 111.33 | |
| Comdty | | | | | | | | | | | | | | | |
| USZ2 | Oct. 23, 2002 | 108.72 | 107.63 | 107.5 | | Oct. 23, 2002 | 112.75 | 112.13 | 112.03 | | Oct. 23, 2002 | 111.91 | 111.47 | 111.38 | |
| Comdty | | | | | | | | | | | | | | | |
| USZ2 | Oct. 24, 2002 | 108.53 | 108.44 | 107.06 | | Oct. 24, 2002 | 112.78 | 112.73 | 111.8 | | Oct. 24, 2002 | 111.94 | 111.92 | 111.3 | |
| Comdty | | | | | | | | | | | | | | | |
| USZ2 | Oct. 25, 2002 | 109.13 | 109 | 108.41 | | Oct. 25, 2002 | 113.22 | 113.14 | 112.7 | | Oct. 25, 2002 | 112.42 | 112.39 | 111.95 | |
| Comdty | | | | | | | | | | | | | | | |
| USZ2 | Oct. 28, 2002 | 109.38 | 108.97 | 108.81 | | Oct. 28, 2002 | 113.59 | 113.36 | 113.22 | | Oct. 28, 2002 | 112.81 | 112.7 | 112.58 | |
| Comdty | | | | | | | | | | | | | | | |
| USZ2 | Oct. 29, 2002 | 111.03 | 110.56 | 109.28 | | Oct. 29, 2002 | 114.7 | 114.39 | 113.52 | | Oct. 29, 2002 | 113.7 | 113.47 | 112.83 | |
| Comdty | | | | | | | | | | | | | | | |
| USZ2 | Oct. 30, 2002 | 110.75 | 110.22 | 109.91 | | Oct. 30, 2002 | 114.61 | V14.27 | 113.97 | | Oct. 30, 2002 | 113.64 | 113.47 | 113.14 | |
| Comdty | | | | | | | | | | | | | | | |
| USZ2 | Oct. 31, 2002 | 111.06 | 110.66 | 109.91 | | Oct. 31, 2002 | 114.88 | 114.72 | 114 | | Oct. 31, 2002 | 113.88 | 113.73 | 113.22 | |
| Comdty | | | | | | | | | | | | | | | |
| USZ2 | Nov. 01, 2002 | 110.94 | 110.34 | 109.34 | | Nov. 01, 2002 | 114.86 | 114.25 | 113.83 | | Nov. 01, 2002 | 113.73 | 113.36 | 113.03 | |
| Comdty | | | | | | | | | | | | | | | |
| USZ2 | Nov. 04, 2002 | 109.91 | 109.69 | 109.34 | | Nov. 04, 2002 | 113.84 | 113.81 | 113.5 | | Nov. 04, 2002 | 113.03 | 112.97 | 112.78 | |
| Comdty | | | | | | | | | | | | | | | |
| USZ2 | Nov. 05, 2002 | 109.75 | 109.44 | 109.09 | | Nov. 05, 2002 | 113.78 | 113.63 | 113.38 | | Nov. 05, 2002 | 112.95 | 112.89 | 112.66 | |
| Comdty | | | | | | | | | | | | | | | |
| USZ2 | Nov. 06, 2002 | 110.69 | 109.91 | 108.88 | | Nov. 06, 2002 | 114.48 | 113.84 | 113.22 | | Nov. 06, 2002 | 113.5 | 112.98 | 112.61 | |
| Comdty | | | | | | | | | | | | | | | |
| USZ2 | Nov. 07, 2002 | 112.22 | 111.94 | 110.69 | | Nov. 07, 2002 | 114.92 | 114.78 | 114.2 | | Nov. 07, 2002 | 113.56 | 113.45 | 113.06 | |
| Comdty | | | | | | | | | | | | | | | |
| USZ2 | Nov. 08, 2002 | 113.16 | 112.97 | 112.25 | | Nov. 08, 2002 | 115.14 | 115.05 | 114.7 | | Nov. 08, 2002 | 113.61 | 113.53 | 113.27 | |
| Comdty | | | | | | | | | | | | | | | |
| USZ2 | Nov. 12, 2002 | 113.63 | 112.84 | 112.69 | | Nov. 12, 2002 | 115.47 | 115.08 | 115.02 | | Nov. 12, 2002 | 113.78 | 113.61 | 113.55 | |
| Comdty | | | | | | | | | | | | | | | |
| USZ2 | Nov. 13, 2002 | 113.31 | 113.06 | 112.31 | | Nov. 13, 2002 | 115.42 | 115.27 | 114.84 | | Nov. 13, 2002 | 113.84 | 113.7 | 113.5 | |
| Comdty | | | | | | | | | | | | | | | |
| USZ2 | Nov. 14, 2002 | 112.81 | 111.22 | 111.16 | | Nov. 14, 2002 | 115.05 | 113.95 | 113.91 | | Nov. 14, 2002 | 113.56 | 112.81 | 112.8 | |
| Comdty | | | | | | | | | | | | | | | |
| USZ2 | Nov. 15, 2002 | 111.44 | 111.06 | 110.19 | | Nov. 15, 2002 | 113.88 | 113.73 | 113.19 | | Nov. 15, 2002 | 112.67 | 112.63 | 112.22 | |
| Comdty | | | | | | | | | | | | | | | |
| USZ2 | Nov. 18, 2002 | 111.69 | 111.53 | 110.75 | | Nov. 18, 2002 | 113.94 | 113.91 | 113.56 | | Nov. 18, 2002 | 112.72 | 112.7 | 112.48 | |
| Comdty | | | | | | | | | | | | | | | |
| USZ2 | Nov. 19, 2002 | 112.63 | 112.09 | 111.75 | | Nov. 19, 2002 | 114.42 | 114.14 | 113.92 | | Nov. 19, 2002 | 113.03 | 112.81 | 112.72 | |
| Comdty | | | | | | | | | | | | | | | |
| USZ2 | Nov. 20, 2002 | 112.72 | 111.03 | 110.78 | | Nov. 20, 2002 | 114.44 | 113.33 | 113.25 | | Nov. 20, 2002 | 113.05 | 112.25 | 112.22 | |
| Comdty | | | | | | | | | | | | | | | |
| USZ2 | Nov. 21, 2002 | 111.06 | 110.13 | 109.66 | | Nov. 21, 2002 | 113.36 | 112.86 | 112.52 | | Nov. 21, 2002 | 112.31 | 111.94 | 111.72 | |
| Comdty | | | | | | | | | | | | | | | |
| USZ2 | Nov. 22, 2002 | 110.44 | 109.88 | 109.72 | | Nov. 22, 2002 | 113.09 | 112.66 | 112.55 | | Nov. 22, 2002 | 112.13 | 111.77 | 111.69 | |
| Comdty | | | | | | | | | | | | | | | |
| USZ2 | Nov. 25, 2002 | 110.47 | 109.84 | 109.59 | | Nov. 25, 2002 | 113 | 112.66 | 112.56 | | Nov. 25, 2002 | 111.98 | 111.81 | 111.69 | |
| Comdty | | | | | | | | | | | | | | | |
| USZ2 | Nov. 26, 2002 | 111.03 | 110.91 | 109.84 | | Nov. 26, 2002 | 113.53 | 113.45 | 112.69 | | Nov. 26, 2002 | 112.41 | 112.34 | 111.78 | |
| Comdty | | | | | | | | | | | | | | | |
| USZ2 | Nov. 27, 2002 | 110.56 | 108.72 | 108.66 | | Nov. 27, 2002 | 113.2 | 112.17 | 112.09 | | Nov. 27, 2002 | 112.16 | 111.52 | 111.42 | |
| Comdty | | | | | | | | | | | | | | | |
| USZ2 | Nov. 29, 2002 | 109.34 | 109.19 | 108.69 | | Nov. 29, 2002 | 112.55 | 112.52 | 112.22 | | Nov. 29, 2002 | 111.83 | 111.78 | 111.58 | |
| Comdty | | | | | | | | | | | | | | | |
| USZ2 | Dec. 02, 2002 | 109.56 | 109.34 | 107.66 | | Dec. 02, 2002 | 112.61 | 112.41 | 111.5 | | Dec. 02, 2002 | 111.72 | 111.63 | 111.16 | |
| Comdty | | | | | | | | | | | | | | | |
| USZ2 | Dec. 03, 2002 | 109.88 | 109.19 | 109.06 | | Dec. 03, 2002 | 112.75 | 112.31 | 112.2 | | Dec. 03, 2002 | 111.81 | 111.61 | 111.56 | |
| Comdty | | | | | | | | | | | | | | | |
| USZ2 | Dec. 04, 2002 | 110.22 | 109.78 | 109.69 | | Dec. 04, 2002 | 113 | 112.77 | 112.63 | | Dec. 04, 2002 | 112.11 | 111.98 | 111.84 | |
| Comdty | | | | | | | | | | | | | | | |
| USZ2 | Dec. 05, 2002 | 110.69 | 110.47 | 109.09 | | Dec. 05, 2002 | 113.27 | 113.2 | 112.25 | | Dec. 05, 2002 | 112.28 | 112.25 | 111.67 | |
| Comdty | | | | | | | | | | | | | | | |
| USZ2 | Dec. 06, 2002 | 112.06 | 110.53 | 110.09 | | Dec. 06, 2002 | 114.28 | 113.59 | 113.2 | | Dec. 06, 2002 | 112.97 | 112.56 | 112.27 | |
| Comdty | | | | | | | | | | | | | | | |
| USZ2 | Dec. 09, 2002 | 111.41 | 111.13 | 110.28 | | Dec. 09, 2002 | 114.09 | 113.95 | 113.61 | | Dec. 09, 2002 | 112.86 | 112.8 | 112.72 | |
| Comdty | | | | | | | | | | | | | | | |
| USZ2 | Dec. 10, 2002 | 111.47 | 111.44 | 110.91 | | Dec. 10, 2002 | 114.11 | 113.98 | 113.72 | | Dec. 10, 2002 | 112.88 | 112.81 | 112.7 | |
| Comdty | | | | | | | | | | | | | | | |
| USZ2 | Dec. 11, 2002 | 112.34 | 112.22 | 111.53 | | Dec. 11, 2002 | 114.55 | 114.41 | 113.95 | | Dec. 11, 2002 | 113.17 | 113.08 | 112.94 | |
| Comdty | | | | | | | | | | | | | | | |
| USZ2 | Dec. 12, 2002 | 112.44 | 112.25 | 111.66 | 1.344 | Dec. 12, 2002 | 114.56 | 114.34 | 114.03 | 1.359 | Dec. 12, 2002 | 113.13 | 113.06 | 112.91 | 1.328 |
| Comdty | | | | | | | | | | | | | | | |
| USZ2 | Dec. 13, 2002 | 112.44 | 111.38 | 111.13 | 1.344 | Dec. 13, 2002 | 114.53 | 114.06 | 113.81 | 1.359 | Dec. 13, 2002 | 113.06 | 112.92 | 112.78 | 1.328 |
| | | | | | | | Comdty | | | | | Comdty | | | |
| USH3 | | Px | Px | Px | | TYH3 | Px | Px | Px | | FVH3 | Px | Px | Px | |
| Comdty | Date | High | Last | Low | | Date | High | Last | Low | | Date | High | Last | Low | |
| USH3 | Dec. 13, 2002 | 111.13 | 110.03 | 109.75 | | Dec. 13, 2002 | 113.31 | 112.7 | 112.42 | | Dec. 13, 2002 | 111.94 | 111.59 | 111.42 | |
| Comdty | | | | | | | | | | | | | | | |
| USH3 | Dec. 16, 2002 | 110.25 | 109.13 | 108.97 | | Dec. 16, 2002 | 112.77 | 112.2 | 112.16 | | Dec. 16, 2002 | 111.64 | 111.31 | 111.28 | |
| Comdty | | | | | | | | | | | | | | | |
| USH3 | Dec. 17, 2002 | 109.66 | 109.19 | 108.81 | | Dec. 17, 2002 | 112.5 | 112.44 | 112.11 | | Dec. 17, 2002 | 111.56 | 111.52 | 111.28 | |
| Comdty | | | | | | | | | | | | | | | |
| USH3 | Dec. 18, 2002 | 110.13 | 109.84 | 109.44 | | Dec. 18, 2002 | 113.13 | 112.98 | 112.66 | | Dec. 18, 2002 | 112 | 111.94 | 111.7 | |
| Comdty | | | | | | | | | | | | | | | |
| USH3 | Dec. 19, 2002 | 110.97 | 110.88 | 109.91 | | Dec. 19, 2002 | 113.78 | 113.75 | 113.11 | | Dec. 19, 2002 | 112.45 | 112.44 | 112 | |
| Comdty | | | | | | | | | | | | | | | |
| USH3 | Dec. 20, 2002 | 111.16 | 110.97 | 110.47 | | Dec. 20, 2002 | 113.8 | 113.78 | 113.42 | | Dec. 20, 2002 | 112.42 | 112.42 | 112.17 | |
| Comdty | | | | | | | | | | | | | | | |
| USH3 | Dec. 23, 2002 | 111.28 | 110.84 | 110.28 | | Dec. 23, 2002 | 113.84 | 113.72 | 113.34 | | Dec. 23, 2002 | 112.39 | 112.34 | 112.13 | |
| Comdty | | | | | | | | | | | | | | | |
| USH3 | Dec. 24, 2002 | 111.81 | 111.56 | 111.13 | | Dec. 24, 2002 | 114.25 | 114.11 | 113.81 | | Dec. 24, 2002 | 112.72 | 112.55 | 112.44 | |
| Comdty | | | | | | | | | | | | | | | |
| USH3 | Dec. 26, 2002 | 111.75 | 111.72 | 111.34 | | Dec. 26, 2002 | 114.28 | 114.23 | 114.03 | | Dec. 26, 2002 | 112.67 | 112.66 | 112.47 | |
| Comdty | | | | | | | | | | | | | | | |
| USH3 | Dec. 27, 2002 | 112.88 | 112.84 | 111.69 | | Dec. 27, 2002 | 115.06 | 115.03 | 114.39 | | Dec. 27, 2002 | 113.22 | 113.2 | 112.8 | |
| Comdty | | | | | | | | | | | | | | | |
| USH3 | Dec. 30, 2002 | 113.19 | 113.13 | 112.44 | | Dec. 30, 2002 | 115.34 | 115.27 | 114.8 | | Dec. 30, 2002 | 113.48 | 113.41 | 113.08 | |
| Comdty | | | | | | | | | | | | | | | |
| USH3 | Dec. 31, 2002 | 113.81 | 112.69 | 112.56 | | Dec. 31, 2002 | 115.55 | 115.05 | 114.91 | | Dec. 31, 2002 | 113.59 | 113.25 | 113.14 | |
| Comdty | | | | | | | | | | | | | | | |
| USH3 | Jan. 02, 2003 | 112.5 | 110.16 | 110.03 | | Jan. 02, 2003 | 114.81 | 113.41 | 113.2 | | Jan. 02, 2003 | 113.06 | 112.16 | 112 | |
| Comdty | | | | | | | | | | | | | | | |
| USH3 | Jan. 03, 2003 | 110.38 | 110.28 | 109.59 | | Jan. 03, 2003 | 113.5 | 113.44 | 113.03 | | Jan. 03, 2003 | 112.23 | 112.16 | 111.92 | |
| Comdty | | | | | | | | | | | | | | | |
| USH3 | Jan. 06, 2003 | 110.13 | 110.03 | 109.44 | | Jan. 06, 2003 | 113.34 | 113.23 | 112.91 | | Jan. 06, 2003 | 112.02 | 111.94 | 111.73 | |
| Comdty | | | | | | | | | | | | | | | |
| USH3 | Jan. 07, 2003 | 110.75 | 110.34 | 109.75 | | Jan. 07, 2003 | 113.75 | 113.53 | 113.09 | | Jan. 07, 2003 | 112.28 | 112.19 | 111.81 | |
| Comdty | | | | | | | | | | | | | | | |
| USH3 | Jan. 08, 2003 | 111.22 | 111.03 | 110.47 | | Jan. 08, 2003 | 114.02 | 113.83 | 113.64 | | Jan. 08, 2003 | 112.45 | 112.36 | 112.28 | |
| Comdty | | | | | | | | | | | | | | | |
| USH3 | Jan. 09, 2003 | 110.38 | 109.03 | 108.56 | | Jan. 09, 2003 | 113.28 | 112.59 | 112.31 | | Jan. 09, 2003 | 111.97 | 111.52 | 111.34 | |
| Comdty | | | | | | | | | | | | | | | |
| USH3 | Jan. 10, 2003 | 109.84 | 109.03 | 108.59 | | Jan. 10, 2003 | 113.25 | 112.56 | 112.25 | | Jan. 10, 2003 | 112.05 | 111.59 | 111.34 | |
| Comdty | | | | | | | | | | | | | | | |
| USH3 | Jan. 13, 2003 | 109.63 | 109.47 | 108.53 | | Jan. 13, 2003 | 112.92 | 112.84 | 112.2 | | Jan. 13, 2003 | 111.84 | 111.77 | 111.34 | |
| Comdty | | | | | | | | | | | | | | | |
| USH3 | Jan. 14, 2003 | 110.09 | 109.88 | 109.41 | | Jan. 14, 2003 | 113.3 | 113.22 | 112.81 | | Jan. 14, 2003 | 112.11 | 112.02 | 111.77 | |
| Comdty | | | | | | | | | | | | | | | |
| USH3 | Jan. 15, 2003 | 110.69 | 110.28 | 109.72 | | Jan. 15, 2003 | 113.69 | 113.33 | 113.08 | | Jan. 15, 2003 | 112.28 | 112.03 | 111.94 | |
| Comdty | | | | | | | | | | | | | | | |
| USH3 | Jan. 16, 2003 | 110.44 | 110.41 | 109.03 | | Jan. 16, 2003 | 113.33 | 113.3 | 112.52 | | Jan. 16, 2003 | 112.02 | 112 | 111.55 | |
| Comdty | | | | | | | | | | | | | | | |
| USH3 | Jan. 17, 2003 | 111.38 | 111.06 | 110.69 | | Jan. 17, 2003 | 114 | 113.8 | 113.53 | | Jan. 17, 2003 | 112.5 | 112.31 | 112.17 | |
| Comdty | | | | | | | | | | | | | | | |
| USH3 | Jan. 21, 2003 | 111.47 | 111.38 | 110.69 | | Jan. 21, 2003 | 114.11 | 114.06 | 113.59 | | Jan. 21, 2003 | 112.56 | 112.55 | 112.17 | |
| Comdty | | | | | | | | | | | | | | | |
| USH3 | Jan. 22, 2003 | 112.03 | 112 | 111.53 | | Jan. 22, 2003 | 114.56 | 114.55 | 114.2 | | Jan. 22, 2003 | 112.89 | 112.88 | 112.67 | |
| Comdty | | | | | | | | | | | | | | | |
| USH3 | Jan. 23, 2003 | 111.88 | 111.56 | 111.31 | | Jan. 23, 2003 | 114.5 | 114.36 | 114.16 | | Jan. 23, 2003 | 112.81 | 112.73 | 112.61 | |
| Comdty | | | | | | | | | | | | | | | |
| USH3 | Jan. 24, 2003 | 112.88 | 112.38 | 111.88 | | Jan. 24, 2003 | 114.97 | 114.69 | 114.53 | | Jan. 24, 2003 | 113.09 | 112.94 | 112.84 | |
| Comdty | | | | | | | | | | | | | | | |
| USH3 | Jan. 27, 2003 | 112.69 | 111.78 | 111.44 | | Jan. 27, 2003 | 114.89 | 114.3 | 114.13 | | Jan. 27, 2003 | 113.06 | 112.7 | 112.56 | |
| Comdty | | | | | | | | | | | | | | | |
| USH3 | Jan. 28, 2003 | 112.06 | 111.72 | 111.03 | | Jan. 28, 2003 | 114.41 | 114.16 | 113.73 | | Jan. 28, 2003 | 112.78 | 112.64 | 112.33 | |
| Comdty | | | | | | | | | | | | | | | |
| USH3 | Jan. 29, 2003 | 112.06 | 111.06 | 10.84 | | Jan. 29, 2003 | 114.31 | 113.7 | 113.53 | | Jan. 29, 2003 | 112.73 | 112.34 | 112.25 | |
| Comdty | | | | | | | | | | | | | | | |
| USH3 | Jan. 30, 2003 | 111.75 | 111.72 | 10.75 | | Jan. 30, 2003 | 114.06 | 114.05 | 113.36 | | Jan. 30, 2003 | 112.55 | 112.53 | 112.09 | |
| Comdty | | | | | | | | | | | | | | | |
| USH3 | Jan. 31, 2003 | 112.47 | 112.19 | 11.47 | | Jan. 31, 2003 | 114.34 | 114.14 | 113.94 | | Jan. 31, 2003 | 112.69 | 112.53 | 112.41 | |
| Comdty | | | | | | | | | | | | | | | |
| USH3 | Feb. 03, 2003 | 112.22 | 112.16 | 11.53 | | Feb. 03, 2003 | 114.03 | 113.97 | 113.63 | | Feb. 03, 2003 | 112.45 | 112.44 | 112.22 | |
| Comdty | | | | | | | | | | | | | | | |
| USH3 | Feb. 04, 2003 | 112.81 | 112.78 | 12.41 | | Feb. 04, 2003 | 114.45 | 114.44 | 114.17 | | Feb. 04, 2003 | 112.75 | 112.73 | 112.58 | |
| Comdty | | | | | | | | | | | | | | | |
| USH3 | Feb. 05, 2003 | 113.03 | 111.75 | 111.53 | | Feb. 05, 2003 | 114.5 | 113.92 | 113.59 | | Feb. 05, 2003 | 112.73 | 112.38 | 112.17 | |
| Comdty | | | | | | | | | | | | | | | |
| USH3 | Feb. 06, 2003 | 112.78 | 112.66 | 111.91 | | Feb. 06, 2003 | 114.42 | 114.34 | 114.08 | | Feb. 06, 2003 | 112.67 | 112.63 | 112.45 | |
| Comdty | | | | | | | | | | | | | | | |
| USH3 | Feb. 07, 2003 | 113.09 | 113.03 | 111.44 | | Feb. 07, 2003 | 114.61 | 114.58 | 113.59 | | Feb. 07, 2003 | 112.92 | 112.89 | 112.13 | |
| Comdty | | | | | | | | | | | | | | | |
| USH3 | Feb. 10, 2003 | 113 | 112.25 | 111.97 | | Feb. 10, 2003 | 114.55 | 114.17 | 114 | | Feb. 10, 2003 | 112.89 | 112.63 | 112.53 | |
| Comdty | | | | | | | | | | | | | | | |
| USH3 | Feb. 11, 2003 | 112.44 | 112.31 | 111.75 | | Feb. 11, 2003 | 114.42 | 114.39 | 113.97 | | Feb. 11, 2003 | 112.83 | 112.78 | 112.5 | |
| Comdty | | | | | | | | | | | | | | | |
| USH3 | Feb. 12, 2003 | 112.72 | 112.69 | 112.13 | | Feb. 12, 2003 | 114.84 | 114.81 | 114.42 | | Feb. 12, 2003 | 113.13 | 113.11 | 112.89 | |
| Comdty | | | | | | | | | | | | | | | |
| USH3 | Feb. 13, 2003 | 114.22 | 113.41 | 112.72 | | Feb. 13, 2003 | 115.64 | 115.36 | 114.84 | | Feb. 13, 2003 | 113.66 | 113.52 | 113.13 | |
| Comdty | | | | | | | | | | | | | | | |
| USH3 | Feb. 14, 2003 | 113.34 | 112.34 | 112.19 | | Feb. 14, 2003 | 115.25 | 114.83 | 114.69 | | Feb. 14, 2003 | 113.44 | 113.16 | 113.05 | |
| Comdty | | | | | | | | | | | | | | | |
| USH3 | Feb. 18, 2003 | 112.66 | 112.63 | 111.84 | | Feb. 18, 2003 | 114.91 | 114.89 | 114.41 | | Feb. 18, 2003 | 113.16 | 113.14 | 112.81 | |
| Comdty | | | | | | | | | | | | | | | |
| USH3 | Feb. 19, 2003 | 113.59 | 113.47 | 112.84 | | Feb. 19, 2003 | 115.41 | 115.39 | 114.92 | | Feb. 19, 2003 | 113.44 | 113.42 | 113.16 | |
| Comdty | | | | | | | | | | | | | | | |
| USH3 | Feb. 20, 2003 | 113.84 | 113.78 | 113.06 | | Feb. 20, 2003 | 115.75 | 115.7 | 115.09 | | Feb. 20, 2003 | 113.69 | 113.64 | 113.25 | |
| Comdty | | | | | | | | | | | | | | | |
| USH3 | Feb. 21, 2003 | 113.81 | 113.13 | 112.94 | | Feb. 21, 2003 | 115.81 | 115.33 | 115.23 | | Feb. 21, 2003 | 113.75 | 113.47 | 113.41 | |
| Comdty | | | | | | | | | | | | | | | |
| USH3 | Feb. 24, 2003 | 113.81 | 113.59 | 113.5 | | Feb. 24, 2003 | 115.78 | 115.7 | 115.48 | | Feb. 24, 2003 | 113.72 | 113.69 | 113.53 | |
| Comdty | | | | | | | | | | | | | | | |
| USH3 | Feb. 25, 2003 | 114.63 | 114.06 | 113.91 | | Feb. 25, 2003 | 116.41 | 115.89 | 115.83 | | Feb. 25, 2003 | 114.17 | 113.84 | 113.8 | |
| Comdty | | | | | | | | | | | | | | | |
| USH3 | Feb. 26, 2003 | 114.84 | 114.75 | 114.09 | | Feb. 26, 2003 | 116.25 | 116.19 | 115.81 | | Feb. 26, 2003 | 114 | 113.97 | 113.78 | |
| Comdty | | | | | | | | | | | | | | | |
| USH3 | Feb. 27, 2003 | 115.09 | 115 | 114.25 | | Feb. 27, 2003 | 116.41 | 116.31 | 115.92 | | Feb. 27, 2003 | 114.13 | 113.98 | 113.81 | |
| Comdty | | | | | | | | | | | | | | | |
| USH3 | Feb. 28, 2003 | 115.84 | 115.81 | 114.56 | | Feb. 28, 2003 | 116.75 | 116.72 | 116.11 | | Feb. 28, 2003 | 114.31 | 114.31 | 113.81 | |
| Comdty | | | | | | | | | | | | | | | |
| USH3 | Mar. 03, 2003 | 116.16 | 115.88 | 115.5 | | Mar. 03, 2003 | 116.98 | 116.91 | 116.58 | | Mar. 03, 2003 | 114.5 | 114.45 | 114.2 | |
| Comdty | | | | | | | | | | | | | | | |
| USH3 | Mar. 04, 2003 | 116.16 | 116.03 | 115.41 | | Mar. 04, 2003 | 117.19 | 117.13 | 116.77 | | Mar. 04, 2003 | 114.63 | 114.58 | 114.41 | |
| Comdty | | | | | | | | | | | | | | | |
| USH3 | Mar. 05, 2003 | 116.38 | 116.25 | 115.59 | | Mar. 05, 2003 | 117.47 | 117.41 | 117 | | Mar. 05, 2003 | 114.78 | 114.77 | 114.52 | |
| Comdty | | | | | | | | | | | | | | | |
| USH3 | Mar. 06, 2003 | 116.47 | 115.91 | 115.59 | | Mar. 06, 2003 | 117.42 | 117.2 | 116.92 | | Mar. 06, 2003 | 114.75 | 114.64 | 114.41 | |
| Comdty | | | | | | | | | | | | | | | |
| USH3 | Mar. 07, 2003 | 116.69 | 116.25 | 115.72 | | Mar. 07, 2003 | 117.8 | 117.47 | 117.09 | | Mar. 07, 2003 | 115.06 | 114.86 | 114.63 | |
| Comdty | | | | | | | | | | | | | | | |
| USH3 | Mar. 10, 2003 | 116.78 | 116.69 | 116.44 | | Mar. 10, 2003 | 117.88 | 117.81 | 117.66 | | Mar. 10, 2003 | 115.16 | 115.14 | 115.05 | |
| Comdty | | | | | | | | | | | | | | | |
| USH3 | Mar. 11, 2003 | 117 | 116.56 | 116.53 | | Mar. 11, 2003 | 117.91 | 117.59 | 117.53 | | Mar. 11, 2003 | 115.16 | 114.98 | 114.95 | |
| Comdty | | | | | | | | | | | | | | | |
| USH3 | Mar. 12, 2003 | 117.16 | 116.91 | 116.56 | | Mar. 12, 2003 | 117.73 | 117.47 | 117.38 | | Mar. 12, 2003 | 114.95 | 114.8 | 114.8 | |
| Comdty | | | | | | | | | | | | | | | |
| USH3 | Mar. 13, 2003 | 116.38 | 115.13 | 115.09 | | Mar. 13, 2003 | 117.09 | 116.28 | 116.17 | | Mar. 13, 2003 | 114.5 | 114.03 | 113.97 | |
| Comdty | | | | | | | | | | | | | | | |
| USH3 | Mar. 14, 2003 | 115.69 | 115.5 | 115.06 | | Mar. 14, 2003 | 116.7 | 116.59 | 116.17 | | Mar. 14, 2003 | 114.25 | 114.25 | 114.09 | |

APPENDIX II
Cash Index Data 2001
(6% Coupon Data)

| Settle | Jan. 15, 2001 | Feb. 15, 2001 | Mar. 15, 2001 | Apr. 15, 2001 | May 15, 2001 | Jun. 15, 2001 |
|---|---|---|---|---|---|---|
| DATE | Jan-01 | Feb-01 | Mar-01 | Apr-01 | May-01 | Jun-01 |
| Cash_5YR | 4.86 | 4.89 | 4.64 | 4.76 | 4.93 | 4.81 |
| 5YR YTM | 4.86% | 4.89% | 4.64% | 4.76% | 4.93% | 4.81% |
| Maturity | Jan. 15, 2006 | Feb. 15, 2006 | Mar. 15, 2006 | Apr. 15, 2006 | May 15, 2006 | Jun. 15, 2006 |
| 5YR Price | 105 | 104 28/32 | 106 | 105 15/32 | 104 22/32 | 105 7/32 |
| Weight | 2.75 | 2.75 | 2.75 | 2.75 | 2.75 | 2.75 |
| Cash_10YR | 5.16 | 5.1 | 4.89 | 5.14 | 5.39 | 5.28 |
| 10YR YTM | 5.16% | 5.10% | 4.89% | 5.14% | 5.39% | 5.28% |
| Maturity | Jan. 15, 2011 | Feb. 15, 2011 | Mar. 15, 2011 | Apr. 15, 2011 | May 15, 2011 | Jun. 15, 2011 |
| 10YR Price | 106 16/32 | 107 | 108 23/32 | 106 22/32 | 104 22/32 | 105 18/32 |
| Weight | 1.57 | 1.57 | 1.57 | 1.57 | 1.57 | 1.57 |
| Cash_20YR | 5.65 | 5.62 | 5.49 | 5.78 | 5.92 | 5.82 |
| 20YR YTM | 5.65% | 5.62% | 5.49% | 5.78% | 5.92% | 5.82% |
| Maturity | Jan. 15, 2021 | Feb. 15, 2021 | Mar. 15, 2021 | Apr. 15, 2021 | May 15, 2021 | Jun. 15, 2021 |
| 20YR Price | 104 5/32 | 104 17/32 | 106 5/32 | 102 19/32 | 100 30/32 | 102 4/32 |
| Weight | 1 | 1 | 1 | 1 | 1 | 1 |
| Fed Funds | 5.98 | 5.49 | 5.31 | 4.8 | 4.21 | 3.97 |
| Monthly Fund | 0.4983 | 0.4575 | 0.4425 | 0.4000 | 0.3508 | 0.3308 |
| Price | | | | | | |
| Divisor | 5.32 | 5.32 | 5.32 | 5.31 | 5.31 | 5.31 |
| Cash Index | 105 9/32 | 105 14/32 | 106 27/32 | 105 9/32 | 103 31/32 | 104 24/32 |
| Funds | 0.50 | 0.96 | 1.40 | 1.80 | 2.15 | 2.48 |
| Cumulative | | | | | | |
| Coupon | 0.5 | 1 | 1.5 | 2 | 2.5 | 3 |
| Cumulative | | | | | | |
| Margin | 0.00 | 0.04 | 0.10 | 0.20 | 0.35 | 0.52 |
| Cash Cum. | 105 9/32 | 105 15/32 | 106 30/32 | 105 15/32 | 104 11/32 | 105 8/32 |
| INDEX | | | | | | |
| FUTURES | 104 8/32 | 104 12/32 | 105 23/32 | 104 22/32 | 103 14/32 | 104 9/32 |
| INDEX | | | | | | |
| Cash Bonds | 104 5/32 | 104 17/32 | 106 5/32 | 102 19/32 | 100 30/32 | 102 4/32 |
| | Jan | Feb | Mar | April | May | June |
| Cash Return | Cash | 0.0018 | 0.0137 | −0.014 | −0.011 | 0.0089 |
| Futures | Futures | 0.0014 | 0.0126 | −0.01 | −0.012 | 0.0083 |
| Returns | | | | | | |
| Bond Returns | | 0.0035 | 0.0154 | −0.0341 | −0.0163 | 0.0116 |
| 10YR Returns | | 0.0045 | 0.0160 | −0.0190 | −0.0189 | 0.0083 |
| 5YR Returns | | −0.0013 | 0.0108 | −0.0052 | −0.0073 | 0.0052 |

| | | | | | | |
|---|---|---|---|---|---|---|
| Settle | Jul. 15, 2001 | Aug. 15, 2001 | Sep. 15, 2001 | Oct. 15, 2001 | Nov. 15, 2001 | Dec. 15, 2001 |
| DATE | Jul-01 | Aug-01 | Sep-01 | Oct-01 | Nov-01 | Dec-01 |
| Cash_5YR | 4.76 | 4.57 | 4.12 | 3.91 | 3.97 | 4.39 |
| 5YR YTM | 4.76% | 4.57% | 4.12% | 3.91% | 3.97% | 4.39% |
| Maturity | Jul. 15, 2006 | Aug. 15, 2006 | Sep. 15, 2006 | Oct. 15, 2006 | Nov. 15, 2006 | Dec. 15, 2006 |
| 5YR Price | 105 15/32 | 106 10/32 | 108 13/32 | 109 13/32 | 109 4/32 | 107 5/32 |
| Weight | 2.70 | 2.70 | 2.70 | 2.74 | 2.74 | 2.74 |
| Cash_10YR | 5.24 | 4.97 | 4.73 | 4.57 | 4.65 | 5.09 |
| 10YR YTM | 5.24% | 4.97% | 4.73% | 4.57% | 4.65% | 5.09% |
| Maturity | Jul. 15, 2011 | Aug. 15, 2011 | Sep. 15, 2011 | Oct. 15, 2011 | Nov. 15, 2011 | Dec. 15, 2011 |
| 10YR Price | 105 28/32 | 108 2/32 | 110 2/32 | 111 13/32 | 110 23/32 | 107 3/32 |
| Weight | 1.54 | 1.54 | 1.54 | 1.56 | 1.56 | 1.56 |
| Cash_20YR | 5.75 | 5.58 | 5.53 | 5.34 | 5.33 | 5.76 |
| 20YR YTM | 5.75% | 5.58% | 5.53% | 5.34% | 5.33% | 5.76% |
| Maturity | Jul. 15, 2021 | Aug. 15, 2021 | Sep. 15, 2021 | Oct. 15, 2021 | Nov. 15, 2021 | Dec. 15, 2021 |
| 20YR Price | 102 30/32 | 105 1/32 | 105 21/32 | 108 2/32 | 108 6/32 | 102 27/32 |
| Weight | 1 | 1 | 1 | 1 | 1 | 1 |
| Fed Funds | 3.77 | 3.65 | 3.65 | 2.49 | 2.09 | 1.82 |
| Monthly Fund | 0.3142 | 0.3042 | 0.2558 | 0.2075 | 0.1742 | 0.1742 |
| Price | | | | | | |
| Divisor | 5.24 | 5.24 | 5.24 | 5.30 | 5.30 | 5.30 |
| Cash Index | 105 3/32 | 106 19/32 | 108 12/32 | 109 24/32 | 109 13/32 | 106 10/32 |
| Funds | 2.79 | 3.10 | 3.35 | 3.56 | 3.74 | 3.89 |
| Cumulative | | | | | | |
| Coupon | 3.5 | 4 | 4.5 | 5 | 5.5 | 6 |
| Cumulative | | | | | | |
| Margin | 0.71 | 0.90 | 1.15 | 1.44 | 1.76 | 2.11 |
| Cash Cum. | 105 26/32 | 107 16/32 | 109 17/32 | 111 6/32 | 111 6/32 | 108 14/32 |
| INDEX | | | | | | |
| FUTURES | 104 28/32 | 106 15/32 | 108 6/32 | 109 29/32 | 109 25/32 | 107 9/32 |
| INDEX | | | | | | |
| Cash Bonds | 102 30/32 | 105 1/32 | 105 21/32 | 108 2/32 | 108 6/32 | 102 27/32 |
| | July | Aug | Sept | Oct | Nov | Dec |
| Cash Return | 0.0052 | 0.0158 | 0.0187 | 0.0151 | 3E−05 | −0.025 |
| Futures | 0.0056 | 0.0152 | 0.0158 | 0.0159 | −0.001 | −0.023 |
| Returns | | | | | | |
| Bond Returns | 0.0082 | 0.0200 | 0.0059 | 0.0226 | 0.0012 | −0.0508 |
| 10YR Returns | 0.0030 | 0.0205 | 0.0183 | 0.0122 | −0.0061 | −0.0335 |
| 5YR Returns | 0.0022 | 0.0082 | 0.0195 | 0.0091 | −0.0026 | −0.0182 |

Cash Index Data 2002
(6% Coupon Data)

| Settle | Jan. 15, 2002 | Feb. 15, 2002 | Mar. 15, 2002 | Apr. 15, 2002 | May 15, 2002 | Jun. 15, 2002 |
|---|---|---|---|---|---|---|
| DATE | Jan-02 | Feb-02 | Mar-02 | Apr-02 | May-02 | Jun-02 |
| Cash_5YR | 4.34 | 4.30 | 4.74 | 4.65 | 4.49 | 4.19 |
| 5YR YTM | 4.34% | 4.30% | 4.74% | 4.65% | 4.49% | 4.19% |
| Maturity | Jan. 15, 2007 | Feb. 15, 2007 | Mar. 15, 2007 | Apr. 15, 2007 | May 15, 2007 | Jun. 15, 2007 |
| 5YR Price | 107 12/32 | 107 18/32 | 105 18/32 | 105 31/32 | 106 22/32 | 108 3/32 |
| Weight | 2.69 | 2.69 | 2.69 | 2.68 | 2.68 | 2.68 |
| Cash_10YR | 5.04 | 4.91 | 5.28 | 5.21 | 5.16 | 4.93 |
| 10YR YTM | 5.04% | 4.91% | 5.28% | 5.21% | 5.16% | 4.93% |
| Maturity | Jan. 15, 2012 | Feb. 15, 2012 | Mar. 15, 2012 | Apr. 15, 2012 | May 15, 2012 | Jun. 15, 2012 |
| 10YR Price | 107 16/32 | 108 18/32 | 105 18/32 | 106 4/32 | 106 16/32 | 108 12/32 |
| Weight | 1.54 | 1.54 | 1.54 | 1.54 | 1.54 | 1.54 |
| Cash_20YR | 5.69 | 5.61 | 5.93 | 5.85 | 5.81 | 5.65 |
| 20YR YTM | 5.69% | 5.61% | 5.93% | 5.85% | 5.81% | 5.65% |
| Maturity | Jan. 15, 2022 | Feb. 15, 2022 | Mar. 15, 2022 | Apr. 15, 2022 | May 15, 2022 | Jun. 15, 2022 |
| 20YR Price | 103 22/32 | 104 21/32 | 100 26/32 | 101 24/32 | 102 7/32 | 104 5/32 |
| Weight | 1 | 1 | 1 | 1 | 1 | 1 |
| Fed Funds | 1.73 | 1.74 | 1.73 | 1.75 | 1.75 | 1.75 |
| Monthly Fund | 0.1442 | 0.1450 | 0.1442 | 0.1458 | 0.1458 | 0.1458 |
| Price | | | | | | |
| Divisor | 5.23 | 5.23 | 5.23 | 5.22 | 5.22 | 5.22 |
| Cash Index | 106 23/32 | 107 10/32 | 104 21/32 | 105 6/32 | 105 25/32 | 107 14/32 |
| Funds | 4.03 | 4.18 | 4.32 | 4.47 | 4.61 | 4.76 |
| Cumulative | | | | | | |
| Coupon | 6.5 | 7 | 7.5 | 8 | 8.5 | 9 |
| Cumulative | | | | | | |
| Margin | 2.47 | 2.82 | 3.18 | 3.53 | 3.89 | 4.24 |
| Cash Cum. | 109 6/32 | 110 4/32 | 107 26/32 | 108 23/32 | 109 22/32 | 111 21/32 |
| INDEX | | | | | | |
| FUTURES | 108 4/32 | 109 | 107 4/32 | 108 7/32 | 109 7/32 | 111 7/32 |
| INDEX | | | | | | |
| Cash Bonds | 103 22/32 | 104 21/32 | 100 26/32 | 101 24/32 | 102 7/32 | 104 5/32 |
| | Jan | Feb | Mar | April | May | June |
| Cash Returns | 0.0069 | 0.0087 | −0.021 | 0.0084 | 0.0086 | 0.018 |
| Futures | 0.0077 | 0.0081 | −0.017 | 0.0103 | 0.0091 | 0.018 |
| Returns | | | | | | |
| Bond Returns | 0.0082 | 0.0094 | −0.0374 | 0.0093 | 0.0047 | 0.0187 |
| 10YR Returns | 0.0038 | 0.0099 | −0.0281 | 0.0053 | 0.0038 | 0.0175 |
| 5YR Returns | 0.0022 | 0.0017 | −0.0190 | 0.0039 | 0.0069 | 0.0130 |

| | | | | | | |
|---|---|---|---|---|---|---|
| Settle | Jul. 15, 2002 | Aug. 15, 2002 | Sep. 15, 2002 | Oct. 15, 2002 | Nov. 15, 2002 | Dec. 15, 2002 |
| DATE | Jul-02 | Aug-02 | Sep-02 | Oct-02 | Nov-02 | Dec-02 |
| Cash_5YR | 3.81 | 3.29 | 2.94 | 2.95 | 3.05 | 3.03 |
| 5YR YTM | 3.81% | 3.29% | 2.94% | 2.95% | 3.05% | 3.03% |
| Maturity | Jul. 15, 2007 | Aug. 15, 2007 | Sep. 15, 2007 | Oct. 15, 2007 | Nov. 15, 2007 | Dec. 15, 2007 |
| 5YR Price | 109 28/32 | 112 13/32 | 114 4/32 | 114 3/32 | 113 19/32 | 113 22/32 |
| Weight | 2.72 | 2.72 | 2.72 | 2.78 | 2.78 | 2.78 |
| Cash_10YR | 4.65 | 4.26 | 3.87 | 3.94 | 4.05 | 4.03 |
| 10YR YTM | 4.65% | 4.26% | 3.87% | 3.94% | 4.05% | 4.03% |
| Maturity | Jul. 15, 2012 | Aug. 15, 2012 | Sep. 15, 2012 | Oct. 15, 2012 | Nov. 15, 2012 | Dec. 15, 2012 |
| 10YR Price | 110 23/32 | 114 3/32 | 117 18/32 | 116 30/32 | 115 30/32 | 116 4/32 |
| Weight | 1.55 | 1.55 | 1.55 | 1.58 | 1.58 | 1.58 |
| Cash_20YR | 5.51 | 5.19 | 4.87 | 5 | 5.04 | 5.01 |
| 20YR YTM | 5.51% | 5.19% | 4.87% | 5.00% | 5.04% | 5.01% |
| Maturity | Jul. 15, 2022 | Aug. 15, 2022 | Sep. 15, 2022 | Oct. 15, 2022 | Nov. 15, 2022 | Dec. 15, 2022 |
| 20YR Price | 105 29/32 | 110 | 114 11/32 | 112 18/32 | 112 1/32 | 112 14/32 |
| Weight | 1 | 1 | 1 | 1 | 1 | 1 |
| Fed Funds | 1.73 | 1.74 | 1.75 | 1.75 | 1.34 | 1.24 |
| Monthly Fund | 0.1442 | 0.1450 | 0.1458 | 0.1458 | 0.1117 | 0.1033 |
| Price | | | | | | |
| Divisor | 5.27 | 5.27 | 5.27 | 5.36 | 5.36 | 5.36 |
| Cash Index | 109 12/32 | 112 14/32 | 115 6/32 | 114 21/32 | 114 | 114 5/32 |
| Funds | 4.90 | 5.05 | 5.19 | 5.34 | 5.45 | 5.55 |
| Cumulative | | | | | | |
| Coupon | 9.5 | 10 | 10.5 | 11 | 11.5 | 12 |
| Cumulative | | | | | | |
| Margin | 4.60 | 4.95 | 5.31 | 5.66 | 6.05 | 6.45 |
| Cash Cum. | 113 31/32 | 117 13/32 | 120 16/32 | 120 10/32 | 120 1/32 | 120 20/32 |
| INDEX | | | | | | |
| FUTURES | 113 19/32 | 116 20/32 | 119 7/32 | 119 3/32 | 118 30/32 | 119 15/32 |
| INDEX | | | | | | |
| Cash Bonds | 105 29/32 | 110 | 114 11/32 | 112 18/32 | 112 1/32 | 112 14/32 |
| | July | Aug | Sept | Oct | Nov | Dec |
| Cash Returns | 0.0205 | 0.0296 | 0.026 | −0.002 | −0.002 | 0.0048 |
| Futures | 0.0211 | 0.0265 | 0.0219 | −0.001 | −0.001 | 0.0046 |
| Returns | | | | | | |
| Bond Returns | 0.0165 | 0.0381 | 0.0387 | −0.0158 | −0.0048 | 0.0036 |
| 10YR Returns | 0.0213 | 0.0299 | 0.0301 | −0.0054 | −0.0085 | 0.0015 |
| 5YR Returns | 0.0165 | 0.0226 | 0.0153 | −0.0004 | −0.0044 | 0.0009 |

Cash Index Data 2003
(6% Coupon Data)

| Settle | Jan. 15, 2003 | Feb. 15, 2003 | Mar. 15, 2003 |
|---|---|---|---|
| DATE | Jan-03 | Feb-03 | Mar-03 |
| Cash_5YR | 3.05 | 2.90 | 2.78 |
| 5YR YTM | 3.05% | 2.90% | 2.78% |
| Maturity | Jan. 15, 2008 | Feb. 15, 2008 | Mar. 15, 2008 |
| 5YR Price | 113 19/32 | 114 11/32 | 114 30/32 |
| Weight | 2.76 | 2.76 | 2.76 |
| Cash_10YR | 4.05 | 3.9 | 3.81 |
| 10YR YTM | 4.05% | 3.90% | 3.81% |
| Maturity | Jan. 15, 2013 | Feb. 15, 2013 | Mar. 15, 2013 |
| 10YR Price | 115 30/32 | 117 10/32 | 118 4/32 |
| Weight | 1.57 | 1.57 | 1.57 |
| Cash_20YR | 5.02 | 4.87 | 4.82 |
| 20YR YTM | 5.02% | 4.87% | 4.82% |
| Maturity | Jan. 15, 2003 | Feb. 15, 2023 | Mar. 15, 2023 |
| 20YR Price | 112 9/32 | 114 11/32 | 115 2/32 |
| Weight | 1 | 1 | 1 |
| Fed Funds | 1.24 | 1.26 | 1.25 |
| Monthly Fund | 0.1033 | 0.1050 | 0.1042 |
| Price | | | |
| Divisor | 5.33 | 5.33 | 5.33 |
| Cash Index | 114 1/32 | 115 7/32 | 115 29/32 |
| Funds | 5.66 | 5.76 | 5.87 |
| Cumulative | | | |
| Coupon | 12.5 | 13 | 13.5 |
| Cumulative | | | |
| Margin | 6.84 | 7.24 | 7.63 |
| Cash CUM INDEX | 120 28/32 | 122 14/32 | 123 17/32 |
| FUTURES | 119 31/32 | 121 9/32 | |
| INDEX | | | |
| Cash Bonds | 112 9/32 | 114 11/32 | 115 2/32 |
| | Jan. | Feb. | Mar. |
| Cash Returns | 0.0021978 | 0.0128848 | |
| Futures | 0.0041909 | 0.0107356 | |
| Returns | | | |
| Bond Returns | −0.0012 | 0.0182 | |
| 10YR Returns | −0.0015 | 0.0116 | |
| 5YR Returns | −0.0009 | 0.0066 | |

APPENDIX III
CM Rate Data

| DATE | Cash 5YR | DATE | Cash_7YR | DATE | Cash_10 YR | DATE | Cash_20YR | Date | Fed Funds |
|---|---|---|---|---|---|---|---|---|---|
| Apr-53 | 2.62 | | | Apr-53 | 2.83 | 1953.04 | 3.08 | | |
| May-53 | 2.87 | | | May-53 | 3.05 | 1953.05 | 3.18 | | |
| Jun-53 | 2.94 | | | Jun-53 | 3.11 | 1953.06 | 3.21 | | |
| Jul-53 | 2.75 | | | Jul-53 | 2.93 | 1953.07 | 3.12 | | |
| Aug-53 | 2.8 | | | Aug-53 | 2.95 | 1953.08 | 3.1 | | |
| Sep-53 | 2.71 | | | Sep-53 | 2.87 | 1953.09 | 3.07 | | |
| Oct-53 | 2.43 | | | Oct-53 | 2.66 | 1953.1 | 2.95 | | |
| Nov-53 | 2.42 | | | Nov-53 | 2.68 | 1953.11 | 2.95 | | |
| Dec-53 | 2.32 | | | Dec-53 | 2.59 | 1953.12 | 2.89 | | |
| Jan-54 | 2.17 | | | Jan-54 | 2.48 | 1954.01 | 2.8 | | |
| Feb-54 | 2.04 | | | Feb-54 | 2.47 | 1954.02 | 2.72 | | |
| Mar-54 | 1.93 | | | Mar-54 | 2.37 | 1954.03 | 2.61 | | |
| Apr-54 | 1.87 | | | Apr-54 | 2.29 | 1954.04 | 2.6 | | |
| May-54 | 1.92 | | | May-54 | 2.37 | 1954.05 | 2.66 | | |
| Jun-54 | 1.92 | | | Jun-54 | 2.38 | 1954.06 | 2.64 | | |
| Jul-54 | 1.85 | | | Jul-54 | 2.3 | 1954.07 | 2.57 | 1954.07 | 0.8 |
| Aug-54 | 1.9 | | | Aug-54 | 2.36 | 1954.08 | 2.58 | 1954.08 | 1.22 |
| Sep-54 | 1.96 | | | Sep-54 | 2.38 | 1954.09 | 2.6 | 1954.09 | 1.06 |
| Oct-54 | 2.02 | | | Oct-54 | 2.43 | 1954.1 | 2.61 | 1954.1 | 0.85 |
| Nov-54 | 2.09 | | | Nov-54 | 2.48 | 1954.11 | 2.65 | 1954.11 | 0.83 |
| Dec-54 | 2.16 | | | Dec-54 | 2.51 | 1954.12 | 2.67 | 1954.12 | 1.28 |
| Jan-55 | 2.32 | | | Jan-55 | 2.61 | 1955.01 | 2.75 | 1955.01 | 1.39 |
| Feb-55 | 2.38 | | | Feb-55 | 2.65 | 1955.02 | 2.83 | 1955.02 | 1.29 |
| Mar-55 | 2.48 | | | Mar-55 | 2.68 | 1955.03 | 2.84 | 1955.03 | 1.35 |
| Apr-55 | 2.55 | | | Apr-55 | 2.75 | 1955.04 | 2.85 | 1955.04 | 1.43 |
| May-55 | 2.56 | | | May-55 | 2.76 | 1955.05 | 2.87 | 1955.05 | 1.43 |
| Jun-55 | 2.59 | | | Jun-55 | 2.78 | 1955.06 | 2.86 | 1955.06 | 1.64 |
| Jul-55 | 2.72 | | | Jul-55 | 2.9 | 1955.07 | 2.94 | 1955.07 | 1.68 |
| Aug-55 | 2.86 | | | Aug-55 | 2.97 | 1955.08 | 3.01 | 1955.08 | 1.96 |
| Sep-55 | 2.85 | | | Sep-55 | 2.97 | 1955.09 | 3 | 1955.09 | 2.18 |
| Oct-55 | 2.76 | | | Oct-55 | 2.88 | 1955.1 | 2.93 | 1955.1 | 2.24 |
| Nov-55 | 2.81 | | | Nov-55 | 2.89 | 1955.11 | 2.93 | 1955.11 | 2.35 |
| Dec-55 | 2.93 | | | Dec-55 | 2.96 | 1955.12 | 2.98 | 1955.12 | 2.48 |
| Jan-56 | 2.84 | | | Jan-56 | 2.9 | 1956.01 | 2.94 | 1956.01 | 2.45 |
| Feb-56 | 2.74 | | | Feb-56 | 2.84 | 1956.02 | 2.91 | 1956.02 | 2.5 |
| Mar-56 | 2.93 | | | Mar-56 | 2.96 | 1956.03 | 2.99 | 1956.03 | 2.5 |
| Apr-56 | 3.2 | | | Apr-56 | 3.18 | 1956.04 | 3.14 | 1956.04 | 2.62 |
| May-56 | 3.08 | | | May-56 | 3.07 | 1956.05 | 3.06 | 1956.05 | 2.75 |
| Jun-56 | 2.97 | | | Jun-56 | 3 | 1956.06 | 3 | 1956.06 | 2.71 |
| Jul-56 | 3.12 | | | Jul-56 | 3.11 | 1956.07 | 3.08 | 1956.07 | 2.75 |
| Aug-56 | 3.41 | | | Aug-56 | 3.33 | 1956.08 | 3.22 | 1956.08 | 2.73 |
| Sep-56 | 3.47 | | | Sep-56 | 3.38 | 1956.09 | 3.28 | 1956.09 | 2.95 |
| Oct-56 | 3.4 | | | Oct-56 | 3.34 | 1956.1 | 3.26 | 1956.1 | 2.96 |
| Nov-56 | 3.56 | | | Nov-56 | 3.49 | 1956.11 | 3.37 | 1956.11 | 2.88 |
| Dec-56 | 3.7 | | | Dec-56 | 3.59 | 1956.12 | 3.45 | 1956.12 | 2.94 |
| Jan-57 | 3.47 | | | Jan-57 | 3.46 | 1957.01 | 3.41 | 1957.01 | 2.84 |
| Feb-57 | 3.39 | | | Feb-57 | 3.34 | 1957.02 | 3.3 | 1957.02 | 3 |
| Mar-57 | 3.46 | | | Mar-57 | 3.41 | 1957.03 | 3.32 | 1957.03 | 2.96 |
| Apr-57 | 3.53 | | | Apr-57 | 3.48 | 1957.04 | 3.4 | 1957.04 | 3 |
| May-57 | 3.64 | | | May-57 | 3.6 | 1957.05 | 3.49 | 1957.05 | 3 |
| Jun-57 | 3.83 | | | Jun-57 | 3.8 | 1957.06 | 3.65 | 1957.06 | 3 |
| Jul-57 | 4 | | | Jul-57 | 3.93 | 1957.07 | 3.72 | 1957.07 | 2.99 |
| Aug-57 | 4 | | | Aug-57 | 3.93 | 1957.08 | 3.75 | 1957.08 | 3.24 |
| Sep-57 | 4.03 | | | Sep-57 | 3.92 | 1957.09 | 3.73 | 1957.09 | 3.47 |
| Oct-57 | 4.08 | | | Oct-57 | 3.97 | 1957.1 | 3.76 | 1957.1 | 3.5 |
| Nov-57 | 3.72 | | | Nov-57 | 3.72 | 1957.11 | 3.61 | 1957.11 | 3.28 |
| Dec-57 | 3.08 | | | Dec-57 | 3.21 | 1957.12 | 3.38 | 1957.12 | 2.98 |
| Jan-58 | 2.88 | | | Jan-58 | 3.09 | 1958.01 | 3.27 | 1958.01 | 2.72 |
| Feb-58 | 2.78 | | | Feb-58 | 3.05 | 1958.02 | 3.31 | 1958.02 | 1.67 |
| Mar-58 | 2.64 | | | Mar-58 | 2.98 | 1958.03 | 3.29 | 1958.03 | 1.2 |
| Apr-58 | 2.46 | | | Apr-58 | 2.88 | 1958.04 | 3.17 | 1958.04 | 1.26 |
| May-58 | 2.41 | | | May-58 | 2.92 | 1958.05 | 3.17 | 1958.05 | 0.63 |
| Jun-58 | 2.46 | | | Jun-58 | 2.97 | 1958.06 | 3.23 | 1958.06 | 0.93 |
| Jul-58 | 2.77 | | | Jul-58 | 3.2 | 1958.07 | 3.39 | 1958.07 | 0.68 |
| Aug-58 | 3.29 | | | Aug-58 | 3.54 | 1958.08 | 3.65 | 1958.08 | 1.53 |
| Sep-58 | 3.69 | | | Sep-58 | 3.76 | 1958.09 | 3.8 | 1958.09 | 1.76 |
| Oct-58 | 3.78 | | | Oct-58 | 3.8 | 1958.1 | 3.81 | 1958.1 | 1.8 |
| Nov-58 | 3.7 | | | Nov-58 | 3.74 | 1958.11 | 3.76 | 1958.11 | 2.27 |
| Dec-58 | 3.82 | | | Dec-58 | 3.86 | 1958.12 | 3.86 | 1958.12 | 2.42 |
| Jan-59 | 4.01 | | | Jan-59 | 4.02 | 1959.01 | 3.95 | 1959.01 | 2.48 |
| Feb-59 | 3.96 | | | Feb-59 | 3.96 | 1959.02 | 3.96 | 1959.02 | 2.43 |
| Mar-59 | 3.99 | | | Mar-59 | 3.99 | 1959.03 | 3.99 | 1959.03 | 2.8 |
| Apr-59 | 4.12 | | | Apr-59 | 4.12 | 1959.04 | 4.06 | 1959.04 | 2.96 |
| May-59 | 4.35 | | | May-59 | 4.31 | 1959.05 | 4.13 | 1959.05 | 2.9 |
| Jun-59 | 4.5 | | | Jun-59 | 4.34 | 1959.06 | 4.14 | 1959.06 | 3.39 |
| Jul-59 | 4.58 | | | Jul-59 | 4.4 | 1959.07 | 4.16 | 1959.07 | 3.47 |
| Aug-59 | 4.57 | | | Aug-59 | 4.43 | 1959.08 | 4.15 | 1959.08 | 3.5 |
| Sep-59 | 4.9 | | | Sep-59 | 4.68 | 1959.09 | 4.29 | 1959.09 | 3.76 |
| Oct-59 | 4.72 | | | Oct-59 | 4.53 | 1959.1 | 4.19 | 1959.1 | 3.98 |
| Nov-59 | 4.75 | | | Nov-59 | 4.53 | 1959.11 | 4.2 | 1959.11 | 4 |
| Dec-59 | 5.01 | | | Dec-59 | 4.69 | 1959.12 | 4.33 | 1959.12 | 3.99 |
| Jan-60 | 4.92 | | | Jan-60 | 4.72 | 1960.01 | 4.42 | 1960.01 | 3.99 |
| Feb-60 | 4.69 | | | Feb-60 | 4.49 | 1960.02 | 4.28 | 1960.02 | 3.97 |
| Mar-60 | 4.31 | | | Mar-60 | 4.25 | 1960.03 | 4.14 | 1960.03 | 3.84 |
| Apr-60 | 4.29 | | | Apr-60 | 4.28 | 1960.04 | 4.23 | 1960.04 | 3.92 |
| May-60 | 4.49 | | | May-60 | 4.35 | 1960.05 | 4.2 | 1960.05 | 3.85 |
| Jun-60 | 4.12 | | | Jun-60 | 4.15 | 1960.06 | 4.04 | 1960.06 | 3.32 |
| Jul-60 | 3.79 | | | Jul-60 | 3.9 | 1960.07 | 3.91 | 1960.07 | 3.23 |
| Aug-60 | 3.62 | | | Aug-60 | 3.8 | 1960.08 | 3.84 | 1960.08 | 2.98 |
| Sep-60 | 3.61 | | | Sep-60 | 3.8 | 1960.09 | 3.86 | 1960.09 | 2.6 |
| Oct-60 | 3.76 | | | Oct-60 | 3.89 | 1960.1 | 3.92 | 1960.1 | 2.47 |
| Nov-60 | 3.81 | | | Nov-60 | 3.93 | 1960.11 | 3.96 | 1960.11 | 2.44 |
| Dec-60 | 3.67 | | | Dec-60 | 3.84 | 1960.12 | 3.91 | 1960.12 | 1.98 |
| Jan-61 | 3.67 | | | Jan-61 | 3.84 | 1961.01 | 3.9 | 1961.01 | 1.45 |
| Feb-61 | 3.66 | | | Feb-61 | 3.78 | 1961.02 | 3.84 | 1961.02 | 2.54 |
| Mar-61 | 3.6 | | | Mar-61 | 3.74 | 1961.03 | 3.81 | 1961.03 | 2.02 |
| Apr-61 | 3.57 | | | Apr-61 | 3.78 | 1961.04 | 3.81 | 1961.04 | 1.49 |
| May-61 | 3.47 | | | May-61 | 3.71 | 1961.05 | 3.74 | 1961.05 | 1.98 |
| Jun-61 | 3.81 | | | Jun-61 | 3.88 | 1961.06 | 3.89 | 1961.06 | 1.73 |
| Jul-61 | 3.84 | | | Jul-61 | 3.92 | 1961.07 | 3.93 | 1961.07 | 1.17 |
| Aug-61 | 3.96 | | | Aug-61 | 4.04 | 1961.08 | 4.04 | 1961.08 | 2 |
| Sep-61 | 3.9 | | | Sep-61 | 3.98 | 1961.09 | 4.04 | 1961.09 | 1.88 |
| Oct-61 | 3.8 | | | Oct-61 | 3.92 | 1961.1 | 4.01 | 1961.1 | 2.26 |
| Nov-61 | 3.82 | | | Nov-61 | 3.94 | 1961.11 | 4 | 1961.11 | 2.61 |
| Dec-61 | 3.91 | | | Dec-61 | 4.06 | 1961.12 | 4.07 | 1961.12 | 2.33 |
| Jan-62 | 3.94 | | | Jan-62 | 4.08 | 1962.01 | 4.1 | 1962.01 | 2.15 |
| Feb-62 | 3.89 | | | Feb-62 | 4.04 | 1962.02 | 4.12 | 1962.02 | 2.37 |
| Mar-62 | 3.68 | | | Mar-62 | 3.93 | 1962.03 | 4.04 | 1962.03 | 2.85 |
| Apr-62 | 3.6 | | | Apr-62 | 3.84 | 1962.04 | 3.93 | 1962.04 | 2.78 |
| May-62 | 3.66 | | | May-62 | 3.87 | 1962.05 | 3.92 | 1962.05 | 2.36 |
| Jun-62 | 3.64 | | | Jun-62 | 3.91 | 1962.06 | 3.96 | 1962.06 | 2.68 |
| Jul-62 | 3.8 | | | Jul-62 | 4.01 | 1962.07 | 4.05 | 1962.07 | 2.71 |
| Aug-62 | 3.71 | | | Aug-62 | 3.98 | 1962.08 | 4.01 | 1962.08 | 2.93 |
| Sep-62 | 3.7 | | | Sep-62 | 3.98 | 1962.09 | 4 | 1962.09 | 2.9 |
| Oct-62 | 3.64 | | | Oct-62 | 3.93 | 1962.1 | 3.94 | 1962.1 | 2.9 |
| Nov-62 | 3.6 | | | Nov-62 | 3.92 | 1962.11 | 3.93 | 1962.11 | 2.94 |
| Dec-62 | 3.56 | | | Dec-62 | 3.86 | 1962.12 | 3.92 | 1962.12 | 2.93 |
| Jan-63 | 3.58 | | | Jan-63 | 3.83 | 1963.01 | 3.93 | 1963.01 | 2.92 |
| Feb-63 | 3.66 | | | Feb-63 | 3.92 | 1963.02 | 3.97 | 1963.02 | 3 |
| Mar-63 | 3.68 | | | Mar-63 | 3.93 | 1963.03 | 3.98 | 1963.03 | 2.98 |
| Apr-63 | 3.74 | | | Apr-63 | 3.97 | 1963.04 | 4.03 | 1963.04 | 2.9 |
| May-63 | 3.72 | | | May-63 | 3.93 | 1963.05 | 4.02 | 1963.05 | 3 |
| Jun-63 | 3.81 | | | Jun-63 | 3.99 | 1963.06 | 4.02 | 1963.06 | 2.99 |
| Jul-63 | 3.89 | | | Jul-63 | 4.02 | 1963.07 | 4.06 | 1963.07 | 3.02 |
| Aug-63 | 3.89 | | | Aug-63 | 4 | 1963.08 | 4.03 | 1963.08 | 3.49 |
| Sep-63 | 3.96 | | | Sep-63 | 4.08 | 1963.09 | 4.09 | 1963.09 | 3.48 |
| Oct-63 | 3.97 | | | Oct-63 | 4.11 | 1963.1 | 4.12 | 1963.1 | 3.5 |
| Nov-63 | 4.01 | | | Nov-63 | 4.12 | 1963.11 | 4.16 | 1963.11 | 3.48 |
| Dec-63 | 4.04 | | | Dec-63 | 4.13 | 1963.12 | 4.19 | 1963.12 | 3.38 |
| Jan-64 | 4.07 | | | Jan-64 | 4.17 | 1964.01 | 4.19 | 1964.01 | 3.48 |
| Feb-64 | 4.03 | | | Feb-64 | 4.15 | 1964.02 | 4.17 | 1964.02 | 3.48 |
| Mar-64 | 4.14 | | | Mar-64 | 4.22 | 1964.03 | 4.22 | 1964.03 | 3.43 |
| Apr-64 | 4.15 | | | Apr-64 | 4.23 | 1964.04 | 4.24 | 1964.04 | 3.47 |
| May-64 | 4.05 | | | May-64 | 4.2 | 1964.05 | 4.2 | 1964.05 | 3.5 |
| Jun-64 | 4.02 | | | Jun-64 | 4.17 | 1964.06 | 4.17 | 1964.06 | 3.5 |
| Jul-64 | 4.03 | | | Jul-64 | 4.19 | 1964.07 | 4.16 | 1964.07 | 3.42 |
| Aug-64 | 4.05 | | | Aug-64 | 4.19 | 1964.08 | 4.18 | 1964.08 | 3.5 |
| Sep-64 | 4.08 | | | Sep-64 | 4.2 | 1964.09 | 4.2 | 1964.09 | 3.45 |
| Oct-64 | 4.07 | | | Oct-64 | 4.19 | 1964.1 | 4.2 | 1964.1 | 3.36 |
| Nov-64 | 4.04 | | | Nov-64 | 4.15 | 1964.11 | 4.17 | 1964.11 | 3.52 |
| Dec-64 | 4.09 | | | Dec-64 | 4.18 | 1964.12 | 4.18 | 1964.12 | 3.85 |
| Jan-65 | 4.1 | | | Jan-65 | 4.19 | 1965.01 | 4.19 | 1965.01 | 3.9 |
| Feb-65 | 4.15 | | | Feb-65 | 4.21 | 1965.02 | 4.21 | 1965.02 | 3.98 |
| Mar-65 | 4.15 | | | Mar-65 | 4.21 | 1965.03 | 4.2 | 1965.03 | 4.04 |
| Apr-65 | 4.15 | | | Apr-65 | 4.2 | 1965.04 | 4.2 | 1965.04 | 4.09 |
| May-65 | 4.15 | | | May-65 | 4.21 | 1965.05 | 4.21 | 1965.05 | 4.1 |
| Jun-65 | 4.15 | | | Jun-65 | 4.21 | 1965.06 | 4.21 | 1965.06 | 4.04 |
| Jul-65 | 4.15 | | | Jul-65 | 4.2 | 1965.07 | 4.21 | 1965.07 | 4.09 |
| Aug-65 | 4.2 | | | Aug-65 | 4.25 | 1965.08 | 4.25 | 1965.08 | 4.12 |
| Sep-65 | 4.25 | | | Sep-65 | 4.29 | 1965.09 | 4.3 | 1965.09 | 4.01 |
| Oct-65 | 4.34 | | | Oct-65 | 4.35 | 1965.1 | 4.32 | 1965.1 | 4.08 |
| Nov-65 | 4.46 | | | Nov-65 | 4.45 | 1965.11 | 4.4 | 1965.11 | 4.1 |
| Dec-65 | 4.72 | | | Dec-65 | 4.62 | 1965.12 | 4.5 | 1965.12 | 4.32 |
| Jan-66 | 4.86 | | | Jan-66 | 4.61 | 1966.01 | 4.52 | 1966.01 | 4.42 |
| Feb-66 | 4.98 | | | Feb-66 | 4.83 | 1966.02 | 4.71 | 1966.02 | 4.6 |
| Mar-66 | 4.92 | | | Mar-66 | 4.87 | 1966.03 | 4.72 | 1966.03 | 4.65 |
| Apr-66 | 4.83 | | | Apr-66 | 4.75 | 1966.04 | 4.65 | 1966.04 | 4.67 |
| May-66 | 4.89 | | | May-66 | 4.78 | 1966.05 | 4.69 | 1966.05 | 4.9 |
| Jun-66 | 4.97 | | | Jun-66 | 4.81 | 1966.06 | 4.73 | 1966.06 | 5.17 |
| Jul-66 | 5.17 | | | Jul-66 | 5.02 | 1966.07 | 4.84 | 1966.07 | 5.3 |
| Aug-66 | 5.5 | | | Aug-66 | 5.22 | 1966.08 | 4.95 | 1966.08 | 5.53 |
| Sep-66 | 5.5 | | | Sep-66 | 5.18 | 1966.09 | 4.94 | 1966.09 | 5.4 |
| Oct-66 | 5.27 | | | Oct-66 | 5.01 | 1966.1 | 4.83 | 1966.1 | 5.53 |
| Nov-66 | 5.36 | | | Nov-66 | 5.16 | 1966.11 | 4.87 | 1966.11 | 5.76 |
| Dec-66 | 5 | | | Dec-66 | 4.84 | 1966.12 | 4.76 | 1966.12 | 5.4 |
| Jan-67 | 4.7 | | | Jan-67 | 4.58 | 1967.01 | 4.51 | 1967.01 | 4.94 |
| Feb-67 | 4.74 | | | Feb-67 | 4.63 | 1967.02 | 4.61 | 1967.02 | 5 |
| Mar-67 | 4.54 | | | Mar-67 | 4.54 | 1967.03 | 4.56 | 1967.03 | 4.53 |
| Apr-67 | 4.51 | | | Apr-67 | 4.59 | 1967.04 | 4.64 | 1967.04 | 4.05 |
| May-67 | 4.75 | | | May-67 | 4.85 | 1967.05 | 4.9 | 1967.05 | 3.94 |
| Jun-67 | 5.01 | | | Jun-67 | 5.02 | 1967.06 | 4.99 | 1967.06 | 3.98 |
| Jul-67 | 5.23 | | | Jul-67 | 5.16 | 1967.07 | 5.01 | 1967.07 | 3.79 |
| Aug-67 | 5.31 | | | Aug-67 | 5.28 | 1967.08 | 5.12 | 1967.08 | 3.9 |
| Sep-67 | 5.4 | | | Sep-67 | 5.3 | 1967.09 | 5.16 | 1967.09 | 3.99 |
| Oct-67 | 5.57 | | | Oct-67 | 5.48 | 1967.1 | 5.36 | 1967.1 | 3.88 |
| Nov-67 | 5.78 | | | Nov-67 | 5.75 | 1967.11 | 5.66 | 1967.11 | 4.13 |
| Dec-67 | 5.75 | | | Dec-67 | 5.7 | 1967.12 | 5.59 | 1967.12 | 4.51 |
| Jan-68 | 5.54 | | | Jan-68 | 5.53 | 1968.01 | 5.39 | 1968.01 | 4.6 |
| Feb-68 | 5.59 | | | Feb-68 | 5.56 | 1968.02 | 5.38 | 1968.02 | 4.71 |
| Mar-68 | 5.76 | | | Mar-68 | 5.74 | 1968.03 | 5.59 | 1968.03 | 5.05 |
| Apr-68 | 5.69 | | | Apr-68 | 5.64 | 1968.04 | 5.46 | 1968.04 | 5.76 |
| May-68 | 6.04 | | | May-68 | 5.87 | 1968.05 | 5.55 | 1968.05 | 6.11 |
| Jun-68 | 5.85 | | | Jun-68 | 5.72 | 1968.06 | 5.4 | 1968.06 | 6.07 |
| Jul-68 | 5.6 | | | Jul-68 | 5.5 | 1968.07 | 5.29 | 1968.07 | 6.02 |
| Aug-68 | 5.5 | | | Aug-68 | 5.42 | 1968.08 | 5.23 | 1968.08 | 6.03 |
| Sep-68 | 5.48 | | | Sep-68 | 5.46 | 1968.09 | 5.28 | 1968.09 | 5.78 |
| Oct-68 | 5.55 | | | Oct-68 | 5.58 | 1968.1 | 5.44 | 1968.1 | 5.91 |
| Nov-68 | 5.66 | | | Nov-68 | 5.7 | 1968.11 | 5.56 | 1968.11 | 5.82 |
| Dec-68 | 6.12 | | | Dec-68 | 6.03 | 1968.12 | 5.88 | 1968.12 | 6.02 |
| Jan-69 | 6.25 | | | Jan-69 | 6.04 | 1969.01 | 5.99 | 1969.01 | 6.3 |
| Feb-69 | 6.34 | | | Feb-69 | 6.19 | 1969.02 | 6.11 | 1969.02 | 6.61 |
| Mar-69 | 6.41 | | | Mar-69 | 6.3 | 1969.03 | 6.22 | 1969.03 | 6.79 |
| Apr-69 | 6.3 | | | Apr-69 | 6.17 | 1969.04 | 6.03 | 1969.04 | 7.41 |
| May-69 | 6.54 | | | May-69 | 6.32 | 1969.05 | 6.11 | 1969.05 | 8.67 |
| Jun-69 | 6.75 | | | Jun-69 | 6.57 | 1969.06 | 6.28 | 1969.06 | 8.9 |
| Jul-69 | 7.01 | Jul-69 | 6.8 | Jul-69 | 6.72 | 1969.07 | 6.27 | 1969.07 | 8.61 |
| Aug-69 | 7.03 | Aug-69 | 6.79 | Aug-69 | 6.69 | 1969.08 | 6.22 | 1969.08 | 9.19 |
| Sep-69 | 7.57 | Sep-69 | 7.36 | Sep-69 | 7.16 | 1969.09 | 6.55 | 1969.09 | 9.15 |
| Oct-69 | 7.51 | Oct-69 | 7.24 | Oct-69 | 7.1 | 1969.1 | 6.49 | 1969.1 | 9 |
| Nov-69 | 7.53 | Nov-69 | 7.17 | Nov-69 | 7.14 | 1969.11 | 6.74 | 1969.11 | 8.85 |
| Dec-69 | 7.96 | Dec-69 | 7.51 | Dec-69 | 7.65 | 1969.12 | 6.91 | 1969.12 | 8.97 |
| Jan-70 | 8.17 | Jan-70 | 7.73 | Jan-70 | 7.79 | 1970.01 | 6.92 | 1970.01 | 8.98 |
| Feb-70 | 7.82 | Feb-70 | 7.51 | Feb-70 | 7.24 | 1970.02 | 6.67 | 1970.02 | 8.98 |
| Mar-70 | 7.21 | Mar-70 | 7.13 | Mar-70 | 7.07 | 1970.03 | 6.72 | 1970.03 | 7.76 |
| Apr-70 | 7.5 | Apr-70 | 7.45 | Apr-70 | 7.39 | 1970.04 | 6.85 | 1970.04 | 8.1 |
| May-70 | 7.97 | May-70 | 7.93 | May-70 | 7.91 | 1970.05 | 7.24 | 1970.05 | 7.94 |
| Jun-70 | 7.85 | Jun-70 | 7.84 | Jun-70 | 7.84 | 1970.06 | 7.34 | 1970.06 | 7.6 |
| Jul-70 | 7.59 | Jul-70 | 7.61 | Jul-70 | 7.46 | 1970.07 | 6.92 | 1970.07 | 7.21 |
| Aug-70 | 7.57 | Aug-70 | 7.59 | Aug-70 | 7.53 | 1970.08 | 7.07 | 1970.08 | 6.61 |
| Sep-70 | 7.29 | Sep-70 | 7.4 | Sep-70 | 7.39 | 1970.09 | 6.88 | 1970.09 | 6.29 |
| Oct-70 | 7.12 | Oct-70 | 7.32 | Oct-70 | 7.33 | 1970.1 | 6.88 | 1970.1 | 6.2 |
| Nov-70 | 6.47 | Nov-70 | 6.76 | Nov-70 | 6.84 | 1970.11 | 6.58 | 1970.11 | 5.6 |
| Dec-70 | 5.95 | Dec-70 | 6.23 | Dec-70 | 6.39 | 1970.12 | 6.28 | 1970.12 | 4.9 |
| Jan-71 | 5.89 | Jan-71 | 6.16 | Jan-71 | 6.24 | 1971.01 | 6.18 | 1971.01 | 4.14 |
| Feb-71 | 5.56 | Feb-71 | 5.94 | Feb-71 | 6.11 | 1971.02 | 6.14 | 1971.02 | 3.72 |
| Mar-71 | 5 | Mar-71 | 5.42 | Mar-71 | 5.7 | 1971.03 | 5.94 | 1971.03 | 3.71 |
| Apr-71 | 5.65 | Apr-71 | 5.87 | Apr-71 | 5.83 | 1971.04 | 6 | 1971.04 | 4.15 |
| May-71 | 6.28 | May-71 | 6.42 | May-71 | 6.39 | 1971.05 | 6.32 | 1971.05 | 4.63 |
| Jun-71 | 6.53 | Jun-71 | 6.65 | Jun-71 | 6.52 | 1971.06 | 6.38 | 1971.06 | 4.91 |
| Jul-71 | 6.85 | Jul-71 | 6.92 | Jul-71 | 6.73 | 1971.07 | 6.38 | 1971.07 | 5.31 |
| Aug-71 | 6.55 | Aug-71 | 6.67 | Aug-71 | 6.58 | 1971.08 | 6.27 | 1971.08 | 5.56 |
| Sep-71 | 6.14 | Sep-71 | 6.2 | Sep-71 | 6.14 | 1971.09 | 6.05 | 1971.09 | 5.55 |
| Oct-71 | 5.93 | Oct-71 | 5.98 | Oct-71 | 5.93 | 1971.1 | 5.92 | 1971.1 | 5.2 |
| Nov-71 | 5.78 | Nov-71 | 5.94 | Nov-71 | 5.81 | 1971.11 | 5.86 | 1971.11 | 4.91 |
| Dec-71 | 5.69 | Dec-71 | 5.97 | Dec-71 | 5.93 | 1971.12 | 6 | 1971.12 | 4.14 |
| Jan-72 | 5.59 | Jan-72 | 5.91 | Jan-72 | 5.95 | 1972.01 | 6.01 | 1972.01 | 3.5 |
| Feb-72 | 5.69 | Feb-72 | 5.99 | Feb-72 | 6.08 | 1972.02 | 6.06 | 1972.02 | 3.29 |
| Mar-72 | 5.87 | Mar-72 | 6.05 | Mar-72 | 6.07 | 1972.03 | 6.06 | 1972.03 | 3.83 |
| Apr-72 | 6.17 | Apr-72 | 6.22 | Apr-72 | 6.19 | 1972.04 | 6.16 | 1972.04 | 4.17 |
| May-72 | 5.85 | May-72 | 6.07 | May-72 | 6.13 | 1972.05 | 6.07 | 1972.05 | 4.27 |
| Jun-72 | 5.91 | Jun-72 | 6.06 | Jun-72 | 6.11 | 1972.06 | 6.01 | 1972.06 | 4.46 |
| Jul-72 | 5.97 | Jul-72 | 6.09 | Jul-72 | 6.11 | 1972.07 | 6.01 | 1972.07 | 4.55 |
| Aug-72 | 6.02 | Aug-72 | 6.19 | Aug-72 | 6.21 | 1972.08 | 5.94 | 1972.08 | 4.8 |
| Sep-72 | 6.25 | Sep-72 | 6.43 | Sep-72 | 6.55 | 1972.09 | 6.05 | 1972.09 | 4.87 |
| Oct-72 | 6.18 | Oct-72 | 6.35 | Oct-72 | 6.48 | 1972.1 | 6 | 1972.1 | 5.04 |
| Nov-72 | 6.12 | Nov-72 | 6.18 | Nov-72 | 6.28 | 1972.11 | 5.79 | 1972.11 | 5.06 |
| Dec-72 | 6.16 | Dec-72 | 6.2 | Dec-72 | 6.36 | 1972.12 | 5.96 | 1972.12 | 5.33 |
| Jan-73 | 6.34 | Jan-73 | 6.36 | Jan-73 | 6.46 | 1973.01 | 6.78 | 1973.01 | 5.94 |
| Feb-73 | 6.6 | Feb-73 | 6.6 | Feb-73 | 6.64 | 1973.02 | 6.88 | 1973.02 | 6.58 |
| Mar-73 | 6.8 | Mar-73 | 6.76 | Mar-73 | 6.71 | 1973.03 | 6.91 | 1973.03 | 7.09 |
| Apr-73 | 6.67 | Apr-73 | 6.67 | Apr-73 | 6.67 | 1973.04 | 6.86 | 1973.04 | 7.12 |
| May-73 | 6.8 | May-73 | 6.83 | May-73 | 6.85 | 1973.05 | 6.99 | 1973.05 | 7.84 |
| Jun-73 | 6.69 | Jun-73 | 6.81 | Jun-73 | 6.9 | 1973.06 | 7.06 | 1973.06 | 8.49 |
| Jul-73 | 7.33 | Jul-73 | 7.23 | Jul-73 | 7.13 | 1973.07 | 7.29 | 1973.07 | 10.4 |
| Aug-73 | 7.63 | Aug-73 | 7.52 | Aug-73 | 7.4 | 1973.08 | 7.61 | 1973.08 | 10.5 |
| Sep-73 | 7.05 | Sep-73 | 7.08 | Sep-73 | 7.09 | 1973.09 | 7.25 | 1973.09 | 10.78 |
| Oct-73 | 6.77 | Oct-73 | 6.78 | Oct-73 | 6.79 | 1973.1 | 7.18 | 1973.1 | 10.01 |
| Nov-73 | 6.92 | Nov-73 | 6.89 | Nov-73 | 6.73 | 1973.11 | 7.3 | 1973.11 | 10.03 |
| Dec-73 | 6.8 | Dec-73 | 6.77 | Dec-73 | 6.74 | 1973.12 | 7.29 | 1973.12 | 9.95 |
| Jan-74 | 6.95 | Jan-74 | 6.88 | Jan-74 | 6.99 | 1974.01 | 7.47 | 1974.01 | 9.65 |
| Feb-74 | 6.82 | Feb-74 | 6.92 | Feb-74 | 6.96 | 1974.02 | 7.46 | 1974.02 | 8.97 |
| Mar-74 | 7.31 | Mar-74 | 7.34 | Mar-74 | 7.21 | 1974.03 | 7.73 | 1974.03 | 9.35 |
| Apr-74 | 7.92 | Apr-74 | 1.11 | Apr-74 | 7.51 | 1974.04 | 8.01 | 1974.04 | 10.51 |
| May-74 | 8.18 | May-74 | 7.93 | May-74 | 7.58 | 1974.05 | 8.14 | 1974.05 | 11.31 |
| Jun-74 | 8.1 | Jun-74 | 7.9 | Jun-74 | 7.54 | 1974.06 | 8.1 | 1974.06 | 11.93 |
| Jul-74 | 8.38 | Jul-74 | 8.19 | Jul-74 | 7.81 | 1974.07 | 8.26 | 1974.07 | 12.92 |
| Aug-74 | 8.63 | Aug-74 | 8.41 | Aug-74 | 8.04 | 1974.08 | 8.6 | 1974.08 | 12.01 |
| Sep-74 | 8.37 | Sep-74 | 8.25 | Sep-74 | 8.04 | 1974.09 | 8.59 | 1974.09 | 11.34 |
| Oct-74 | 7.97 | Oct-74 | 7.92 | Oct-74 | 7.9 | 1974.1 | 8.37 | 1974.1 | 10.06 |
| Nov-74 | 7.68 | Nov-74 | 7.68 | Nov-74 | 7.68 | 1974.11 | 7.98 | 1974.11 | 9.45 |
| Dec-74 | 7.31 | Dec-74 | 7.38 | Dec-74 | 7.43 | 1974.12 | 7.91 | 1974.12 | 8.53 |
| Jan-75 | 7.41 | Jan-75 | 7.45 | Jan-75 | 7.5 | 1975.01 | 7.88 | 1975.01 | 7.13 |
| Feb-75 | 7.11 | Feb-75 | 7.3 | Feb-75 | 7.39 | 1975.02 | 7.71 | 1975.02 | 6.24 |
| Mar-75 | 7.3 | Mar-75 | 7.58 | Mar-75 | 7.73 | 1975.03 | 7.99 | 1975.03 | 5.54 |
| Apr-75 | 7.99 | Apr-75 | 8.1 | Apr-75 | 8.23 | 1975.04 | 8.36 | 1975.04 | 5.49 |
| May-75 | 7.72 | May-75 | 7.9 | May-75 | 8.06 | 1975.05 | 8.22 | 1975.05 | 5.22 |
| Jun-75 | 7.51 | Jun-75 | 7.69 | Jun-75 | 7.86 | 1975.06 | 8.04 | 1975.06 | 5.55 |
| Jul-75 | 7.92 | Jul-75 | 7.99 | Jul-75 | 8.06 | 1975.07 | 8.17 | 1975.07 | 6.1 |
| Aug-75 | 8.33 | Aug-75 | 8.37 | Aug-75 | 8.4 | 1975.08 | 8.5 | 1975.08 | 6.14 |
| Sep-75 | 8.37 | Sep-75 | 8.39 | Sep-75 | 8.43 | 1975.09 | 8.57 | 1975.09 | 6.24 |
| Oct-75 | 7.97 | Oct-75 | 8.06 | Oct-75 | 8.14 | 1975.1 | 8.35 | 1975.1 | 5.82 |
| Nov-75 | 7.8 | Nov-75 | 7.98 | Nov-75 | 8.05 | 1975.11 | 8.28 | 1975.11 | 5.22 |
| Dec-75 | 7.76 | Dec-75 | 7.93 | Dec-75 | 8 | 1975.12 | 8.23 | 1975.12 | 5.2 |
| Jan-76 | 7.46 | Jan-76 | 7.67 | Jan-76 | 7.74 | 1976.01 | 8.01 | 1976.01 | 4.87 |
| Feb-76 | 7.45 | Feb-76 | 7.72 | Feb-76 | 7.79 | 1976.02 | 8.03 | 1976.02 | 4.77 |
| Mar-76 | 7.49 | Mar-76 | 7.65 | Mar-76 | 7.73 | 1976.03 | 7.97 | 1976.03 | 4.84 |
| Apr-76 | 7.25 | Apr-76 | 7.44 | Apr-76 | 7.56 | 1976.04 | 7.86 | 1976.04 | 4.82 |
| May-76 | 7.59 | May-76 | 7.77 | May-76 | 7.9 | 1976.05 | 8.13 | 1976.05 | 5.29 |
| Jun-76 | 7.61 | Jun-76 | 7.75 | Jun-76 | 7.86 | 1976.06 | 8.03 | 1976.06 | 5.48 |
| Jul-76 | 7.49 | Jul-76 | 7.7 | Jul-76 | 7.83 | 1976.07 | 8 | 1976.07 | 5.31 |
| Aug-76 | 7.31 | Aug-76 | 7.58 | Aug-76 | 7.77 | 1976.08 | 7.91 | 1976.08 | 5.29 |
| Sep-76 | 7.13 | Sep-76 | 7.41 | Sep-76 | 7.59 | 1976.09 | 7.78 | 1976.09 | 5.25 |
| Oct-76 | 6.75 | Oct-76 | 7.16 | Oct-76 | 7.41 | 1976.1 | 7.7 | 1976.1 | 5.02 |
| Nov-76 | 6.52 | Nov-76 | 6.86 | Nov-76 | 7.29 | 1976.11 | 7.64 | 1976.11 | 4.95 |
| Dec-76 | 6.1 | Dec-76 | 6.37 | Dec-76 | 6.87 | 1976.12 | 7.3 | 1976.12 | 4.65 |
| Jan-77 | 6.58 | Jan-77 | 6.92 | Jan-77 | 7.21 | 1977.01 | 7.48 | 1977.01 | 4.61 |
| Feb-77 | 6.83 | Feb-77 | 7.16 | Feb-77 | 7.39 | 1977.02 | 7.64 | 1977.02 | 4.68 |
| Mar-77 | 6.93 | Mar-77 | 7.2 | Mar-77 | 7.46 | 1977.03 | 7.73 | 1977.03 | 4.69 |
| Apr-77 | 6.79 | Apr-77 | 7.11 | Apr-77 | 7.37 | 1977.04 | 7.67 | 1977.04 | 4.73 |
| May-77 | 6.94 | May-77 | 7.26 | May-77 | 7.46 | 1977.05 | 7.74 | 1977.05 | 5.35 |
| Jun-77 | 6.76 | Jun-77 | 7.05 | Jun-77 | 7.28 | 1977.06 | 7.64 | 1977.06 | 5.39 |
| Jul-77 | 6.84 | Jul-77 | 7.12 | Jul-77 | 7.33 | 1977.07 | 7.6 | 1977.07 | 5.42 |
| Aug-77 | 7.03 | Aug-77 | 7.24 | Aug-77 | 7.4 | 1977.08 | 7.64 | 1977.08 | 5.9 |
| Sep-77 | 7.04 | Sep-77 | 7.21 | Sep-77 | 7.34 | 1977.09 | 7.57 | 1977.09 | 6.14 |
| Oct-77 | 7.32 | Oct-77 | 7.44 | Oct-77 | 7.52 | 1977.1 | 7.71 | 1977.1 | 6.47 |
| Nov-77 | 7.34 | Nov-77 | 7.46 | Nov-77 | 7.58 | 1977.11 | 7.76 | 1977.11 | 6.51 |
| Dec-77 | 7.48 | Dec-77 | 7.59 | Dec-77 | 7.69 | 1977.12 | 7.87 | 1977.12 | 6.56 |
| Jan-78 | 7.77 | Jan-78 | 7.86 | Jan-78 | 7.96 | 1978.01 | 8.14 | 1978.01 | 6.7 |
| Feb-78 | 7.83 | Feb-78 | 7.94 | Feb-78 | 8.03 | 1978.02 | 8.22 | 1978.02 | 6.78 |
| Mar-78 | 7.86 | Mar-78 | 7.95 | Mar-78 | 8.04 | 1978.03 | 8.21 | 1978.03 | 6.79 |
| Apr-78 | 7.98 | Apr-78 | 8.06 | Apr-78 | 8.15 | 1978.04 | 8.32 | 1978.04 | 6.89 |
| May-78 | 8.18 | May-78 | 8.25 | May-78 | 8.35 | 1978.05 | 8.44 | 1978.05 | 7.36 |
| Jun-78 | 8.36 | Jun-78 | 8.4 | Jun-78 | 8.46 | 1978.06 | 8.53 | 1978.06 | 7.6 |
| Jul-78 | 8.54 | Jul-78 | 8.55 | Jul-78 | 8.64 | 1978.07 | 8.69 | 1978.07 | 7.81 |
| Aug-78 | 8.33 | Aug-78 | 8.38 | Aug-78 | 8.41 | 1978.08 | 8.45 | 1978.08 | 8.04 |
| Sep-78 | 8.43 | Sep-78 | 8.42 | Sep-78 | 8.42 | 1978.09 | 8.47 | 1978.09 | 8.45 |
| Oct-78 | 8.61 | Oct-78 | 8.64 | Oct-78 | 8.64 | 1978.1 | 8.69 | 1978.1 | 8.96 |
| Nov-78 | 8.84 | Nov-78 | 8.8 | Nov-78 | 8.81 | 1978.11 | 8.75 | 1978.11 | 9.76 |
| Dec-78 | 9.08 | Dec-78 | 9.03 | Dec-78 | 9.01 | 1978.12 | 8.9 | 1978.12 | 10.03 |
| Jan-79 | 9.2 | Jan-79 | 9.14 | Jan-79 | 9.1 | 1979.01 | 8.98 | 1979.01 | 10.07 |
| Feb-79 | 9.13 | Feb-79 | 9.11 | Feb-79 | 9.1 | 1979.02 | 9.03 | 1979.02 | 10.06 |
| Mar-79 | 9.2 | Mar-79 | 9.15 | Mar-79 | 9.12 | 1979.03 | 9.08 | 1979.03 | 10.09 |
| Apr-79 | 9.25 | Apr-79 | 9.21 | Apr-79 | 9.18 | 1979.04 | 9.12 | 1979.04 | 10.01 |
| May-79 | 9.24 | May-79 | 9.23 | May-79 | 9.25 | 1979.05 | 9.21 | 1979.05 | 10.24 |
| Jun-79 | 8.85 | Jun-79 | 8.86 | Jun-79 | 8.91 | 1979.06 | 8.91 | 1979.06 | 10.29 |
| Jul-79 | 8.9 | Jul-79 | 8.92 | Jul-79 | 8.95 | 1979.07 | 8.92 | 1979.07 | 10.47 |
| Aug-79 | 9.06 | Aug-79 | 9.05 | Aug-79 | 9.03 | 1979.08 | 8.97 | 1979.08 | 10.94 |
| Sep-79 | 9.41 | Sep-79 | 9.38 | Sep-79 | 9.33 | 1979.09 | 9.21 | 1979.09 | 11.43 |
| Oct-79 | 10.63 | Oct-79 | 10.47 | Oct-79 | 10.3 | 1979.1 | 9.99 | 1979.1 | 13.77 |
| Nov-79 | 10.93 | Nov-79 | 10.8 | Nov-79 | 10.65 | 1979.11 | 10.37 | 1979.11 | 13.18 |
| Dec-79 | 10.42 | Dec-79 | 10.42 | Dec-79 | 10.39 | 1979.12 | 10.18 | 1979.12 | 13.78 |
| Jan-80 | 10.74 | Jan-80 | 10.77 | Jan-80 | 10.8 | 1980.01 | 10.65 | 1980.01 | 13.82 |
| Feb-80 | 12.6 | Feb-80 | 12.53 | Feb-80 | 12.41 | 1980.02 | 12.21 | 1980.02 | 14.13 |
| Mar-80 | 13.47 | Mar-80 | 13 | Mar-80 | 12.75 | 1980.03 | 12.49 | 1980.03 | 17.19 |
| Apr-80 | 11.84 | Apr-80 | 11.49 | Apr-80 | 11.47 | 1980.04 | 11.42 | 1980.04 | 17.61 |
| May-80 | 9.95 | May-80 | 10.09 | May-80 | 10.18 | 1980.05 | 10.44 | 1980.05 | 10.98 |
| Jun-80 | 9.21 | Jun-80 | 9.45 | Jun-80 | 9.78 | 1980.06 | 9.89 | 1980.06 | 9.47 |
| Jul-80 | 9.53 | Jul-80 | 9.84 | Jul-80 | 10.25 | 1980.07 | 10.32 | 1980.07 | 9.03 |
| Aug-80 | 10.84 | Aug-80 | 10.95 | Aug-80 | 11.1 | 1980.08 | 11.07 | 1980.08 | 9.61 |
| Sep-80 | 11.62 | Sep-80 | 11.57 | Sep-80 | 11.51 | 1980.09 | 11.47 | 1980.09 | 10.87 |
| Oct-80 | 11.86 | Oct-80 | 11.79 | Oct-80 | 11.75 | 1980.1 | 11.75 | 1980.1 | 12.81 |
| Nov-80 | 12.83 | Nov-80 | 12.71 | Nov-80 | 12.68 | 1980.11 | 12.44 | 1980.11 | 15.85 |
| Dec-80 | 13.25 | Dec-80 | 13 | Dec-80 | 12.84 | 1980.12 | 12.49 | 1980.12 | 18.9 |
| Jan-81 | 12.77 | Jan-81 | 12.66 | Jan-81 | 12.57 | 1981.01 | 12.29 | 1981.01 | 19.08 |
| Feb-81 | 13.41 | Feb-81 | 13.28 | Feb-81 | 13.19 | 1981.02 | 12.98 | 1981.02 | 15.93 |
| Mar-81 | 13.41 | Mar-81 | 13.24 | Mar-81 | 13.12 | 1981.03 | 12.94 | 1981.03 | 14.7 |
| Apr-81 | 13.99 | Apr-81 | 13.85 | Apr-81 | 13.68 | 1981.04 | 13.46 | 1981.04 | 15.72 |
| May-81 | 14.63 | May-81 | 14.3 | May-81 | 14.1 | 1981.05 | 13.82 | 1981.05 | 18.52 |
| Jun-81 | 13.95 | Jun-81 | 13.67 | Jun-81 | 13.47 | 1981.06 | 13.2 | 1981.06 | 19.1 |
| Jul-81 | 14.79 | Jul-81 | 14.49 | Jul-81 | 14.28 | 1981.07 | 13.92 | 1981.07 | 19.04 |
| Aug-81 | 15.56 | Aug-81 | 15.22 | Aug-81 | 14.94 | 1981.08 | 14.52 | 1981.08 | 17.82 |
| Sep-81 | 15.93 | Sep-81 | 15.65 | Sep-81 | 15.32 | 1981.09 | 15.07 | 1981.09 | 15.87 |
| Oct-81 | 15.41 | Oct-81 | 15.33 | Oct-81 | 15.15 | 1981.1 | 15.13 | 1981.1 | 15.08 |
| Nov-81 | 13.38 | Nov-81 | 13.42 | Nov-81 | 13.39 | 1981.11 | 13.56 | 1981.11 | 13.31 |
| Dec-81 | 13.6 | Dec-81 | 13.62 | Dec-81 | 13.72 | 1981.12 | 13.73 | 1981.12 | 12.37 |
| Jan-82 | 14.65 | Jan-82 | 14.67 | Jan-82 | 14.59 | 1982.01 | 14.57 | 1982.01 | 13.22 |
| Feb-82 | 14.54 | Feb-82 | 14.46 | Feb-82 | 14.43 | 1982.02 | 14.48 | 1982.02 | 14.78 |
| Mar-82 | 13.98 | Mar-82 | 13.93 | Mar-82 | 13.86 | 1982.03 | 13.75 | 1982.03 | 14.68 |
| Apr-82 | 14 | Apr-82 | 13.94 | Apr-82 | 13.87 | 1982.04 | 13.57 | 1982.04 | 14.94 |
| May-82 | 13.75 | May-82 | 13.74 | May-82 | 13.62 | 1982.05 | 13.46 | 1982.05 | 14.45 |
| Jun-82 | 14.43 | Jun-82 | 14.47 | Jun-82 | 14.3 | 1982.06 | 14.18 | 1982.06 | 14.15 |
| Jul-82 | 14.07 | Jul-82 | 14.07 | Jul-82 | 13.95 | 1982.07 | 13.76 | 1982.07 | 12.59 |
| Aug-82 | 13 | Aug-82 | 13.14 | Aug-82 | 13.06 | 1982.08 | 12.91 | 1982.08 | 10.12 |
| Sep-82 | 12.25 | Sep-82 | 12.36 | Sep-82 | 12.34 | 1982.09 | 12.16 | 1982.09 | 10.31 |
| Oct-82 | 10.8 | Oct-82 | 10.88 | Oct-82 | 10.91 | 1982.1 | 10.97 | 1982.1 | 9.71 |
| Nov-82 | 10.38 | Nov-82 | 10.53 | Nov-82 | 10.55 | 1982.11 | 10.57 | 1982.11 | 9.2 |
| Dec-82 | 10.22 | Dec-82 | 10.49 | Dec-82 | 10.54 | 1982.12 | 10.62 | 1982.12 | 8.95 |
| Jan-83 | 10.03 | Jan-83 | 10.36 | Jan-83 | 10.46 | 1983.01 | 10.78 | 1983.01 | 8.68 |
| Feb-83 | 10.26 | Feb-83 | 10.56 | Feb-83 | 10.72 | 1983.02 | 11.03 | 1983.02 | 8.51 |
| Mar-83 | 10.08 | Mar-83 | 10.31 | Mar-83 | 10.51 | 1983.03 | 10.8 | 1983.03 | 8.77 |
| Apr-83 | 10.02 | Apr-83 | 10.29 | Apr-83 | 10.4 | 1983.04 | 10.63 | 1983.04 | 8.8 |
| May-83 | 10.03 | May-83 | 10.3 | May-83 | 10.38 | 1983.05 | 10.67 | 1983.05 | 8.63 |
| Jun-83 | 10.63 | Jun-83 | 10.83 | Jun-83 | 10.85 | 1983.06 | 11.12 | 1983.06 | 8.98 |
| Jul-83 | 11.21 | Jul-83 | 11.35 | Jul-83 | 11.38 | 1983.07 | 11.59 | 1983.07 | 9.37 |
| Aug-83 | 11.63 | Aug-83 | 11.77 | Aug-83 | 11.85 | 1983.08 | 11.96 | 1983.08 | 9.56 |
| Sep-83 | 11.43 | Sep-83 | 11.61 | Sep-83 | 11.65 | 1983.09 | 11.82 | 1983.09 | 9.45 |
| Oct-83 | 11.28 | Oct-83 | 11.47 | Oct-83 | 11.54 | 1983.1 | 11.77 | 1983.1 | 9.48 |
| Nov-83 | 11.41 | Nov-83 | 11.61 | Nov-83 | 11.69 | 1983.11 | 11.92 | 1983.11 | 9.34 |
| Dec-83 | 11.54 | Dec-83 | 11.78 | Dec-83 | 11.83 | 1983.12 | 12.02 | 1983.12 | 9.47 |
| Jan-84 | 11.37 | Jan-84 | 11.58 | Jan-84 | 11.67 | 1984.01 | 11.82 | 1984.01 | 9.56 |
| Feb-84 | 11.54 | Feb-84 | 11.75 | Feb-84 | 11.84 | 1984.02 | 12 | 1984.02 | 9.59 |
| Mar-84 | 12.02 | Mar-84 | 12.25 | Mar-84 | 12.32 | 1984.03 | 12.45 | 1984.03 | 9.91 |
| Apr-84 | 12.37 | Apr-84 | 12.56 | Apr-84 | 12.63 | 1984.04 | 12.65 | 1984.04 | 10.29 |
| May-84 | 13.17 | May-84 | 13.34 | May-84 | 13.41 | 1984.05 | 13.43 | 1984.05 | 10.32 |
| Jun-84 | 13.48 | Jun-84 | 13.56 | Jun-84 | 13.56 | 1984.06 | 13.54 | 1984.06 | 11.06 |
| Jul-84 | 13.27 | Jul-84 | 13.35 | Jul-84 | 13.36 | 1984.07 | 13.36 | 1984.07 | 11.23 |
| Aug-84 | 12.68 | Aug-84 | 12.75 | Aug-84 | 12.72 | 1984.08 | 12.71 | 1984.08 | 11.64 |
| Sep-84 | 12.53 | Sep-84 | 12.6 | Sep-84 | 12.52 | 1984.09 | 12.42 | 1984.09 | 11.3 |
| Oct-84 | 12.06 | Oct-84 | 12.16 | Oct-84 | 12.16 | 1984.1 | 12.04 | 1984.1 | 9.99 |
| Nov-84 | 11.33 | Nov-84 | 11.49 | Nov-84 | 11.57 | 1984.11 | 11.66 | 1984.11 | 9.43 |
| Dec-84 | 11.07 | Dec-84 | 11.45 | Dec-84 | 11.5 | 1984.12 | 11.64 | 1984.12 | 8.38 |
| Jan-85 | 10.93 | Jan-85 | 11.27 | Jan-85 | 11.38 | 1985.01 | 11.58 | 1985.01 | 8.35 |
| Feb-85 | 11.13 | Feb-85 | 11.44 | Feb-85 | 11.51 | 1985.02 | 11.7 | 1985.02 | 8.5 |
| Mar-85 | 11.52 | Mar-85 | 11.82 | Mar-85 | 11.86 | 1985.03 | 12.06 | 1985.03 | 8.58 |
| Apr-85 | 11.01 | Apr-85 | 11.34 | Apr-85 | 11.43 | 1985.04 | 11.69 | 1985.04 | 8.27 |
| May-85 | 10.34 | May-85 | 10.72 | May-85 | 10.85 | 1985.05 | 11.19 | 1985.05 | 7.97 |
| Jun-85 | 9.6 | Jun-85 | 10.08 | Jun-85 | 10.16 | 1985.06 | 10.57 | 1985.06 | 7.53 |
| Jul-85 | 9.7 | Jul-85 | 10.16 | Jul-85 | 10.31 | 1985.07 | 10.68 | 1985.07 | 7.88 |
| Aug-85 | 9.81 | Aug-85 | 10.2 | Aug-85 | 10.33 | 1985.08 | 10.73 | 1985.08 | 7.9 |
| Sep-85 | 9.81 | Sep-85 | 10.24 | Sep-85 | 10.37 | 1985.09 | 10.8 | 1985.09 | 7.92 |
| Oct-85 | 9.69 | Oct-85 | 10.11 | Oct-85 | 10.24 | 1985.1 | 10.67 | 1985.1 | 7.99 |
| Nov-85 | 9.28 | Nov-85 | 9.62 | Nov-85 | 9.78 | 1985.11 | 10.24 | 1985.11 | 8.05 |
| Dec-85 | 8.73 | Dec-85 | 9.11 | Dec-85 | 9.26 | 1985.12 | 9.75 | 1985.12 | 8.27 |
| Jan-86 | 8.68 | Jan-86 | 9.03 | Jan-86 | 9.19 | 1986.01 | 9.59 | 1986.01 | 8.14 |
| Feb-86 | 8.34 | Feb-86 | 8.58 | Feb-86 | 8.7 | 1986.02 | 9.08 | 1986.02 | 7.86 |
| Mar-86 | 7.46 | Mar-86 | 7.67 | Mar-86 | 7.78 | 1986.03 | 8.09 | 1986.03 | 7.48 |
| Apr-86 | 7.05 | Apr-86 | 7.16 | Apr-86 | 7.3 | 1986.04 | 7.5 | 1986.04 | 6.99 |
| May-86 | 7.52 | May-86 | 7.65 | May-86 | 7.71 | 1986.05 | 7.81 | 1986.05 | 6.85 |
| Jun-86 | 7.64 | Jun-86 | 7.75 | Jun-86 | 7.8 | 1986.06 | 7.69 | 1986.06 | 6.92 |
| Jul-86 | 7.06 | Jul-86 | 7.22 | Jul-86 | 7.3 | 1986.07 | 7.29 | 1986.07 | 6.56 |
| Aug-86 | 6.8 | Aug-86 | 7.01 | Aug-86 | 7.17 | 1986.08 | 7.28 | 1986.08 | 6.17 |
| Sep-86 | 6.92 | Sep-86 | 7.28 | Sep-86 | 7.45 | 1986.09 | 7.56 | 1986.09 | 5.89 |
| Oct-86 | 6.83 | Oct-86 | 7.24 | Oct-86 | 7.43 | 1986.1 | 7.61 | 1986.1 | 5.85 |
| Nov-86 | 6.76 | Nov-86 | 7.08 | Nov-86 | 7.25 | 1986.11 | 7.42 | 1986.11 | 6.04 |
| Dec-86 | 6.67 | Dec-86 | 6.97 | Dec-86 | 7.11 | 1986.12 | 7.28 | 1986.12 | 6.91 |
| Jan-87 | 6.64 | Jan-87 | 6.92 | Jan-87 | 7.08 | 1987.01 | | 1987.01 | 6.43 |
| Feb-87 | 6.79 | Feb-87 | 7.06 | Feb-87 | 7.25 | 1987.02 | | 1987.02 | 6.1 |
| Mar-87 | 6.79 | Mar-87 | 7.06 | Mar-87 | 7.25 | 1987.03 | | 1987.03 | 6.13 |
| Apr-87 | 7.57 | Apr-87 | 7.83 | Apr-87 | 8.02 | 1987.04 | | 1987.04 | 6.37 |
| May-87 | 8.26 | May-87 | 8.47 | May-87 | 8.61 | 1987.05 | | 1987.05 | 6.85 |
| Jun-87 | 8.02 | Jun-87 | 8.27 | Jun-87 | 8.4 | 1987.06 | | 1987.06 | 6.73 |
| Jul-87 | 8.01 | Jul-87 | 8.27 | Jul-87 | 8.45 | 1987.07 | | 1987.07 | 6.58 |
| Aug-87 | 8.32 | Aug-87 | 8.59 | Aug-87 | 8.76 | 1987.08 | | 1987.08 | 6.73 |
| Sep-87 | 8.94 | Sep-87 | 9.26 | Sep-87 | 9.42 | 1987.09 | | 1987.09 | 7.22 |
| Oct-87 | 9.08 | Oct-87 | 9.37 | Oct-87 | 9.52 | 1987.1 | | 1987.1 | 7.29 |
| Nov-87 | 8.35 | Nov-87 | 8.69 | Nov-87 | 8.86 | 1987.11 | | 1987.11 | 6.69 |
| Dec-87 | 8.45 | Dec-87 | 8.82 | Dec-87 | 8.99 | 1987.12 | | 1987.12 | 6.77 |
| Jan-88 | 8.18 | Jan-88 | 8.48 | Jan-88 | 8.67 | 1988.01 | | 1988.01 | 6.83 |
| Feb-88 | 7.71 | Feb-88 | 8.02 | Feb-88 | 8.21 | 1988.02 | | 1988.02 | 6.58 |
| Mar-88 | 7.83 | Mar-88 | 8.19 | Mar-88 | 8.37 | 1988.03 | | 1988.03 | 6.58 |
| Apr-88 | 8.19 | Apr-88 | 8.52 | Apr-88 | 8.72 | 1988.04 | | 1988.04 | 6.87 |
| May-88 | 8.58 | May-88 | 8.89 | May-88 | 9.09 | 1988.05 | | 1988.05 | 7.09 |
| Jun-88 | 8.49 | Jun-88 | 8.78 | Jun-88 | 8.92 | 1988.06 | | 1988.06 | 7.51 |
| Jul-88 | 8.66 | Jul-88 | 8.91 | Jul-88 | 9.06 | 1988.07 | | 1988.07 | 7.75 |
| Aug-88 | 8.94 | Aug-88 | 9.13 | Aug-88 | 9.26 | 1988.08 | | 1988.08 | 8.01 |
| Sep-88 | 8.69 | Sep-88 | 8.87 | Sep-88 | 8.98 | 1988.09 | | 1988.09 | 8.19 |
| Oct-88 | 8.51 | Oct-88 | 8.69 | Oct-88 | 8.8 | 1988.1 | | 1988.1 | 8.3 |
| Nov-88 | 8.79 | Nov-88 | 8.89 | Nov-88 | 8.96 | 1988.11 | | 1988.11 | 8.35 |
| Dec-88 | 9.09 | Dec-88 | 9.13 | Dec-88 | 9.11 | 1988.12 | | 1988.12 | 8.76 |
| Jan-89 | 9.15 | Jan-89 | 9.14 | Jan-89 | 9.09 | 1989.01 | | 1989.01 | 9.12 |
| Feb-89 | 9.27 | Feb-89 | 9.23 | Feb-89 | 9.17 | 1989.02 | | 1989.02 | 9.36 |
| Mar-89 | 9.51 | Mar-89 | 9.43 | Mar-89 | 9.36 | 1989.03 | | 1989.03 | 9.85 |
| Apr-89 | 9.3 | Apr-89 | 9.24 | Apr-89 | 9.18 | 1989.04 | | 1989.04 | 9.84 |
| May-89 | 8.91 | May-89 | 8.88 | May-89 | 8.86 | 1989.05 | | 1989.05 | 9.81 |
| Jun-89 | 8.29 | Jun-89 | 8.31 | Jun-89 | 8.28 | 1989.06 | | 1989.06 | 9.53 |
| Jul-89 | 7.83 | Jul-89 | 7.94 | Jul-89 | 8.02 | 1989.07 | | 1989.07 | 9.24 |
| Aug-89 | 8.09 | Aug-89 | 8.11 | Aug-89 | 8.11 | 1989.08 | | 1989.08 | 8.99 |
| Sep-89 | 8.17 | Sep-89 | 8.23 | Sep-89 | 8.19 | 1989.09 | | 1989.09 | 9.02 |
| Oct-89 | 7.97 | Oct-89 | 8.03 | Oct-89 | 8.01 | 1989.1 | | 1989.1 | 8.84 |
| Nov-89 | 7.81 | Nov-89 | 7.86 | Nov-89 | 7.87 | 1989.11 | | 1989.11 | 8.55 |
| Dec-89 | 7.75 | Dec-89 | 7.85 | Dec-89 | 7.84 | 1989.12 | | 1989.12 | 8.45 |
| Jan-90 | 8.12 | Jan-90 | 8.2 | Jan-90 | 8.21 | 1990.01 | | 1990.01 | 8.23 |
| Feb-90 | 8.42 | Feb-90 | 8.48 | Feb-90 | 8.47 | 1990.02 | | 1990.02 | 8.24 |
| Mar-90 | 8.6 | Mar-90 | 8.65 | Mar-90 | 8.59 | 1990.03 | | 1990.03 | 8.28 |
| Apr-90 | 8.77 | Apr-90 | 8.81 | Apr-90 | 8.79 | 1990.04 | | 1990.04 | 8.26 |
| May-90 | 8.74 | May-90 | 8.78 | May-90 | 8.76 | 1990.05 | | 1990.05 | 8.18 |
| Jun-90 | 8.43 | Jun-90 | 8.52 | Jun-90 | 8.48 | 1990.06 | | 1990.06 | 8.29 |
| Jul-90 | 8.33 | Jul-90 | 8.46 | Jul-90 | 8.47 | 1990.07 | | 1990.07 | 8.15 |
| Aug-90 | 8.44 | Aug-90 | 8.64 | Aug-90 | 8.75 | 1990.08 | | 1990.08 | 8.13 |
| Sep-90 | 8.51 | Sep-90 | 8.79 | Sep-90 | 8.89 | 1990.09 | | 1990.09 | 8.2 |
| Oct-90 | 8.33 | Oct-90 | 8.59 | Oct-90 | 8.72 | 1990.1 | | 1990.1 | 8.11 |
| Nov-90 | 8.02 | Nov-90 | 8.28 | Nov-90 | 8.39 | 1990.11 | | 1990.11 | 7.81 |
| Dec-90 | 7.73 | Dec-90 | 8 | Dec-90 | 8.08 | 1990.12 | | 1990.12 | 7.31 |
| Jan-91 | 7.7 | Jan-91 | 7.97 | Jan-91 | 8.09 | 1991.01 | | 1991.01 | 6.91 |
| Feb-91 | 7.47 | Feb-91 | 7.73 | Feb-91 | 7.85 | 1991.02 | | 1991.02 | 6.25 |
| Mar-91 | 7.77 | Mar-91 | 8 | Mar-91 | 8.11 | 1991.03 | | 1991.03 | 6.12 |
| Apr-91 | 7.7 | Apr-91 | 7.92 | Apr-91 | 8.04 | 1991.04 | | 1991.04 | 5.91 |
| May-91 | 7.7 | May-91 | 7.94 | May-91 | 8.07 | 1991.05 | | 1991.05 | 5.78 |
| Jun-91 | 7.94 | Jun-91 | 8.17 | Jun-91 | 8.28 | 1991.06 | | 1991.06 | 5.9 |
| Jul-91 | 7.91 | Jul-91 | 8.15 | Jul-91 | 8.27 | 1991.07 | | 1991.07 | 5.82 |
| Aug-91 | 7.43 | Aug-91 | 7.74 | Aug-91 | 7.9 | 1991.08 | | 1991.08 | 5.66 |
| Sep-91 | 7.14 | Sep-91 | 7.48 | Sep-91 | 7.65 | 1991.09 | | 1991.09 | 5.45 |
| Oct-91 | 6.87 | Oct-91 | 7.25 | Oct-91 | 7.53 | 1991.1 | | 1991.1 | 5.21 |
| Nov-91 | 6.62 | Nov-91 | 7.06 | Nov-91 | 7.42 | 1991.11 | | 1991.11 | 4.81 |
| Dec-91 | 6.19 | Dec-91 | 6.69 | Dec-91 | 7.09 | 1991.12 | | 1991.12 | 4.43 |
| Jan-92 | 6.24 | Jan-92 | 6.7 | Jan-92 | 7.03 | 1992.01 | | 1992.01 | 4.03 |
| Feb-92 | 6.58 | Feb-92 | 6.96 | Feb-92 | 7.34 | 1992.02 | | 1992.02 | 4.06 |
| Mar-92 | 6.95 | Mar-92 | 7.26 | Mar-92 | 7.54 | 1992.03 | | 1992.03 | 3.98 |
| Apr-92 | 6.78 | Apr-92 | 7.15 | Apr-92 | 7.48 | 1992.04 | | 1992.04 | 3.73 |
| May-92 | 6.69 | May-92 | 7.06 | May-92 | 7.39 | 1992.05 | | 1992.05 | 3.82 |
| Jun-92 | 6.48 | Jun-92 | 6.9 | Jun-92 | 7.26 | 1992.06 | | 1992.06 | 3.76 |
| Jul-92 | 5.84 | Jul-92 | 6.36 | Jul-92 | 6.84 | 1992.07 | | 1992.07 | 3.25 |
| Aug-92 | 5.6 | Aug-92 | 6.12 | Aug-92 | 6.59 | 1992.08 | | 1992.08 | 3.3 |
| Sep-92 | 5.38 | Sep-92 | 5.96 | Sep-92 | 6.42 | 1992.09 | | 1992.09 | 3.22 |
| Oct-92 | 5.6 | Oct-92 | 6.15 | Oct-92 | 6.59 | 1992.1 | | 1992.1 | 3.1 |
| Nov-92 | 6.04 | Nov-92 | 6.49 | Nov-92 | 6.87 | 1992.11 | | 1992.11 | 3.09 |
| Dec-92 | 6.08 | Dec-92 | 6.46 | Dec-92 | 6.77 | 1992.12 | | 1992.12 | 2.92 |
| Jan-93 | 5.83 | Jan-93 | 6.26 | Jan-93 | 6.6 | 1993.01 | | 1993.01 | 3.02 |
| Feb-93 | 5.43 | Feb-93 | 5.87 | Feb-93 | 6.26 | 1993.02 | | 1993.02 | 3.03 |
| Mar-93 | 5.19 | Mar-93 | 5.66 | Mar-93 | 5.98 | 1993.03 | | 1993.03 | 3.07 |
| Apr-93 | 5.13 | Apr-93 | 5.59 | Apr-93 | 5.97 | 1993.04 | | 1993.04 | 2.96 |
| May-93 | 5.2 | May-93 | 5.66 | May-93 | 6.04 | 1993.05 | | 1993.05 | 3 |
| Jun-93 | 5.22 | Jun-93 | 5.61 | Jun-93 | 5.96 | 1993.06 | | 1993.06 | 3.04 |
| Jul-93 | 5.09 | Jul-93 | 5.48 | Jul-93 | 5.81 | 1993.07 | | 1993.07 | 3.06 |
| Aug-93 | 5.03 | Aug-93 | 5.35 | Aug-93 | 5.68 | 1993.08 | | 1993.08 | 3.03 |
| Sep-93 | 4.73 | Sep-93 | 5.08 | Sep-93 | 5.36 | 1993.09 | | 1993.09 | 3.09 |
| Oct-93 | 4.71 | Oct-93 | 5.05 | Oct-93 | 5.33 | 1993.1 | 6.07 | 1993.1 | 2.99 |
| Nov-93 | 5.06 | Nov-93 | 5.45 | Nov-93 | 5.72 | 1993.11 | 6.38 | 1993.11 | 3.02 |
| Dec-93 | 5.15 | Dec-93 | 5.48 | Dec-93 | 5.77 | 1993.12 | 6.4 | 1993.12 | 2.96 |
| Jan-94 | 5.09 | Jan-94 | 5.43 | Jan-94 | 5.75 | 1994.01 | 6.39 | 1994.01 | 3.05 |
| Feb-94 | 5.4 | Feb-94 | 5.72 | Feb-94 | 5.97 | 1994.02 | 6.57 | 1994.02 | 3.25 |
| Mar-94 | 5.94 | Mar-94 | 6.28 | Mar-94 | 6.48 | 1994.03 | 7 | 1994.03 | 3.34 |
| Apr-94 | 6.52 | Apr-94 | 6.8 | Apr-94 | 6.97 | 1994.04 | 7.4 | 1994.04 | 3.56 |
| May-94 | 6.78 | May-94 | 7.01 | May-94 | 7.18 | 1994.05 | 7.54 | 1994.05 | 4.01 |
| Jun-94 | 6.7 | Jun-94 | 6.91 | Jun-94 | 7.1 | 1994.06 | 7.51 | 1994.06 | 4.25 |
| Jul-94 | 6.91 | Jul-94 | 7.12 | Jul-94 | 7.3 | 1994.07 | 7.67 | 1994.07 | 4.26 |
| Aug-94 | 6.88 | Aug-94 | 7.06 | Aug-94 | 7.24 | 1994.08 | 7.62 | 1994.08 | 4.47 |
| Sep-94 | 7.08 | Sep-94 | 7.28 | Sep-94 | 7.46 | 1994.09 | 7.87 | 1994.09 | 4.73 |
| Oct-94 | 7.4 | Oct-94 | 7.58 | Oct-94 | 7.74 | 1994.1 | 8.08 | 1994.1 | 4.76 |
| Nov-94 | 7.72 | Nov-94 | 7.83 | Nov-94 | 7.96 | 1994.11 | 8.2 | 1994.11 | 5.29 |
| Dec-94 | 7.78 | Dec-94 | 7.8 | Dec-94 | 7.81 | 1994.12 | 7.99 | 1994.12 | 5.45 |
| Jan-95 | 7.76 | Jan-95 | 7.79 | Jan-95 | 7.78 | 1995.01 | 7.97 | 1995.01 | 5.53 |
| Feb-95 | 7.37 | Feb-95 | 7.44 | Feb-95 | 7.47 | 1995.02 | 7.73 | 1995.02 | 5.92 |
| Mar-95 | 7.05 | Mar-95 | 7.14 | Mar-95 | 7.2 | 1995.03 | 7.57 | 1995.03 | 5.98 |
| Apr-95 | 6.86 | Apr-95 | 6.95 | Apr-95 | 7.06 | 1995.04 | 7.45 | 1995.04 | 6.05 |
| May-95 | 6.41 | May-95 | 6.5 | May-95 | 6.63 | 1995.05 | 7.01 | 1995.05 | 6.01 |
| Jun-95 | 5.93 | Jun-95 | 6.05 | Jun-95 | 6.17 | 1995.06 | 6.59 | 1995.06 | 6 |
| Jul-95 | 6.01 | Jul-95 | 6.2 | Jul-95 | 6.28 | 1995.07 | 6.74 | 1995.07 | 5.85 |
| Aug-95 | 6.24 | Aug-95 | 6.41 | Aug-95 | 6.49 | 1995.08 | 6.92 | 1995.08 | 5.74 |
| Sep-95 | 6 | Sep-95 | 6.13 | Sep-95 | 6.2 | 1995.09 | 6.65 | 1995.09 | 5.8 |
| Oct-95 | 5.86 | Oct-95 | 5.97 | Oct-95 | 6.04 | 1995.1 | 6.45 | 1995.1 | 5.76 |
| Nov-95 | 5.69 | Nov-95 | 5.83 | Nov-95 | 5.93 | 1995.11 | 6.33 | 1995.11 | 5.8 |
| Dec-95 | 5.51 | Dec-95 | 5.63 | Dec-95 | 5.71 | 1995.12 | 6.12 | 1995.12 | 5.6 |
| Jan-96 | 5.36 | Jan-96 | 5.54 | Jan-96 | 5.65 | 1996.01 | 6.11 | 1996.01 | 5.56 |
| Feb-96 | 5.38 | Feb-96 | 5.64 | Feb-96 | 5.81 | 1996.02 | 6.3 | 1996.02 | 5.22 |
| Mar-96 | 5.97 | Mar-96 | 6.19 | Mar-96 | 6.27 | 1996.03 | 6.74 | 1996.03 | 5.31 |
| Apr-96 | 6.3 | Apr-96 | 6.48 | Apr-96 | 6.51 | 1996.04 | 6.98 | 1996.04 | 5.22 |
| May-96 | 6.48 | May-96 | 6.66 | May-96 | 6.74 | 1996.05 | 7.11 | 1996.05 | 5.24 |
| Jun-96 | 6.69 | Jun-96 | 6.83 | Jun-96 | 6.91 | 1996.06 | 7.22 | 1996.06 | 5.27 |
| Jul-96 | 6.64 | Jul-96 | 6.76 | Jul-96 | 6.87 | 1996.07 | 7.14 | 1996.07 | 5.4 |
| Aug-96 | 6.39 | Aug-96 | 6.52 | Aug-96 | 6.64 | 1996.08 | 6.97 | 1996.08 | 5.22 |
| Sep-96 | 6.6 | Sep-96 | 6.73 | Sep-96 | 6.83 | 1996.09 | 7.17 | 1996.09 | 5.3 |
| Oct-96 | 6.27 | Oct-96 | 6.42 | Oct-96 | 6.53 | 1996.1 | 6.9 | 1996.1 | 5.24 |
| Nov-96 | 5.97 | Nov-96 | 6.1 | Nov-96 | 6.2 | 1996.11 | 6.58 | 1996.11 | 5.31 |
| Dec-96 | 6.07 | Dec-96 | 6.2 | Dec-96 | 6.3 | 1996.12 | 6.65 | 1996.12 | 5.29 |
| Jan-97 | 6.33 | Jan-97 | 6.47 | Jan-97 | 6.58 | 1997.01 | 6.91 | 1997.01 | 5.25 |
| Feb-97 | 6.2 | Feb-97 | 6.32 | Feb-97 | 6.42 | 1997.02 | 6.77 | 1997.02 | 5.19 |
| Mar-97 | 6.54 | Mar-97 | 6.65 | Mar-97 | 6.69 | 1997.03 | 7.05 | 1997.03 | 5.39 |
| Apr-97 | 6.76 | Apr-97 | 6.86 | Apr-97 | 6.89 | 1997.04 | 7.2 | 1997.04 | 5.51 |
| May-97 | 6.57 | May-97 | 6.66 | May-97 | 6.71 | 1997.05 | 7.02 | 1997.05 | 5.5 |
| Jun-97 | 6.38 | Jun-97 | 6.46 | Jun-97 | 6.49 | 1997.06 | 6.84 | 1997.06 | 5.56 |
| Jul-97 | 6.12 | Jul-97 | 6.2 | Jul-97 | 6.22 | 1997.07 | 6.56 | 1997.07 | 5.52 |
| Aug-97 | 6.16 | Aug-97 | 6.29 | Aug-97 | 6.3 | 1997.08 | 6.65 | 1997.08 | 5.54 |
| Sep-97 | 6.11 | Sep-97 | 6.2 | Sep-97 | 6.21 | 1997.09 | 6.56 | 1997.09 | 5.54 |
| Oct-97 | 5.93 | Oct-97 | 6.05 | Oct-97 | 6.03 | 1997.1 | 6.38 | 1997.1 | 5.5 |
| Nov-97 | 5.8 | Nov-97 | 5.9 | Nov-97 | 5.88 | 1997.11 | 6.2 | 1997.11 | 5.52 |
| Dec-97 | 5.77 | Dec-97 | 5.83 | Dec-97 | 5.81 | 1997.12 | 6.07 | 1997.12 | 5.5 |
| Jan-98 | 5.42 | Jan-98 | 5.53 | Jan-98 | 5.54 | 1998.01 | 5.88 | 1998.01 | 5.56 |
| Feb-98 | 5.49 | Feb-98 | 5.6 | Feb-98 | 5.57 | 1998.02 | 5.96 | 1998.02 | 5.51 |
| Mar-98 | 5.61 | Mar-98 | 5.71 | Mar-98 | 5.65 | 1998.03 | 6.01 | 1998.03 | 5.49 |
| Apr-98 | 5.61 | Apr-98 | 5.7 | Apr-98 | 5.64 | 1998.04 | 6 | 1998.04 | 5.45 |
| May-98 | 5.63 | May-98 | 5.72 | May-98 | 5.65 | 1998.05 | 6.01 | 1998.05 | 5.49 |
| Jun-98 | 5.52 | Jun-98 | 5.56 | Jun-98 | 5.5 | 1998.06 | 5.8 | 1998.06 | 5.56 |
| Jul-98 | 5.46 | Jul-98 | 5.52 | Jul-98 | 5.46 | 1998.07 | 5.78 | 1998.07 | 5.54 |
| Aug-98 | 5.27 | Aug-98 | 5.36 | Aug-98 | 5.34 | 1998.08 | 5.66 | 1998.08 | 5.55 |
| Sep-98 | 4.62 | Sep-98 | 4.76 | Sep-98 | 4.81 | 1998.09 | 5.38 | 1998.09 | 5.51 |
| Oct-98 | 4.18 | Oct-98 | 4.46 | Oct-98 | 4.53 | 1998.1 | 5.3 | 1998.1 | 5.07 |
| Nov-98 | 4.54 | Nov-98 | 4.78 | Nov-98 | 4.83 | 1998.11 | 5.48 | 1998.11 | 4.83 |
| Dec-98 | 4.45 | Dec-98 | 4.65 | Dec-98 | 4.65 | 1998.12 | 5.36 | 1998.12 | 4.68 |
| Jan-99 | 4.6 | Jan-99 | 4.8 | Jan-99 | 4.72 | 1999.01 | 5.45 | 1999.01 | 4.63 |
| Feb-99 | 4.91 | Feb-99 | 5.1 | Feb-99 | 5 | 1999.02 | 5.66 | 1999.02 | 4.76 |
| Mar-99 | 5.14 | Mar-99 | 5.36 | Mar-99 | 5.23 | 1999.03 | 5.87 | 1999.03 | 4.81 |
| Apr-99 | 5.08 | Apr-99 | 5.28 | Apr-99 | 5.18 | 1999.04 | 5.82 | 1999.04 | 4.74 |
| May-99 | 5.44 | May-99 | 5.64 | May-99 | 5.54 | 1999.05 | 6.08 | 1999.05 | 4.74 |
| Jun-99 | 5.81 | Jun-99 | 6.05 | Jun-99 | 5.9 | 1999.06 | 6.36 | 1999.06 | 4.76 |
| Jul-99 | 5.68 | Jul-99 | 5.94 | Jul-99 | 5.79 | 1999.07 | 6.28 | 1999.07 | 4.99 |
| Aug-99 | 5.84 | Aug-99 | 6.15 | Aug-99 | 5.94 | 1999.08 | 6.43 | 1999.08 | 5.07 |
| Sep-99 | 5.8 | Sep-99 | 6.12 | Sep-99 | 5.92 | 1999.09 | 6.5 | 1999.09 | 5.22 |
| Oct-99 | 6.03 | Oct-99 | 6.33 | Oct-99 | 6.11 | 1999.1 | 6.66 | 1999.1 | 5.2 |
| Nov-99 | 5.97 | Nov-99 | 6.17 | Nov-99 | 6.03 | 1999.11 | 6.48 | 1999.11 | 5.42 |
| Dec-99 | 6.19 | Dec-99 | 6.38 | Dec-99 | 6.28 | 1999.12 | 6.69 | 1999.12 | 5.3 |
| Jan-00 | 6.58 | Jan-00 | 6.7 | Jan-00 | 6.66 | 2000.01 | 6.86 | 2000.01 | 5.45 |
| Feb-00 | 6.68 | Feb-00 | 6.72 | Feb-00 | 6.52 | 2000.02 | 6.54 | 2000.02 | 5.73 |
| Mar-00 | 6.5 | Mar-00 | 6.51 | Mar-00 | 6.26 | 2000.03 | 6.38 | 2000.03 | 5.85 |
| Apr-00 | 6.26 | Apr-00 | 6.27 | Apr-00 | 5.99 | 2000.04 | 6.18 | 2000.04 | 6.02 |
| May-00 | 6.69 | May-00 | 6.69 | May-00 | 6.44 | 2000.05 | 6.55 | 2000.05 | 6.27 |
| Jun-00 | 6.3 | Jun-00 | 6.33 | Jun-00 | 6.1 | 2000.06 | 6.28 | 2000.06 | 6.53 |
| Jul-00 | 6.18 | Jul-00 | 6.22 | Jul-00 | 6.05 | 2000.07 | 6.2 | 2000.07 | 6.54 |
| Aug-00 | 6.06 | Aug-00 | 6.05 | Aug-00 | 5.83 | 2000.08 | 6.02 | 2000.08 | 6.5 |
| Sep-00 | 5.93 | Sep-00 | 5.98 | Sep-00 | 5.8 | 2000.09 | 6.09 | 2000.09 | 6.52 |
| Oct-00 | 5.78 | Oct-00 | 5.84 | Oct-00 | 5.74 | 2000.1 | 6.04 | 2000.1 | 6.51 |
| Nov-00 | 5.7 | Nov-00 | 5.78 | Nov-00 | 5.72 | 2000.11 | 5.98 | 2000.11 | 6.51 |
| Dec-00 | 5.17 | Dec-00 | 5.28 | Dec-00 | 5.24 | 2000.12 | 5.64 | 2000.12 | 6.4 |
| Jan-01 | 4.86 | Jan-01 | 5.13 | Jan-01 | 5.16 | 2001.01 | 5.65 | 2001.01 | 5.98 |
| Feb-01 | 4.89 | Feb-01 | 5.1 | Feb-01 | 5.1 | 2001.02 | 5.62 | 2001.02 | 5.49 |
| Mar-01 | 4.64 | Mar-01 | 4.88 | Mar-01 | 4.89 | 2001.03 | 5.49 | 2001.03 | 5.31 |
| Apr-01 | 4.76 | Apr-01 | 5.03 | Apr-01 | 5.14 | 2001.04 | 5.78 | 2001.04 | 4.8 |
| May-01 | 4.93 | May-01 | 5.24 | May-01 | 5.39 | 2001.05 | 5.92 | 2001.05 | 4.21 |
| Jun-01 | 4.81 | Jun-01 | 5.14 | Jun-01 | 5.28 | 2001.06 | 5.82 | 2001.06 | 3.97 |
| Jul-01 | 4.76 | Jul-01 | 5.06 | Jul-01 | 5.24 | 2001.07 | 5.75 | 2001.07 | 3.77 |
| Aug-01 | 4.57 | Aug-01 | 4.84 | Aug-01 | 4.97 | 2001.08 | 5.58 | 2001.08 | 3.65 |
| Sep-01 | 4.12 | Sep-01 | 4.51 | Sep-01 | 4.73 | 2001.09 | 5.53 | 2001.09 | 3.07 |
| Oct-01 | 3.91 | Oct-01 | 4.31 | Oct-01 | 4.57 | 2001.1 | 5.34 | 2001.1 | 2.49 |
| Nov-01 | 3.97 | Nov-01 | 4.42 | Nov-01 | 4.65 | 2001.11 | 5.33 | 2001.11 | 2.09 |
| Dec-01 | 4.39 | Dec-01 | 4.86 | Dec-01 | 5.09 | 2001.12 | 5.76 | 2001.12 | 1.82 |
| Jan-02 | 4.34 | Jan-02 | 4.79 | Jan-02 | 5.04 | 2002.01 | 5.69 | 2002.01 | 1.73 |
| Feb-02 | 4.3 | Feb-02 | 4.71 | Feb-02 | 4.91 | 2002.02 | 5.61 | 2002.02 | 1.74 |
| Mar-02 | 4.74 | Mar-02 | 5.14 | Mar-02 | 5.28 | 2002.03 | 5.93 | 2002.03 | 1.73 |
| Apr-02 | 4.65 | Apr-02 | 5.02 | Apr-02 | 5.21 | 2002.04 | 5.85 | 2002.04 | 1.75 |
| May-02 | 4.49 | May-02 | 4.9 | May-02 | 5.16 | 2002.05 | 5.81 | 2002.05 | 1.75 |
| Jun-02 | 4.19 | Jun-02 | 4.6 | Jun-02 | 4.93 | 2002.06 | 5.65 | 2002.06 | 1.75 |
| Jul-02 | 3.81 | Jul-02 | 4.3 | Jul-02 | 4.65 | 2002.07 | 5.51 | 2002.07 | 1.73 |
| Aug-02 | 3.29 | Aug-02 | 3.88 | Aug-02 | 4.26 | 2002.08 | 5.19 | 2002.08 | 1.74 |
| Sep-02 | 2.94 | Sep-02 | 3.5 | Sep-02 | 3.87 | 2002.09 | 4.87 | 2002.09 | 1.75 |
| Oct-02 | 2.95 | Oct-02 | 3.54 | Oct-02 | 3.94 | 2002.1 | 5 | 2002.1 | 1.75 |
| Nov-02 | 3.05 | Nov-02 | 3.64 | Nov-02 | 4.05 | 2002.11 | 5.04 | 2002.11 | 1.34 |
| Dec-02 | 3.03 | Dec-02 | 3.63 | Dec-02 | 4.03 | 2002.12 | 5.01 | 2002.12 | 1.24 |
| Jan-03 | 3.05 | Jan-03 | 3.6 | Jan-03 | 4.05 | 2003.01 | 5.02 | 2003.01 | 1.24 |
| Feb-03 | 2.9 | Feb-03 | 3.45 | Feb-03 | 3.9 | 2003.02 | 4.87 | 2003.02 | 1.26 |
| Mar-03 | 2.78 | Mar-03 | 3.34 | Mar-03 | 3.81 | 2003.03 | 4.82 | 2003.03 | 1.25 |

What is claimed is:

1 An index of returns on treasury instruments comprising:
a level of longer-term market interest rates;
a shape of a yield curve; and
a level of short-term financing rates.

2 The index of claim 1 further wherein the Treasury instruments have maturities of 5 years and longer.

3 The index of claim 1 further wherein the Treasury instruments are Treasury 5-year notes, Treasury 10-year notes, and bond contracts.

4 The index of claim 1 further wherein the Treasury instruments are assigned duration weights.

5 The index of claim 4 further wherein the duration weights are adjusted quarterly.

6 The index of claim 4 further wherein the duration weights are such that each index component makes an approximately equal contribution to index volatility.

7 The index of claim 1 further wherein the Treasury instruments are chain-linked to maintain consistency over time.

8 The index of claim 7 further wherein the chain-linked Treasury instruments are utilized as measuring instruments.

9 The index of claim 7 further wherein the chain-linked Treasury instruments are utilized as building blocks.

10 The index of claim 7 further wherein the index is chain linked quarterly.

11 The index of claim 1 further wherein Treasury instruments are strung together into a time-series by incorporating past information into the index.

12 The index of claim 1 further wherein calendar spreads are added to, and current front-month Treasury instruments are substituted for, expiring Treasury instruments.

13 The index of claim 1 further wherein:
IVₜ=(DWABPₜ)+ACₜ,
where IV is the index value at time t, DWABP is the duration-weighted average price at time t, and AC is accumulated net carry at time t.

14 The index of claim 13 further wherein DWABP is of nearby 5-year, 10-year and bond futures contracts.

15 The index of claim 13 further wherein AC is rebalanced quarterly.

16 The index of claim 1 further wherein deferred Treasury instrument months embed carry into the price structure.

17 The index of claim 16 further wherein price differences between current and deferred Treasury instruments are added in to the index.

18 The index of claim 17 further wherein price differences between current and deferred Treasury instruments are added in to the index quarterly.

19 The index of claim 16 further wherein duration price weighting allows yield curve shifts to show through.

20 The index of claim 16 further wherein risks and returns are incorporated on a weighted basis.

21 The index of claim 1 further being utilized as the basis of a futures contract.

22 A capital markets index comprising chain-linked futures contracts.

23 The index of claim 22 further wherein the futures contracts have maturities of 5 years and longer.

24 The index of claim 22 further wherein the futures contracts are Treasury 5-year notes, Treasury 10-year notes, and bond contracts.

25 The index of claim 22 further wherein the futures contracts are assigned duration weights.

26 The index of claim 25 further wherein the duration weights are adjusted quarterly.

27 The index of claim 25 further wherein the duration weights are such that each index component makes an approximately equal contribution to index volatility.

28 The index of claim 22 further wherein the chain-linked futures contracts are utilized as measuring instruments.

29 The index of claim 28 further wherein the chain-linked futures contracts are utilized as building blocks.

30 The index of claim 28 further wherein the index is chain linked quarterly.

31 The index of claim 22 further wherein:
IVₜ=(DWABPₜ)+ACₜ,
where IV is the index value at time t, DWABP is the duration-weighted average price at time t, and AC is accumulated net carry at time t.

32 The index of claim 31 further wherein DWABP is of nearby 5-year, 10-year and bond futures contracts.

33 The index of claim 31 further wherein AC is rebalanced quarterly.

34 The index of claim 22 further wherein deferred contract months embed carry into the price structure.

35 The index of claim 34 further wherein price differences between current and deferred contracts are added in to the index.

36 The index of claim 35 further wherein price differences between current and deferred contracts are added in to the index quarterly.

37 The index of claim 34 further wherein duration price weighting allows yield curve shifts to show through.

38 The index of claim 34 further wherein risks and returns are incorporated on a weighted basis.

39 The index of claim 22 further wherein calendar spreads are added to, and current front-month contracts are substituted for, expiring contracts.

40 The index of claim 22 further being utilized as the basis of a futures contract.

41 An index comprising chain-linked measurement cohorts into a continuous time series.

42 The index of claim 41 further wherein the measurement cohort is the duration weighted average daily price of futures contracts during a given time period.

43 The index of claim 42 further wherein the futures contracts have maturities of 5 years and longer.

44 The index of claim 42 further wherein the futures contracts are Treasury 5-year notes, Treasury 10-year notes, and bond contracts.

45 The index of claim 41 further wherein the chain-link is the market price of rolling from timeₜ to timeₜ₊₁.

46 The index of claim 45 further wherein the chain-link is the market price of rolling from quarterₜ to quarterₜ₊₁.

47 The index of claim 41 further wherein the futures contracts are assigned duration weights.

48 The index of claim 47 further wherein the duration weights are adjusted quarterly.

49 The index of claim 47 further wherein the duration weights are such that each index component makes an approximately equal contribution to index volatility.

50 The index of claim 41 further wherein the chain-linked measurement cohorts are utilized as building blocks.

51 The index of claim 41 further wherein the index is chain linked quarterly.

52 The index of claim 41 further wherein:
IVₜ=(DWABPₜ)+ACₜ,
where IV is the index value at time t, DWABP is the duration-weighted average price at time t, and AC is accumulated net carry at time t.

53 The index of claim 52 further wherein DWABP is of nearby 5-year, 10-year and bond futures contracts.

54 The index of claim 52 further wherein AC is rebalanced quarterly.

55 The index of claim 41 further wherein deferred contract months embed carry into the price structure.

56 The index of claim 55 further wherein price differences between current and deferred contracts are added in to the index.

57 The index of claim 56 further wherein price differences between current and deferred contracts are added in to the index quarterly.

58 The index of claim 55 further wherein duration price weighting allows yield curve shifts to show through.

59 The index of claim 55 further wherein risks and returns are incorporated on a weighted basis.

60 The index of claim 41 further wherein calendar spreads are added to, and current front-month contracts are substituted for, expiring contracts.

61 The index of claim 41 further being utilized as the basis of a futures contract.

62 An index of returns on Treasury instruments comprising a constant measuring instrument and forward pricing.

63 The index of claim 62 further wherein the constant measuring instruments are front-month Treasury instruments.

64 The index of claim 62 further wherein the forward pricing is the quarterly Treasury instrument rolls.

65 The index of claim 62 further wherein the Treasury instruments have maturities of 5 years and longer.

66 The index of claim 62 further wherein the Treasury instruments are Treasury 5-year notes, Treasury 10-year notes, and bond contracts.

67 The index of claim 62 further wherein the Treasury instruments are assigned duration weights.

68 The index of claim 67 further wherein the duration weights are quarterly.

69 The index of claim 67 further wherein the duration weights are such that each index component makes an approximately equal contribution to index volatility.

70 The index of claim 62 further wherein the Treasury instruments are chain-linked to maintain consistency over time.

71 The index of claim 70 further wherein the chain-linked Treasury instruments are utilized as measuring instruments.

72 The index of claim 70 further wherein the chain-linked Treasury instruments are utilized as building blocks.

73 The index of claim 70 further wherein the index is chain linked quarterly.

74 The index of claim 62 further wherein Treasury instruments are strung together into a time-series by incorporating past information into the index.

75 The index of claim 62 further wherein calendar spreads are added to, and current front-month Treasury instruments are substituted for, expiring Treasury instruments.

76 The index of claim 62 further wherein:
IVₜ=(DWABPₜ)+ACₜ,
where IV is the index value at time t, DWABP is the duration-weighted average price at time t, and AC is accumulated net carry at time t.

77 The index of claim 76 further wherein DWABP is of nearby 5-year, 10-year and bond futures contracts.

78 The index of claim 76 further wherein AC is rebalanced quarterly.

79 The index of claim 62 further wherein deferred Treasury instrument months embed carry into the price structure.

80 The index of claim 79 further wherein price differences between current and deferred Treasury instruments are added in to the index.

81 The index of claim 80 further wherein price differences between current and deferred Treasury instruments are added in to the index quarterly.

82 The index of claim 79 further wherein duration price weighting allows yield curve shifts to show through.

83 The index of claim 79 further wherein risks and returns are incorporated on a weighted basis.

84 The index of claim 62 further being utilized as the basis of a futures contract.

85 An index comprising:
prices of futures contracts weighted by duration;
calendar spreads of futures contracts; and
accumulated calendar spreads from the index inception date.

86 The index of claim 85 further wherein duration weights are adjusted.

87 The index of claim 86 further wherein duration weights are adjusted quarterly.

88 The index of claim 85 further wherein calendar spreads are added to, and current front-month contracts are substituted for, expiring contracts.

89 The index of claim 85 further wherein duration weights are such that each index component makes an approximately equal contribution to index volatility for parallel rate shifts.

90 The index of claim 85 further wherein deferred contract months embed carry into the price structure.

91 The index of claim 85 further wherein price differences between current and deferred contracts are added in to the index.

92 The index of claim 91 further wherein price differences between current and deferred contracts are added in to the index quarterly.

93 The index of claim 85 further wherein the futures contracts have maturities of 5 years and longer.

94 The index of claim 85 further wherein the futures contracts are Treasury 5-years notes, Treasury 10-year notes, and bond contracts.

95 The index of claim 85 further wherein the futures contracts are chain-linked to maintain consistency over time.

96 The index of claim 95 further wherein the chain-linked futures contracts are utilized as measuring instruments.

97 The index of claim 95 further wherein the chain-linked futures contracts are utilized as building blocks.

98 The index of claim 95 further wherein the index is chain linked quarterly.

99 The index of claim 85 further wherein futures contracts are strung together into a time-series by incorporating past information into the index.

100 The index of claim 85 further wherein:
IVₜ=(DWABPₜ)+ACₜ,
where IV is the index value at time t, DWABP is the duration-weighted average price at time t, and AC is accumulated net carry at time t.

101 The index of claim 100 further wherein DWABP is of nearby 5-year, 10-year and bond futures contracts.

102 The index of claim 100 further wherein AC is rebalanced quarterly.

103 The index of claim 85 further wherein deferred contract months embed carry into the price structure.

104 The index of claim 103 further wherein price differences between current and deferred contracts are added in to the index.

105 The index of claim 104 further wherein price differences between current and deferred contracts are added in to the index quarterly.

106 The index of claim 103 further wherein duration price weighting allows yield curve shifts to show through.

107 The index of claim 103 further wherein risks and returns are incorporated on a weighted basis.

108 The index of claim 85 further being utilized as the basis of a futures contract.

109. An index comprising:
marginal capital market returns available from investing in a representative collection of longer-duration Treasury instruments and
risks and returns that reside at key pivot points along the capital market yield curve.

110 The index of claim 109 further wherein risks and returns are incorporated on a weighted basis.

111 The index of claim 109 further wherein index cohorts are linked by the market price of rolling forward.

112 The index of claim 111 further wherein rolling Treasury instruments forward involves selling the nearby position and acquiring a position in the next Treasury instrument expiration.

113 The index of claim 109 further including duration weights.

114 The index of claim 113 further wherein duration weights are adjusted.

115 The index of claim 114 further wherein duration weights are adjusted quarterly.

116 The index of claim 109 further wherein the Treasury instruments are chain-linked to maintain consistency over time.

117 The index of claim 116 further wherein the chain-linked Treasury instruments are utilized as measuring instruments.

118 The index of claim 116 further wherein the chain-linked Treasury instruments are utilized as building blocks.

119 The index of claim 116 further wherein the index is chain linked quarterly.

120 The index of claim 109 further wherein observations are strung together into a time-series by incorporating past information into the index.

121 The index of claim 109 further wherein the Treasury instruments have maturities of 5 years and longer.

122 The index of claim 109 further wherein the Treasury instruments comprise Treasury 5-year notes, Treasury 10-year notes, and bond contracts.

123 The index of claim 109 further wherein calendar spreads are added to, and current front-month Treasury instruments are substituted for, expiring Treasury instruments.

124 The index of claim 109 further wherein:
IVₜ=(DWABPₜ)+ACₜ,
where IV is the index value at time t, DWABP is the duration-weighted average price at time t, and AC is accumulated net carry at time t.

125 The index of claim 124 further wherein DWABP is of nearby 5-year, 10-year and bond futures contracts.

126 The index of claim 124 further wherein AC is rebalanced quarterly.

127 The index of claim 109 further wherein deferred Treasury instrument months embed carry into the price structure.

128 The index of claim 127 further wherein price differences between current and deferred Treasury instruments are added in to the index.

129 The index of claim 128 further wherein price differences between current and deferred Treasury instruments are added in to the index quarterly.

130 The index of claim 127 further wherein duration price weighting allows yield curve shifts to show through.

131 The index of claim 127 further wherein risks and returns are incorporated on a weighted basis.

132 The index of claim 109 further being utilized as the basis of a futures contract.

133 A futures contract comprising:
a level of longer-term Treasury instrument market interest rates;
a shape of a yield curve of Treasury instruments; and
a level of short-term Treasury instrument financing rates.

134 The futures contract of claim 133 further wherein the Treasury instruments have maturities of 5 years and longer.

135 The futures contract of claim 133 further wherein the Treasury instruments are Treasury 5-year notes, Treasury 10-year notes, and bond contracts.

136 The futures contract of claim 133 further wherein the Treasury instruments are assigned duration weights.

137 The futures contract of claim 136 further wherein the duration weights are adjusted.

138 The futures contract of claim 137 further wherein the duration weights are adjusted quarterly.

139 The futures contract of claim 136 further wherein the duration weights are such that each component makes an approximately equal contribution to volatility.

140 The futures contract of claim 133 further wherein the Treasury instruments are chain-linked to maintain consistency over time.

141 The futures contract of claim 140 further wherein the chain-linked Treasury instruments are utilized as measuring instruments.

142 The futures contract of claim 140 further wherein the chain-linked Treasury instruments are utilized as building blocks.

143 The futures contract of claim 140 further wherein the Treasury instruments are chain linked quarterly.

144 The futures contract of claim 133 further wherein Treasury instruments are strung together into a time-series by incorporating past information.

145 The futures contract of claim 133 further wherein calendar spreads are added to, and current front-month Treasury instruments are substituted for, expiring Treasury instruments.

146 The futures contract of claim 133 further wherein the futures contract is cash settled.

147 A futures contract comprising chain-linked capital markets futures contracts.

148 The futures contract of claim 147 further wherein the capital markets futures contracts have maturities of 5 years and longer.

149 The futures contract of claim 147 further wherein the capital markets futures contracts are Treasury 5-year notes, Treasury 10-year notes, and bond contracts.

150 The futures contract of claim 147 further wherein the capital markets futures contracts are assigned duration weights.

151 The futures contract of claim 150 further wherein the duration weights are adjusted.

152 The futures contract of claim 151 further wherein the duration weights are adjusted quarterly.

153 The futures contract of claim 151 further wherein the duration weights are such that each component makes an approximately equal contribution to volatility.

154 The futures contract of claim 147 further wherein the chain-linked capital markets futures contracts are utilized as measuring instruments.

155 The futures contract of claim 154 further wherein the chain-linked capital markets futures contracts are utilized as building blocks.

156 The futures contract of claim 154 further wherein the chain-linked capital markets are chain linked quarterly.

157 The futures contract of claim 147 further wherein deferred contract months embed carry into the price structure.

158 The futures contract of claim 157 further wherein duration price weighting allows yield curve shifts to show through.

159 The futures contract of claim 157 further wherein risks and returns are incorporated on a weighted basis.

160 The futures contract of claim 147 further wherein calendar spreads are added to, and current front-month contracts are substituted for, expiring capital markets futures contracts.

161 The futures contract of claim 147 further wherein the futures contract is cash settled.

162 A futures contract comprising a constant measuring instrument of returns on Treasury instruments and forward pricing of Treasury instruments.

163 The futures contract of claim 162 further wherein the constant measuring instruments are front-month Treasury instruments.

164 The futures contract of claim 162 further wherein the forward pricing is the quarterly Treasury instruments rolls.

165 The futures contract of claim 162 further wherein the Treasury instruments have maturities of 5 years and longer.

166 The futures contract of claim 162 further wherein the Treasury instruments are Treasury 5-year notes, Treasury 10-year notes, and bond contracts.

167 The futures contract of claim 162 further wherein the Treasury instruments are assigned duration weights.

168 The futures contract of claim 167 further wherein the duration weights are adjusted.

169 The futures contract of claim 168 further wherein the duration weights are adjusted quarterly.

170 The futures contract of claim 167 further wherein the duration weights are such that each component makes an approximately equal contribution to volatility.

171 The futures contract of claim 162 further wherein the Treasury instruments are chain-linked to maintain consistency over time.

172 The futures contract of claim 171 further wherein the chain-linked Treasury instruments are utilized as measuring instruments.

173 The futures contract of claim 171 further wherein the chain-linked Treasury instruments are utilized as building blocks.

174 The futures contract of claim 171 further wherein the chain-linked Treasury instruments are chain linked quarterly.

175 The futures contract of claim 162 further wherein Treasury instruments are strung together into a time-series by incorporating past information.

176 The futures contract of claim 162 further wherein calendar spreads are added to, and current front-month Treasury instruments are substituted for, expiring Treasury instruments.

177 The futures contract of claim 162 further wherein the futures contract is cash settled.

178 An futures contract comprising:
prices of capital markets futures contracts weighted by duration;
calendar spreads of capital markets futures contracts; and
accumulated calendar spreads from the futures contract inception date.

179 The futures contract of claim 178 further wherein duration weights are adjusted.

180 The futures contract of claim 179 further wherein duration weights are adjusted quarterly.

181 The futures contract of claim 178 further wherein calendar spreads are added to, and current front-month capital markets futures contracts are substituted for, expiring capital markets futures contracts.

182 The futures contract of claim 178 further wherein duration weights are such that each component makes an approximately equal contribution to volatility for parallel rate shifts.

183 The futures contract of claim 178 further wherein deferred capital markets futures contracts months embed carry into the price structure.

184 The futures contract of claim 178 further wherein the capital markets futures contracts have maturities of 5 years and longer.

185 The futures contract of claim 178 further wherein the capital markets futures contracts are Treasury 5-year notes, Treasury 10-year notes, and bond contracts.

186 The futures contract of claim 178 further wherein the capital markets futures contracts are chain-linked to maintain consistency over time.

187 The futures contract of claim 186 further wherein the chain-linked capital markets futures contracts are utilized as measuring instruments.

188 The futures contract of claim 186 further wherein the chain-linked capital markets futures contracts are utilized as building blocks.

189 The futures contract of claim 186 further wherein the capital markets futures contracts are chain linked quarterly.

190 The futures contract of claim 178 further wherein capital markets futures contracts are strung together into a time-series by incorporating past information into the index.

191 The futures contract of claim 178 further wherein the futures contract is cash settled.

192 An futures contract comprising:
marginal capital market returns available from investing in a representative collection of longer-duration Treasury instruments; and
and returns that reside at key pivot points along the capital market yield curve.

193 The futures contract of claim 192 further wherein risks and returns are incorporated on a weighted basis.

194 The futures contract of claim 192 further wherein cohorts are linked by the market price of rolling forward.

195 The futures contract of claim 194 further wherein rolling Treasury instruments forward involves selling the nearby position and acquiring a position in the next Treasury instruments expiration.

196 The futures contract of claim 192 further including duration weights.

197 The futures contract of claim 196 further wherein duration weights are adjusted.

198 The futures contract of claim 197 further wherein duration weights are adjusted quarterly.

199 The futures contract of claim 192 further wherein the Treasury instruments are chain-linked to maintain consistency over time.

200 The futures contract of claim 199 further wherein the chain-linked Treasury instruments are utilized as measuring instruments.

201 The futures contract of claim 199 further wherein the chain-linked Treasury instruments are utilized as building blocks.

202 The futures contract of claim 199 further wherein the Treasury instruments are chain linked quarterly.

203 The futures contract of claim 192 further wherein observations are strung together into a time-series by incorporating past information.

204 The futures contract of claim 192 further wherein the Treasury instruments have maturities of 5 years and longer.

205 The futures contract of claim 192 further wherein the Treasury instruments comprise Treasury 5-year notes, Treasury 10-year notes, and bond contracts.

206 The futures contract of claim 192 further wherein calendar spreads are added to, and current front-month Treasury instruments are substituted for, expiring Treasury instruments.

207 The futures contract of claim 192 further wherein the futures contract is cash settled.
